(19) United States
(12) Patent Application Publication
(10) Pub. No.: US 2004/0181580 A1
(43) Pub. Date: Sep. 16, 2004

(54) Method, computer useable medium, and system for portable email messaging

(76) Inventor: Etienne Baranshamaje, Bethesda, MD (US)

Correspondence Address: LITMAN LAW OFFICES, LTD., P.O. BOX 15035 CRYSTAL CITY STATION, ARLINGTON, VA, 22215, US

(21) Appl. No.: 10/384,640

(22) Filed: Mar. 11, 2003

(51) Int. Cl. G06F 15/16

(52) U.S. Cl. 709/206

(57) ABSTRACT

Portable email messaging allows portable email account users to store email accounts and software anywhere, compose/read email messages, synchronize selected message folders/address book between two independent directory locations, organize email messages in folders and access an address book without an Internet connection. When an Internet connection is present, users are able to send/receive email messages, store online a copy of account parameters; and for users with no access to a local directory, to operate the portable email account as a webmail. Portable email messaging allows local exchange of email messages among independent email addresses, sending/receiving email messages to and from the Internet for intranet members without each member having to individually log into their account, the exchange of intranet member messages in a peer to peer environment or through an intranet exchange point where multiple intranets exchange email messages, and the sending/receiving of Internet bound messages for independent intranet members.

### BACKGROUND OF THE INVENTION

1. Field of the Invention

The present invention relates generally to electronic mail (email) and, more particularly, to a method, computer useable medium, or system for portable email messaging.

2. Description of the Related Art

Presently, roughly four email messaging techniques are predominantly utilized. Users may employ offline email clients that communicate with associated email servers. The users must have access to the computer where the email client software, having proper email settings for the users' Internet service provider (ISP), is installed. In rare cases where Application Configuration Access Protocol (ACAP), an Internet protocol (IP) for accessing client program options, configurations, and preference information remotely, has been implemented, users are still dependent on having an ACAP implementation at the server and client level. The ACAP implementation simplifies the configuration of an offline email client in a fixed setting. It does not facilitate email for mobile professionals as the configuration settings imported through ACAP may be used only on the machine where they have been copied.

Users may also use webmail services, such as Yahoo and Hotmail, to read and prepare messages if/when they have access to an Internet connection. It is not uncommon for users to have two email addresses, a webmail account when they are on the road, and a company email account when they are in the office.

Users may also subscribe to roaming email services that have roaming arrangements with ISPs around the globe. A subscriber to a roaming email account must have a computer with software associated with the roaming email account installed thereon which includes a phonebook directory of the roaming service provider partners in various countries that provide such services. Besides their unreliability, these services are not available everywhere. Finally, users may use mobile devices or hand held devices to download emails in areas where associated email services are offered. Such users are tied to a particular device and the service provider's geographic coverage.

The image that emerges from the above is one of an email account user constrained by ties to a particular hardware (computer or mobile device), the requirement to have access to the Internet, the paucity of economic and user-friendly solutions for users who do not belong to networks with webmail solutions which are costly and difficult to implement for small to medium size organizations, and the lack of access outside the coverage area of the email service provider. Other limitations associated with these current email messaging techniques also exist.

For example, these current email messaging techniques fail to provide a unique user interface between offline email clients and webmails to simplify and enhance user experience and productivity. Even software companies that have developed offline email clients and webmail solutions have different user interfaces.

In addition, when two persons using the same computer exchange message(s), the sent message(s) are transferred to a remote email server where the sender has an email account. The sender's remote email server forwards the sent message(s) to the recipient's email server. The recipient must then connect to his/her remote email server to collect the message(s) sent to him/her from the computer being used.

Also, a user who travels with his/her computer where the email client software is installed and the proper parameters are configured could see his/her email messages blocked by an ISP who uses filtering software to block message transfer for third party emails.

Synchronizing email message folders and an address book between two different directories requires installation of associated software on the two locations if they are on separate devices. For example, it is not possible to carry user important messages and address book on a removable storage device because they do not allow the installation of third party software, in this case, email client software.

Email client software installation generally entails registering information on the registry of the computer where the email client software is being installed and placing specific files in specific locations on the operating system. When the software is launched, the software looks for those files in the specific locations on the specific machine to operate. This requirement makes impossible the installation of email client software on a removable drive.

In the majority of cases, users' email accounts including their message folders and address book cannot be saved on a given device or location and be accessed from another machine even if the machine had the appropriate software installed. Users of an offline email client cannot freely choose where to store their mailbox and address book and move them around. The mailbox and address book directory locations are generally pre-assigned in the email client software. Email messaging software have installation requirements such as a minimum amount of random access memory (RAM).

Intranets (local area networks) are networks designed for information processing within a company or organization. Intranets provide services such as document distribution, software distribution, access to databases, and training. Intranets usually employ applications associated with the Internet, such as Web pages, Web browsers, file transfer protocol sites, email, newsgroups, and mailing lists, accessible only to those within the company or organization.

Creating an intranet within an organization entails installing an email server which requires specialized software and dedicated hardware.

Currently, staff in an organization with an intranet cannot exchange messages without going through the organization's email server. When that email server is located outside the premises of the organization, as is often the case with the majority of small to medium sized businesses and organizations who entrust the hosting of their email servers to hosting companies, internal exchange of messages becomes dependent on the health and accessibility of the email server located outside. When the Internet connection is not present, staff of the organization are not able to communicate internally. Specialized/dedicated servers are needed to host the email/intranet server.

In addition, when two users of an intranet on the same machine exchange messages, the messages are transferred to their respective Simple Mail Transfer Protocol (SMTP)-Post Office Protocol (POP)/Internet Message Access Protocol (IMAP) servers where they are fetched by each recipient. Using the same email client on the same computer, with the same email domain, and having each other in the email address directory does not affect the outcome.

There is currently no mechanism for two users on an intranet using the same machine and the same connection to the Internet to have their messages sent and/or received in a single transaction. Each user has to individually login, send and/or receive email messages, and logout before the next user can do the same thing. So-called special software that allows users to share a connection do not solve this problem because such a shared connection is meant to be among multiple machines.

Two bandwidth constrained ISPs in the same country exchanging messages cannot exchange the messages locally even if they can dial into each other. They must go through sophisticated peering points, usually located outside the local area/country, wasting bandwidth.

The current Internet model is one where users have to be the ones dialing into the ISP, picking up their messages, and dropping messages that are waiting to be sent. This does not allow for the possibility of taking advantage of differential pricing in connection charges that might exist between the ISP and the user. Managing peak load that a scheduling scheme would allow is also not a possibility.

A company's visitor who already has an existing email address is not able to use it in the company's intranet scheme through a simple admission. There are no intranet schemes that allow admitting membership to an email service to share the connection and the company directory for non-holders of a given email account with the company's domain.

Creating email accounts for new members require the presence of an Internet connection. No intranet scheme allows the creation of an email account in an offline mode, with the email account being subsequently validated when an Internet connection is available.

Webmails are front end interfaces to POP/IMAP mail boxes which allow users to access their email through a web page. Users open the Uniform Resource Locator (URL) where the webmail is located and log into their account to access their address book and/or messages folders, and compose and/or read messages while being connected to the Internet.

Webmail software are packaged solutions that are configured to work with email servers which must have a permanent connection to the Internet in order for the user to access the email from any computer that has a connection to the Internet.

There is not a generalized webmail interface that works with any email server that is SMTP-POP/IMAP compliant. Webmail solutions that are currently available on the market have been tailored to work with specific email servers. The cost of integrating a webmail interface into an existing email server acts as a deterrent towards the implementation of webmail in small and medium size companies. It is this high cost which accounts for the popularity of solutions, such as Hotmail and Yahoo, which are used not only by individuals, but also by employees of small and medium size companies when they are on the road. Integration issues between email servers and webmails account for the high cost of migration that might lead organizations to adopt less than optimal messaging solutions. For example, a good email server might be tied to a webmail interface which is not of the best quality and vice-versa.

There is a need for a method, computer useable medium, or system for portable email messaging that overcomes constraints of current email messaging techniques and intranet schemes that limit users' mobility and portability, where the email client software, the webmail interface, the user email account, and an intranet directory requires no client and/or server side installation, work instantly with any email server which is SMTP-POP/IMAP compliant, may be saved wherever a user desires, and that may be accessed and used on and offline, at the users' convenience.

The related art is represented by the following references of interest.

U.S. Pat. Nos. 5,721,827 and 5,732,216, issued on Feb. 24, 1998 and Mar. 24, 1998, respectively, to James Logan et al., describe an audio program and message distribution system in which a host system organizes and transmits program segments to client subscriber locations. The Logan et al. '827 and '216 patents do not suggest a method, computer useable medium, and system for portable email messaging according to the claimed invention.

U.S. Pat. No. 5,758,081, issued on May 26, 1998 to Haluk M. Aytac, describes methods and apparatuses which implement telephony, voice reception, storage, playback, delivery, fax reception, printing, storage, delivery, call processing, electronic mail retrieval, multimedia content delivery HyperText Transfer Protocol (HTTP) server functions in a standaside fashion in relation to computers. The Aytec patent does not suggest a method, computer useable medium, and system for portable email messaging according to the claimed invention.

U.S. Pat. No. 5,764,639, issued on Jun. 9, 1998 to Leven E. Staples et al., describes a system and method for enabling a remote user to maintain a virtual presence at a corporate office and behave substantially as if the user were physically present at the corporate office. The Staples et al. patent does not suggest a method, computer useable medium, and system for portable email messaging according to the claimed invention.

U.S. Pat. No. 5,822,526, issued on Oct. 13, 1998 to Edward P. Waskiewicz, describes a system and method for performing functions of administering a set of email mailboxes and executing requests by email users to transfer email messages between the email computer system and a foreign email system via established gateways. The Waskiewicz patent does not suggest a method, computer useable medium, and system for portable email messaging according to the claimed invention.

U.S. Pat. No. 5,862,339, issued on Jan. 19, 1999 to Patrick P. Bonnaure et al., describes a database central routing device for routing access requests for Internet access among a variety of on-line service providers. The Bonnaure et al. patent does not suggest a method, computer useable medium, and system for portable email messaging according to the claimed invention.

U.S. Pat. No. 5,923,846, issued on Jul. 13, 1999 to Bruce Gage et al., describes a system for posting and downloading messages and files from a bulletin board system. The Gage et al. patent does not suggest a method, computer useable medium, and system for portable email messaging according to the claimed invention.

U.S. Pat. No. 5,995,098, issued on Nov. 30, 1999 to Makota Okada et al., describes an information processing apparatus and a recording medium in which a computer program managing information is recorded. The Okada et al. patent does not suggest a method, computer useable medium, and system for portable email messaging according to the claimed invention.

U.S. Pat. No. 6,112,279, issued on Aug. 29, 2000 to Zheng Wang, describes a virtual web caching system. The Wang patent does not suggest a method, computer useable medium, and system for portable email messaging according to the claimed invention.

U.S. Pat. No. 6,167,568, issued on Dec. 26, 2000 to Deborah E. Gandel et al., describes a method and apparatus for implementing electronic software distribution. The Gandel et al. patent does not suggest a method, computer useable medium, and system for portable email messaging according to the claimed invention.

U.S. Pat. No. 6,199,106 B1, issued on Mar. 6, 2001 to David E. Shaw et al., describes a system for providing scheduled messages to a remote user in a batch oriented system. The Shaw et al. '106 patent does not suggest a method, computer useable medium, and system for portable email messaging according to the claimed invention.

U.S. Pat. No. 6,216,157 B1, issued on Apr. 10, 2001 to Mohan Vishwanath et al., describes a method and apparatus for a client-server system with heterogeneous clients. The Vishwanath et al. patent does not suggest a method, computer useable medium, and system for portable email messaging according to the claimed invention.

U.S. Pat. No. 6,272,532 B1, issued on Aug. 7, 2001 to Harold F. Feinleib, describes an electronic reminder system. The Feinleib patent does not suggest a method, computer useable medium, and system for portable email messaging according to the claimed invention.

U.S. Pat. No. 6,282,565 B1, issued on Aug. 28, 2001 to Mark Shaw et al., describes an enterprise email system. The Shaw et al. '565 patent does not suggest a method, computer useable medium, and system for portable email messaging according to the claimed invention.

U.S. Pat. No. 6,334,146 B1, issued on Dec. 25, 2001 to Abhay V. Parasnis et al., describes a computer system for remotely accessing data in a multi-enterprise collaboration. The Parasnis et al. patent does not suggest a method, computer useable medium, and system for portable email messaging according to the claimed invention.

U.S. Pat. No. 6,442,592, issued on Aug. 27, 2002 to Wendell Alumbaugh et al., describes a system and method for intelligently distributing email for enterprise general accounts among a plurality of individuals designated to respond to such email. The Alumbaugh patent does not suggest a method, computer useable medium, and system for portable email messaging according to the claimed invention.

U.S. Pat. No. 6,487,189, issued on Nov. 26, 2002 to Margery A. Eldridge et al., describes a protocol for performing a token-based document transaction that is adapted to deliver documents to email recipients from mobile computing devices that store document tokens. The Eldridge et al. patent does not suggest a method, computer useable medium, and system for portable email messaging according to the claimed invention.

U.S. Pat. No. 6,487,560, issued on Nov. 26, 2002 to Chris LaRue et al., describes a system and methods for synchronizing information in datasets via a communication medium. The LaRue et al. patent does not suggest a method, computer useable medium, and system for portable email messaging according to the claimed invention.

U.S. Pat. No. 6,505,233 issued on Jan. 7, 2003 to Mike Hanson et al., describes a method for communicating information among a group of participants. The Hanson et al. patent does not suggest a method, computer useable medium, and system for portable email messaging according to the claimed invention.

U.S. Pat. No. 6,507,867 issued on Jan. 14, 2003 to Ian M. Holland et al., describes a method, system, and computer-readable code for a technique by which multiple Web pages can be dynamically bundled (i.e. packaged) and downloaded for accessing on a user's workstation, enabling the user to perform a meaningful interaction even in the absence of an ongoing network connection. The Holland et al. patent does not suggest a method, computer useable medium, and system for portable email messaging according to the claimed invention.

European Patent Application Publication No. EP 1 170 911 A2, published on Jan. 9, 2002, describes a method, system, and terminal for controlling several remote mailboxes. The European application does not suggest a method, computer useable medium, and system for portable email messaging according to the claimed invention.

World Intellectual Property Organization Publication No. WO 177877, published on Oct. 18, 2001, describes an in-flight email system. The WIPO '877 publication does not suggest a method, computer useable medium, and system for portable email messaging according to the claimed invention.

World Intellectual Property Organization Publication No. WO 02/13069 A1, published on Feb. 14, 2002, describes a system and process for updating email and other forms of electronic messages via a change of address network. The WIPO '069 publication does not suggest a method, computer useable medium, and system for portable email messaging according to the claimed invention.

World Intellectual Property Organization Publication No. WO 02/13489 A2, published on Feb. 14, 2002, describes a technique for automated processing of incoming data packages such as email messages in a manner specified by the recipient. The WIPO '489 publication does not suggest a method, computer useable medium, and system for portable email messaging according to the claimed invention.

None of the above inventions and patents, taken either singularly or in combination, is seen to describe the instant invention as claimed. Thus a method, computer useable medium, or system for portable email messaging solving the aforementioned problems is desired.

### SUMMARY OF THE INVENTION

The present invention is a method, computer useable medium, or system for portable email messaging that provides a user with a generalized webmail solution which works instantly with any SMTP-POP/IMAP email server, and the privacy of keeping an email account where the user wants. The portable email messaging activates a portable email account while not being connected to the Internet, allowing a user to compose and/or read email messages, synchronize selected message folders/address book of the portable email account between two independent directory locations, organize email messages in folders, or access an address book of the portable email account while not being connected to the Internet. The portable email messaging sends and/or receives email messages to and from the portable email account and stores online a copy of account parameters of the portable email account while being connected to the Internet. The portable email messaging may be operated as a webmail.

The portable mail messaging allows local exchange of email messages among independent email addresses, allows intranet members to send and/or receive email messages to and from the Internet without each member being connected to the Internet, and allows independently created intranets to exchange intranet member messages in a peer to peer environment or through an intranet exchange point where multiple intranets exchange email messages.

A portable email messaging system may include a computer useable medium and a computer device communicatively linkable to the Internet. The computer useable medium may carry thereon a portable email messaging software package including portable email software and portable intranet software.

The portable email software is completely portable and requires no installation. The portable email software enables a user to by-pass restrictions placed by ISPs who block SMTP ports for email from third party accounts by using an HTTP to SMTP gateway, save regularly an updated copy of the user's portable email account online, download the user's portable email account for use if the location where the user's portable email account is stored is not accessible, and use the portable email software in a webmail version with the same user interface if there is no possibility to store the user portable email account locally.

The portable intranet software is completely portable and requires no installation. The portable intranet software enables local exchange of email messages between independent users on a portable device, such as a floppy disk or the like, or on a local area network (LAN), and the ability to take a collective outbox and inbox of a plurality of intranet members to another location, and send and/or receive Internet bound email messages for the intranet members. Independently created intranets utilizing the portable intranet software may exchange messages from their intranet members in a peer to peer network or through an intranet exchange point whose members drop and pick up email messages for their respective intranet members while obtaining an updated directory of intranet peers. The intranet exchange point does not require special or dedicated hardware and is also portable.

The portable intranet software includes a built-in system of email addressing convention which simplifies the creation of email accounts for members. An intranet administrator may add members who already have email addresses. The intranet administrator may also remove members at any time. Existing email accounts or a brand new email account may be created using the portable intranet software. Membership provides access to group contacts, group calendar, and shared documents. Messages between members of the group are exchanged locally irrespective of whether they belong to the same email address domain or not. The intranet manager may send and/or receive Internet bound messages for intranet members.

In a single machine setting users may read and/or compose their messages anywhere, but must log into their account on the computer upon which the portable intranet software is configured, in order to exchange email messages locally with other intranet members, send outgoing Internet email messages, and receive new email messages downloaded by the intranet manager from the user's POP/IMAP server email mailbox.

In a multi-machine environment (e.g., one that requires a local area network with Windows file-sharing capabilities or the like), any intranet member may log into any intranet configured computer to carry out their email messaging activities. Configuring a computer to be part of an intranet configured by the portable intranet software involves running a small script that is automatically created at the time the intranet is originally configured.

Members of an intranet configured by the portable intranet software may send and/or receive email messages to and from the Internet without ever having to worry about establishing an Internet connection themselves. All outgoing Internet email messages created by intranet members are queued up and sent in aggregate when an Internet connection is established. At the same time, all new email messages are downloaded from each intranet member's online POP/IMAP server email mailbox. This aggregation can result in substantial savings on Internet costs. Independently created intranets utilizing the portable intranet software may exchange messages for their intranet members in a peer to peer network or through an intranet exchange point. Besides delivering and picking up messages when a contact with the intranet exchange point is established, an intranet may also update the directory of the intranet exchange point members.

Accordingly, it is a principal aspect of the invention to provide a portable email messaging method that stores a portable email account associated with a particular user on the computer useable medium; activates the portable email account on the computer device while the device is not communicatively linked to the Internet; composes email messages, reads email messages, synchronizes selected message folders/address book of the portable email account between two independent directory locations, organizes email messages in folders, or accesses an address book of the portable email account while the computer device is not communicatively linked to the Internet; communicatively links the computer device to the Internet; sends/receives email messages from the portable email account; and stores online a copy of user account parameters of the portable email account while the computer device is communicatively linked to the Internet.

It is another aspect of the present invention to provide a computer useable medium or system for portable email messaging that carries thereon portable email messaging software which stores a portable email account associated with a particular user on the computer useable medium; activates the portable email account on a computer device while the device is not communicatively linked to the Internet; composes email messages, reads email messages, synchronizes selected message folders and address book of the portable email account between two independent directory locations, organizes email messages in folders, or accesses an address book of the portable email account while the computer device is not communicatively linked to the Internet; communicatively links the computer device to the Internet; sends/receives email messages to and from the portable email account; and stores online a copy of user account parameters of the portable email account while the computer device is communicatively linked to the Internet.

It is a further aspect of the invention to provide a portable intranet method which locally exchanges email messages among independent email addresses and updates an intranet address book directory; enables an intranet manager to establish a connection with the Internet, and send/receive email messages to and from the Internet for intranet members without each member having to individually log into their account; enables independently created intranets to exchange intranet member messages in a peer to peer environment or through an intranet exchange point where multiple independent intranets exchange email messages and obtain an updated membership directory; and enables an intranet exchange point to send/receive Internet bound messages for independent intranet members.

Still another aspect of the present invention is to provide a portable intranet computer useable medium or system that carries thereon portable intranet software which locally exchanges email messages among independent email addresses while updating an intranet address book directory; enables an intranet manager to establish a connection with the Internet, and sends/receives email messages to and from the Internet for intranet members without each member having to individually log into their account; enables independently created intranets to exchange intranet member messages in a peer to peer environment or through an intranet exchange point where multiple independent intranets exchange email messages and obtain an updated membership directory; and enables an intranet exchange point to send/receive Internet bound messages for independent intranet members.

It is an aspect of the invention to provide improved elements and arrangements thereof in a method, computer useable medium, and system for portable email messaging for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a functional block diagram of a portable email messaging system according to the present invention.

FIGS. 2A and 2B are a functional block diagram of portable email messaging software according to the present invention.

FIGS. 3A(i) and 3A(ii) are a functional block diagram of portable intranet software according to the present invention.

FIG. 3B is a functional block diagram of portable intranet software according to the present invention.

FIG. 4 is an image of a screen initializing portable email software according to the present invention.

FIG. 5 is an image of a screen indicating initializing progress of portable email software according to the present invention.

FIG. 6 is an image of a screen showing options available to a user who visits an Internet website where portable email software is stored on the website server according to the present invention.

FIG. 7 is an image of a screen for selecting whether to download portable email software according to the present invention.

FIG. 8 is an image of a screen for allowing a user to enter or to browse for a location where files for portable email software will be downloaded according to the present invention.

FIG. 9 is an image of a screen for presenting a user with the file system of the user's computer to select the directory where to download portable email software according to the present invention.

FIG. 10 is an image of a screen for selecting whether to download desktop icons for portable email messaging according to the present invention.

FIG. 11 is an image of a screen indicating the progress of portable email software being downloaded according to the present invention.

FIG. 12 is an image of a screen indicating download completion of portable email software according to the present invention.

FIG. 13 is an image of a screen for selecting whether to create a portable email account or to read data from an existing email account using the portable email messaging software package according to the present invention.

FIG. 14 is an image of a screen presented to a user who has selected to enter account information for an existing email account whose data will be read using the portable email software according to the present invention.

FIG. 15 is an image of a screen for entering the email address of an existing email account according to the present invention.

FIG. 16 is an image of a screen for entering a password for a portable email account that will be able to read data from an existing email account according to the present invention.

FIG. 17 is an image of a screen for entering an address of a POP/IMAP server for incoming mail for a portable email account according to the present invention.

FIG. 18 is an image of a screen for entering an address of an SMTP server for outgoing mail for a portable email account according to the present invention.

FIG. 19 is an image of a screen for entering a location where a portable email account will be saved according to the present invention.

FIG. 20 is an image of a screen for saving a portable email account on the desktop of a computer or some other location according to the present invention.

FIG. 21 is an image of a screen for providing a user with license terms and conditions for a portable email account according to the present invention.

FIG. 22 is an image of a screen for providing the user with a summary of portable email account information according to the present invention.

FIG. 23 is an image of a screen for notifying a user to request a trial license from an entity associated with portable email messaging software according to the present invention.

FIG. 24 is an image of a screen for notifying a user that the user has been provided with a trial license for a portable email account according to the present invention.

FIG. 25 is an image of a screen for selecting whether to create a portable email account or to log into an existing portable email account using the portable email messaging software package according to the present invention.

FIG. 26 is an image of a screen presented to a user that has selected to create a new email account on an email server of an entity configured to create email accounts on the fly using portable email account using the portable email messaging software package according to the present invention.

FIG. 27 is an image of a screen for entering a username for a new portable email account that is being created on the fly using the portable email messaging software package according to the present invention.

FIG. 28 is an image of a screen for entering a password for a portable email account that is being created using the portable email messaging software package according to the present invention.

FIG. 29 is an image of a screen for entering or browsing for a location where a portable email account will be saved according to the present invention.

FIG. 30 is an image of a screen for saving a portable email account on a desktop of a computer or some other location according to the present invention.

FIG. 31 is an image of a screen providing a user with license terms and conditions of a portable email account according to the present invention.

FIG. 32 is an image of a screen for providing a user with a summary of account information for a portable email account according to the present invention.

FIG. 33 is an image of a screen for notifying a user to request a trial license from an entity associated with portable email messaging software according to the present invention.

FIG. 34 is an image of a screen for informing a user that the user has been provided with a trial license for a portable email account according to the present invention.

FIG. 35 is an image of a screen for entering an email address and password of a portable email account according to the present invention.

FIG. 36 is an image of a screen for portable email account according to the present invention.

FIG. 37 is an image of a screen for enabling a user to select whether to find a portable email account on a computer, to download the portable email account from a back-up remote server and recreate the portable email account onto the computer, or to operate the portable email account as a webmail account according to the present invention.

FIG. 38 is an image of a screen for enabling a user to enter a directory location where a portable email account downloaded from a remote back-up server may be stored according to the present invention.

FIG. 39 is an image of a screen for entering a location where the user portable email account is stored according to the present invention.

FIG. 40 is an image of a screen for selecting whether portable email messaging software should remember messages that have been previously downloaded from a POP/IMAP server according to the present invention.

FIG. 41 is an image of a screen for composing an email message using a portable email account according to the present invention.

FIG. 42 is an image of a screen for a portable email account according to the present invention.

FIG. 43 is an image of a screen for a portable email account with a user created folder highlighted according to the present invention.

FIG. 44 is an image of a screen showing account settings for a portable email account according to the present invention.

FIG. 45 is an image of a screen showing security settings for a portable email account according to the present invention.

FIG. 46 is an image of a screen showing signature settings for a portable email account according to the present invention.

FIG. 47 is an image of a screen showing download options settings for a portable email account according to the present invention.

FIG. 48 is an image of a screen showing SMTP settings for a portable email account according to the present invention.

FIG. 49 is an image of a screen showing POP settings for a portable email account according to the present invention.

FIG. 50 is an image of an address book screen of a portable email account according to the present invention.

FIG. 51 is an image of a new contact screen of a portable email account according to the present invention.

FIG. 52 is an image of a screen for entering a name of a new group for a portable email account according to the present invention.

FIG. 53 is an image of a distribution list screen of a portable email account according to the present invention.

FIG. 54 is an image of a help screen of a portable email account according to the present invention.

FIG. 55 is an image of a bug submission screen of a portable email account according to the present invention.

FIG. 56 is an image of a feedback screen of a portable email account according to the present invention.

FIG. 57 is an image of a synchronization screen of a portable email account according to the present invention.

FIG. 58 is an image of a screen for selecting whether to log on as an intranet manager or to create an intranet using portable intranet software according to the present invention.

FIG. 59 is an image of a screen for selecting whether to create an intranet on a single machine or multiple machines using portable intranet software according to the present invention.

FIG. 60 is an image of a screen for designating a particular location where intranet files will be stored for an intranet being created using portable intranet software according to the present invention.

FIG. 61 is an image of a screen for selecting whether a user has or does not have a registered Internet domain to associate with an intranet being created using portable intranet software according to the present invention.

FIG. 62 is an image of a screen for entering an intranet registered domain for an intranet being created using portable intranet software according to the present invention.

FIG. 63 is an image of a screen for entering an SMTP server that will be used for an intranet being created using portable intranet software according to the present invention.

FIG. 64 is an image of a screen for entering a POP/IMAP server that will be used for an intranet being created using portable intranet software according to the present invention.

FIG. 65 is an image of a screen for selecting an email address convention for intranet members to use in creating email accounts with portable intranet software according to the present invention.

FIG. 66 is an image of a screen for entering an intranet manager password to use for an intranet being created using portable intranet software according to the present invention.

FIG. 67 is an image of a screen for providing a summary of intranet parameters of an intranet being created using portable intranet software according to the present invention.

FIG. 68 is an image of a screen for informing a user that an entity associated with portable intranet software will be notified of a request for a trial license according to the present invention.

FIG. 69 is an image of a screen for informing a user that a request has not been made for a trial license for an intranet according to the present invention.

FIG. 70 is an image of an intranet screen for an intranet created using portable intranet software according to the present invention.

FIG. 71 is an image of screens for intranet properties summary, license information, and scheduler options of an intranet created using portable intranet software according to the present invention.

FIG. 72 is an image of an address book screen for an intranet created using portable intranet software according to the present invention.

FIGS. 73A and 73B are images of screens of managed accounts and pending accounts, respectively, of an intranet created using portable intranet software according to the present invention.

FIG. 74 is an image of a screen for changing a manager password for an intranet created using portable intranet software according to the present invention.

FIG. 75 is an image of a screen for selecting whether to import or export messages to/from an intranet created using portable intranet software according to the present invention.

FIG. 76 is an image of a screen for entering an export location for intranet data for an intranet created using portable intranet software according to the present invention.

FIG. 77 is an image of a screen indicating export progress of intranet data for an intranet created using portable intranet software according to the present invention.

FIG. 78 is an image of a screen indicating export success for an intranet created using portable intranet software according to the present invention.

FIG. 79 is an image of a screen for entering an import location for intranet data for an intranet created using portable intranet software according to the present invention.

FIG. 80 is an image of a screen indicating import success for an intranet created using portable intranet software according to the present invention.

FIG. 81 is an image of a screen for entering an intranet domain to log into an intranet created using portable intranet software according to the present invention.

FIG. 82 is an image of a screen for entering an intranet manager password to log into an intranet created using portable intranet software according to the present invention.

FIG. 83 is an image of a screen for entering or browsing for a location where intranet files were stored for an intranet created using portable intranet software according to the present invention.

FIG. 84 is an image of a screen for a new user to use to create an email account following the email convention of an intranet created using portable intranet software according to the present invention.

FIG. 85 is an image of a screen informing a user who has just created an email account following an intranet email convention, what his/her email address is after an email account request has been submitted to an intranet created using portable intranet software according to the present invention.

FIG. 86 is an image of a screen for informing a user that a request has been made for an intranet account for an intranet created using portable intranet software according to the present invention.

FIG. 87 is an image of a screen for entering a subdomain of an intranet being created using portable intranet software according to the present invention.

FIG. 88 is an image of a screen showing transfer schedule settings for an intranet created using portable intranet software according to the present invention.

FIG. 89 is an image of a screen for entering or removing entries for a transfer schedule of an intranet created using portable intranet software according to the present invention.

FIG. 90 is an image of a screen for entering criteria for a schedule to be added to a transfer schedule of an intranet created using portable intranet software according to the present invention.

FIG. 91 is an image of a screen for a user with an existing portable email account to select whether to request to join an intranet created using portable intranet software according to the present invention.

FIG. 92 is an image of a screen for entering or browsing to find the location where are stored intranet files for an intranet created using portable intranet software according to the present invention.

FIG. 93 is an image of a screen for indicating to a user that a directory has been located with intranet files for an intranet created using portable intranet software according to the present invention.

Similar reference characters denote corresponding features consistently throughout the attached drawings.

### DETAILED DESCRIPTION OF THE PREFERRED EMBODIMENTS

The present invention is a method, computer useable medium, or system for portable email messaging that provides a user with a generalized webmail solution which works instantly with any SMTP-POP/IMAP email server, and the privacy of keeping an email account where the user wants. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

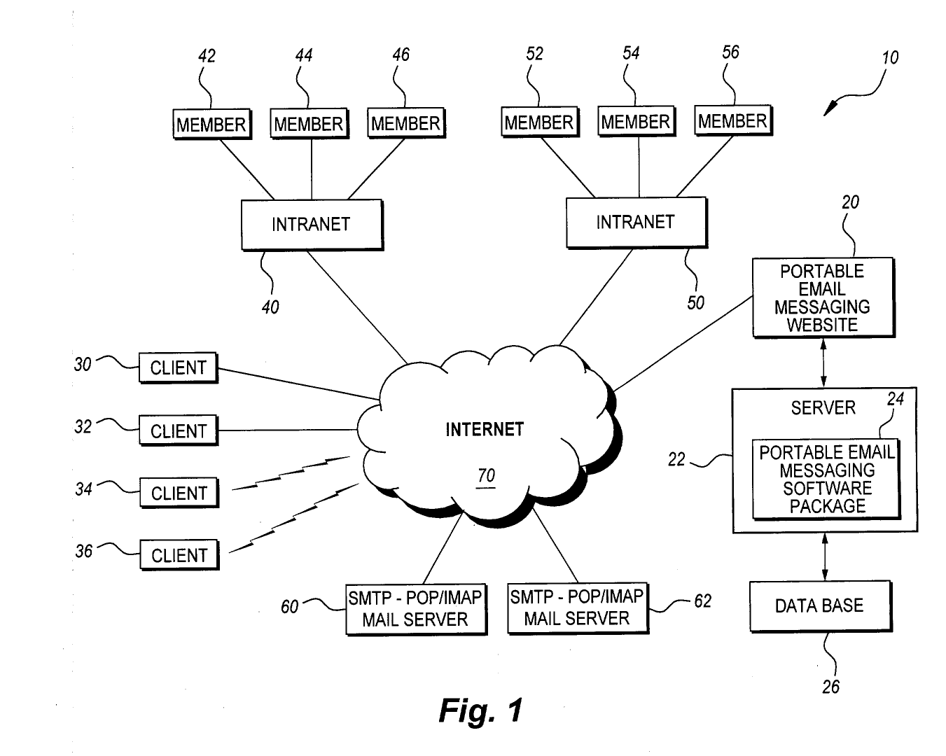

Referring to the drawings, FIG. 1 shows an exemplary block diagram of a portable email messaging system 10 that may include any number of possible elements according to the invention. It is to be understood, however, that the present invention may be associated with any methods, computer useable mediums, and systems for portable email messaging that provides a user with a generalized webmail solution which works instantly with any SMTP-POP/IMAP email server, and the privacy of keeping an email account where the user wants.

For example, portable email messaging according to the invention may store a portable email account and activate the portable email account on a computer device while the device is not communicatively linked to the Internet. The portable email messaging may compose email messages, read email messages, synchronize selected message folders/address book of the portable email account between two independent directory locations, organize email messages in folders, or access an address book of the portable email account while the computer device is not communicatively linked to the Internet. The portable email messaging may communicatively link the computer device to the Internet, and send and/or receive email messages to and from the portable email account, and store online a copy of user account parameters of the portable email account while the computer device is communicatively linked to the Internet.

The portable email messaging may communicatively link the computer device to the Internet, download a user backed-up copy of the portable email account from a remote server, and operate the account as a webmail, enabling a user to compose email messages, read email messages, synchronize selected message folders/address book of the portable email account between two independent directory locations, organize email messages in folders, or access an address book of the portable email account while the computer device is communicatively linked to the Internet, and send and/or receive email messages to and from the portable email account.

The user may access a created portable email account by locally finding an existing portable email account, downloading and saving the existing portable email account, or operating the existing portable email account as a webmail account.

The portable email messaging may enable local exchange of email messages among independent email addresses, enable intranet members to send and/or receive email messages to and from the Internet without each member establishing a connection to the Internet, and enable independently created intranets to exchange intranet member messages in a peer to peer environment or through an intranet exchange point where multiple intranets exchange email messages.

The portable email messaging system 10 shown in FIG. 1 includes a portable email messaging website 20, client computer devices 30, 32, 34, 36, intranet 40, intranet members 42, 44, 46, intranet 50, intranet members 52, 54, 56, and SMTP-POP/IMAP mail servers 60, 62 that are all communicatively interconnected over the Internet 70. As stated before, the portable email messaging system 10 may include any number of client computer devices, any number of intranets, any number of intranet members, and any number of SMTP-POP/IMAP mail servers. Part of the Internet 70 includes a data exchange interface called the World-Wide-Web, or the “Web” for short. Web pages may be located by a browser using Uniform Resource Locators (URLs). A URL specifies the exact location of a Web-based resource, such as a server or data record. The location may include domain, server, user, file, and record.

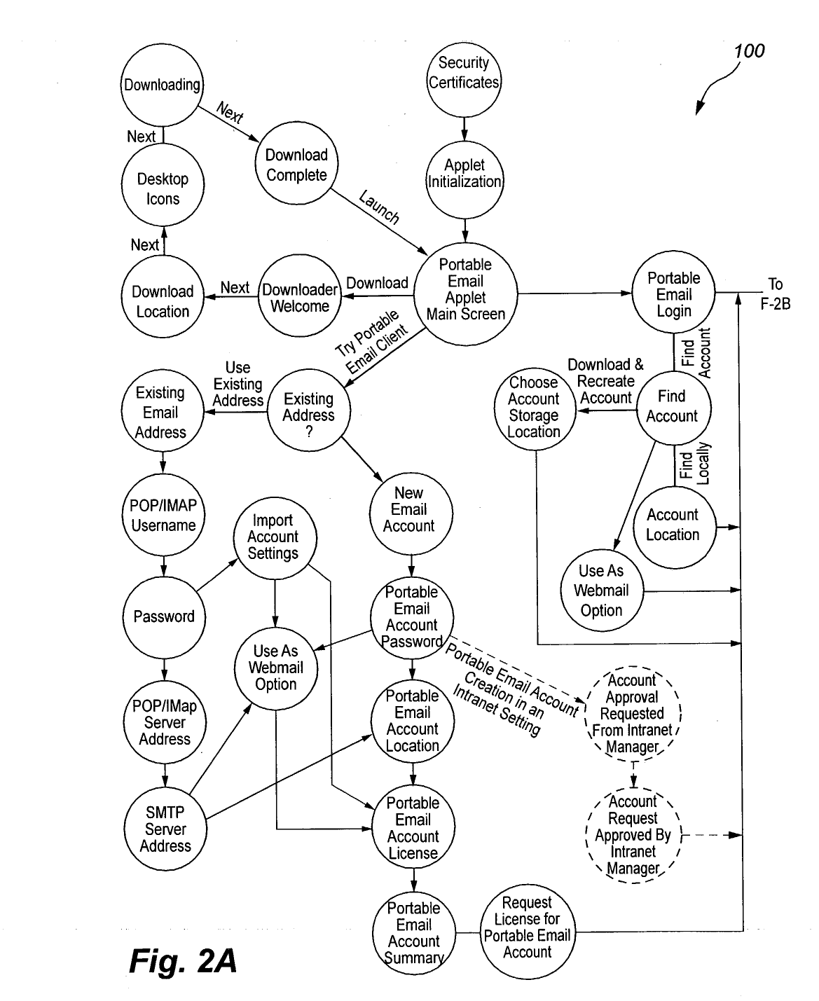

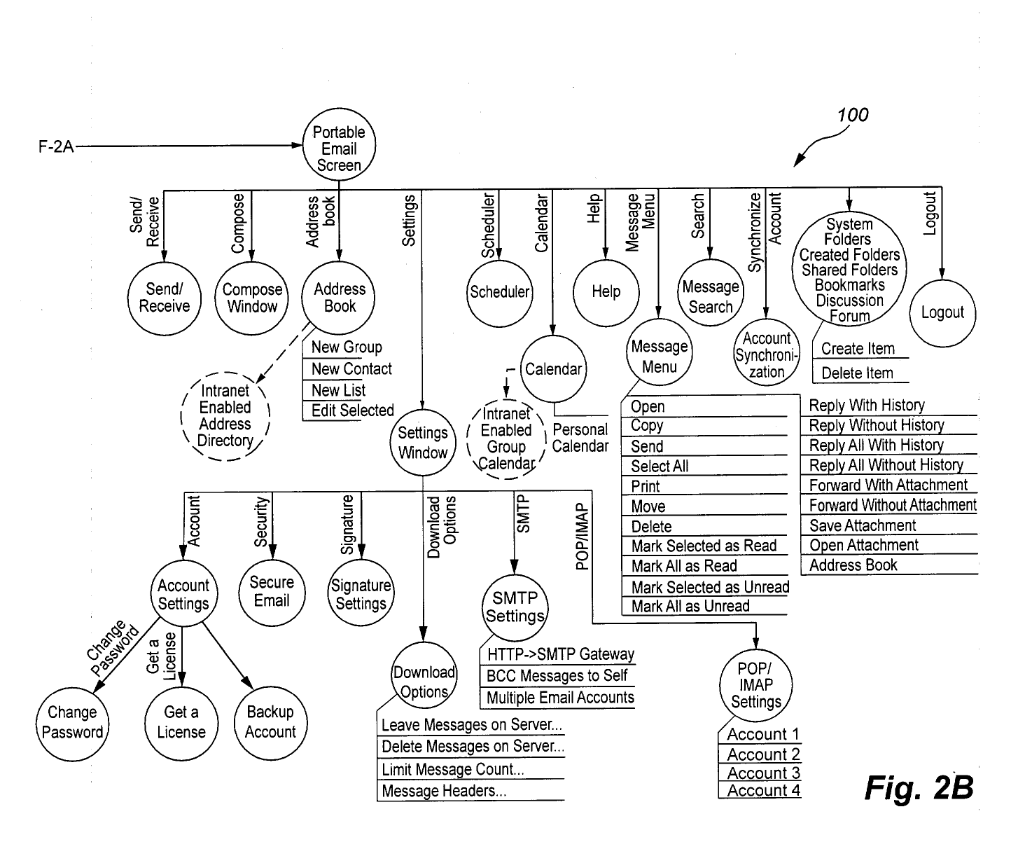

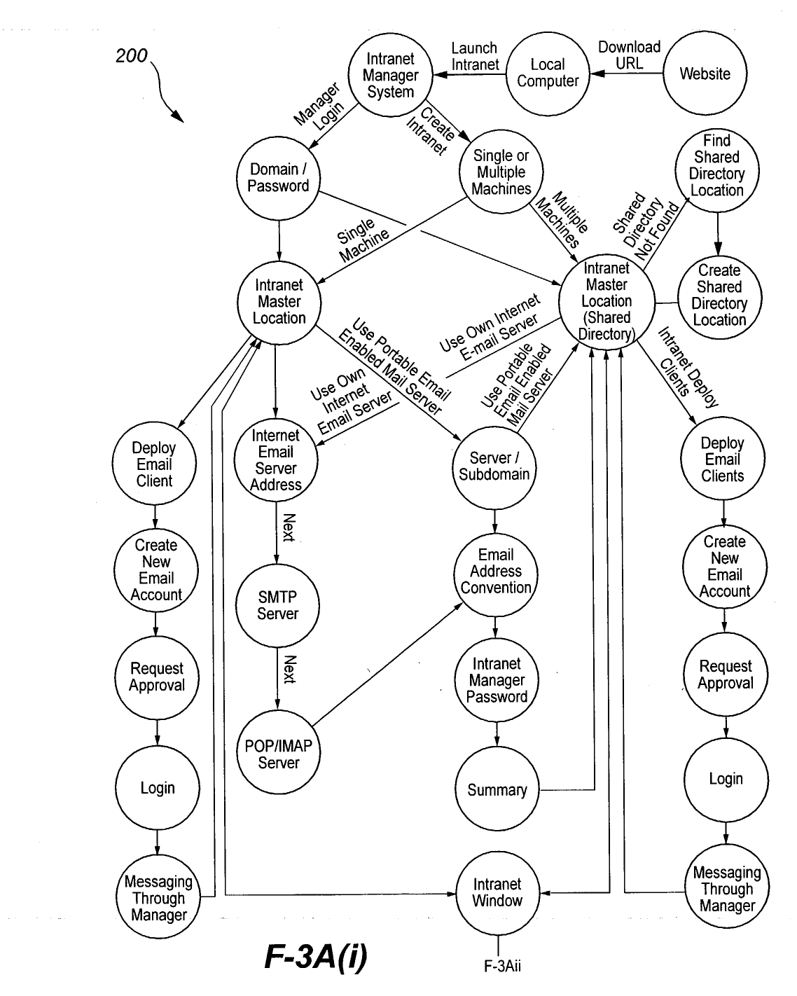

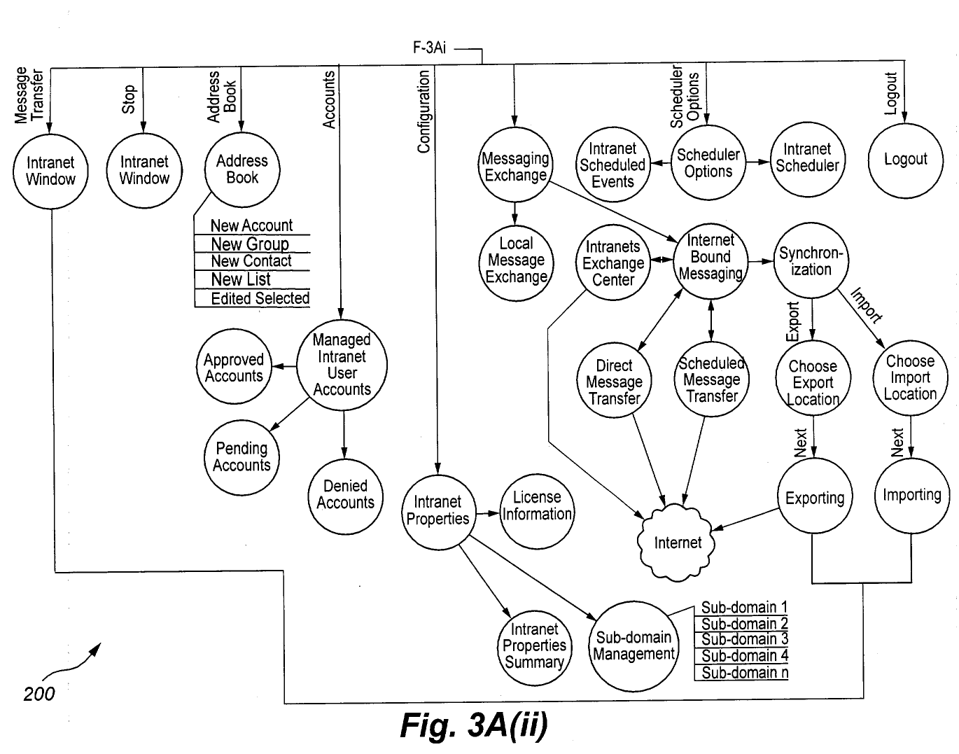

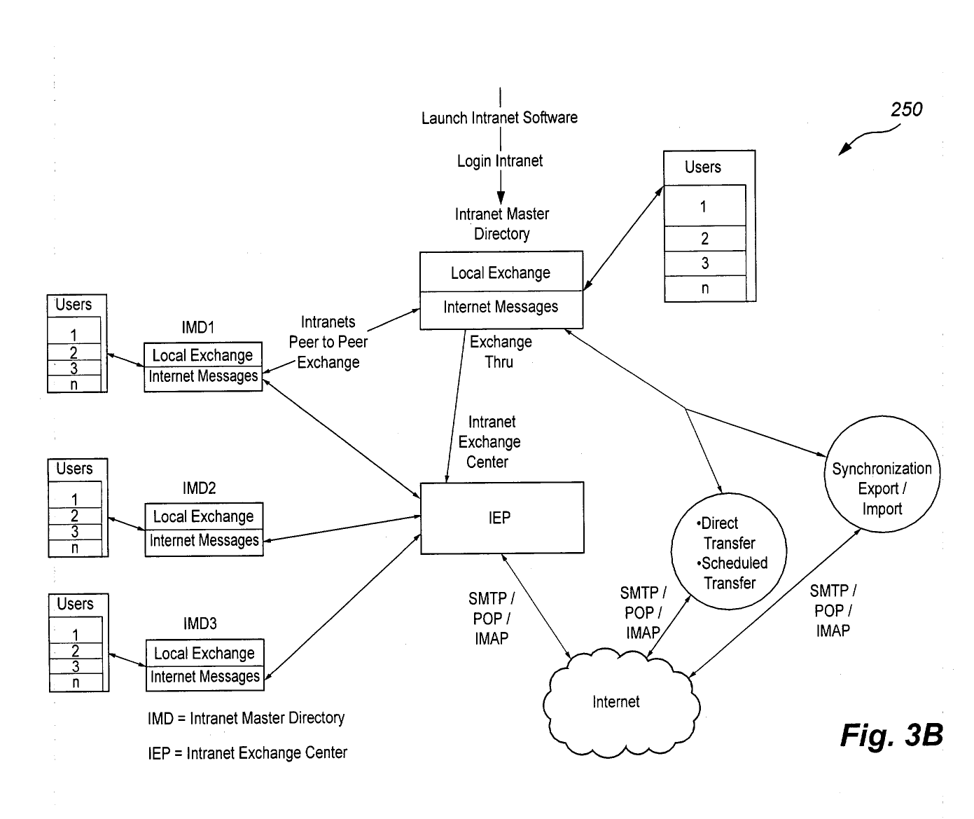

The portable email messaging website 20 is administered by a server 22 and a database 26. The server 22 includes stored therein a portable email messaging software package 24. The portable email messaging software package 24 includes portable email software 100 and portable intranet software 200 (see FIGS. 2A-3B). The portable email messaging software package 24 is stored in a server memory which may be any combination of RAM or cache memory. The server 22 includes a processor, an operating system, application programs, and data. In accordance with well known principles, the processor executes the applications in the server memory under control of the operating system.

The client computer devices 30, 32, 34, 36 may be wireless or non-wireless cell phones, personal computers, lap-tops, palm-tops, workstations, or any other similar configured computer system. Each client computer device may execute standard operating system (O/S) software, such as Windows 98, 2000, XP, UNIX, or the like. The O/S is used to execute application software programs. Each client computer device includes a Java enabled Web browser, such as Microsoft Explorer, Netscape Navigator, Hot Java, or the like. Member(s) of the intranet(s) exchange messages using a Java enabled web browser.

The SMTP-POP/IMAP mail servers 60, 62 each include a POP and/or IMAP server, and an SMTP server. The POP and/or IMAP server handles incoming email. The SMTP server handles outgoing email. The POP and/or IMAP servers maintain a collection of text files, one for each email account. When an email message arrives for a user, the POP and/or IMAP server simply appends it to the bottom of the recipient's file. When an individual checks his/her email account, the email client connects to the POP and/or IMAP server, and requires an account name and a password. Once the individual has logged in the POP and/or IMAP server, the POP and/or IMAP server opens the individual's text file and allows the individual to access it. The user's computer connects to the POP and/or IMAP server and issues a series of commands to bring copies of the user's email messages to the user's local computer. The POP and/or IMAP server merely acts as an interface between an email client on a user's local computer and the text file containing the user's messages. When a piece of email is sent, the email client on a user computer interacts with the SMTP server to handle the sending, while the SMTP server may communicate with other SMTP servers to actually deliver the email.

The portable email messaging software package 24 is a script comprising computer useable instructions which may be read and acted upon by any Java enabled web browser, and that does not require any special installation, such as unzipping, installing, downloading to a pre-specified location, etc.

The portable email messaging software package 24 includes portable email software 100 and portable intranet software 200. The portable email software 100 and the portable intranet software 200 each include a plurality of computer instructions which may be carried on any computer useable medium according to the desires of the user, such as a computer hard drive, a floppy disk, Flash memory, optical memory, magnetic media memory, or the like. If the computer useable medium is a floppy diskette, the portable email messaging software 100 fits on a single floppy and leaves space for storing email messages and address book contacts. An email account, created by the portable email software 100, and the portable email software 100 do not have to be stored on the same directory. A user may open his/her email account stored on a local directory, such as a floppy diskette or the like, with the portable email software 100 stored on another accessible device, e.g., a hard drive, a universal service bus mass storage device, or on the Web. The portable email software 100 minimizes risk by enabling a user to reconstitute effortlessly the email account, message folders content, and address book in the event the local storage is lost or destroyed.

If the local storage is lost or destroyed, users may access their email messages folders by redownloading their backed-up portable email account from a remote server and recreating their portable email account locally. The downloaded backed-up portable email account contains users' address books and gives them the option to download all messages in the server inbox or only messages that have not been downloaded previously. The user who does not have access to a local storage location may log into the portable email account backed-up online and operate the account as a webmail. The remote server where user account information is backed-up does not have to be tied to particular software or hardware. The remote server may be any remotely accessible location.

A POP and/or IMAP email address account is required for a user of the portable email software. However, as described above, online connectivity to the user's POP/IMAP server is not required for a user to compose and/or review email messages that were in the email address account at a predetermined time.

The user may use an existing email account or may create a new email account on an email server configured to create new email accounts on the fly using the portable email software 100. The user may download the portable email software 100, which requires no installation, and store the portable email software 100 on the same location as the email account location or some other location. The user may use already downloaded portable email software 100 located on a hard drive, other accessible directory, or from a link on a website to a server upon which is stored the portable email software 100.

A user of the portable email software 100 may send and/or receive email messages when the user establishes a connection to the Internet 70. The portable email software 100 includes access anywhere/anytime features of webmail systems but does not require an ‘always on’ connection to the Internet 70 in order to read and/or compose messages. Regardless of whether an Internet connection is present or not, users of the portable email software 100 may read and/or compose email messages. The portable email software 100 is independent of a particular computer where the user account settings are installed. Because the portable email software 100 interfaces instantly to any email server that is SMTP-POP/IMAP compliant, the portable email software 100 may be considered a universal webmail. The portable email software 100 includes synchronization instructions that enable a user account to be synchronized to any location independently of where the portable email software 100 is installed. For example, the synchronization instructions enable users to replicate all email account data (e.g., user account information, messages, folders, contacts, etc.) to any location independently of where the portable email software 100 being used is stored.

To send and/or receive email messages, a user establishes a connection to the Internet 70 at his/her convenience, executes the portable email software 100, and clicks on a SEND/RECEIVE key. Connection to the Internet 70 may take place anywhere at any time. A user may initiate modem dial-up from home if there is access to an ISP. Alternatively, the user may take a floppy diskette upon which is stored his/her email account directory to a place where there is a connection to the Internet 70, such as an Internet cafe, a library, a friend's house, or the like, and send messages in the outbox and/or download messages waiting on the email server inbox. Alternatively, the user may log into the backed-up copy of his/her portable email account on the remote server and operate the account as a webmail. Upon sending, all sent messages are copied to the user online account if the user has selected the option to send a copy of each message to the user's account in the SMTP settings. Synchronization allows the user to replicate the portable email account, message folders, and the address book on different storage devices. Several individual email accounts may be stored on the same directory which may be on a floppy diskette. They may be individually accessed through user name and password login.

FIGS. 2A and 2B show a functional block diagram of the portable email software 100. The portable email software 100 includes a plurality of portable email computer instructions. The portable email software does not have to be installed on a client computer for a user to work online and/or offline. A user may utilize different computers and different access points to the Internet 70 at different times because the portable email software 100 requires no installation and provides portability. The portable email software 100 may be used by an individual, group, or organization whose members have occasional access to a computer with an Internet connection. FIGS. 3A(i) and 3A(ii) show a functional block diagram of the portable intranet software 200. FIG. 3B shows another functional block diagram 250 of the portable intranet software 200. The portable intranet software 200 includes a plurality of portable intranet computer instructions.

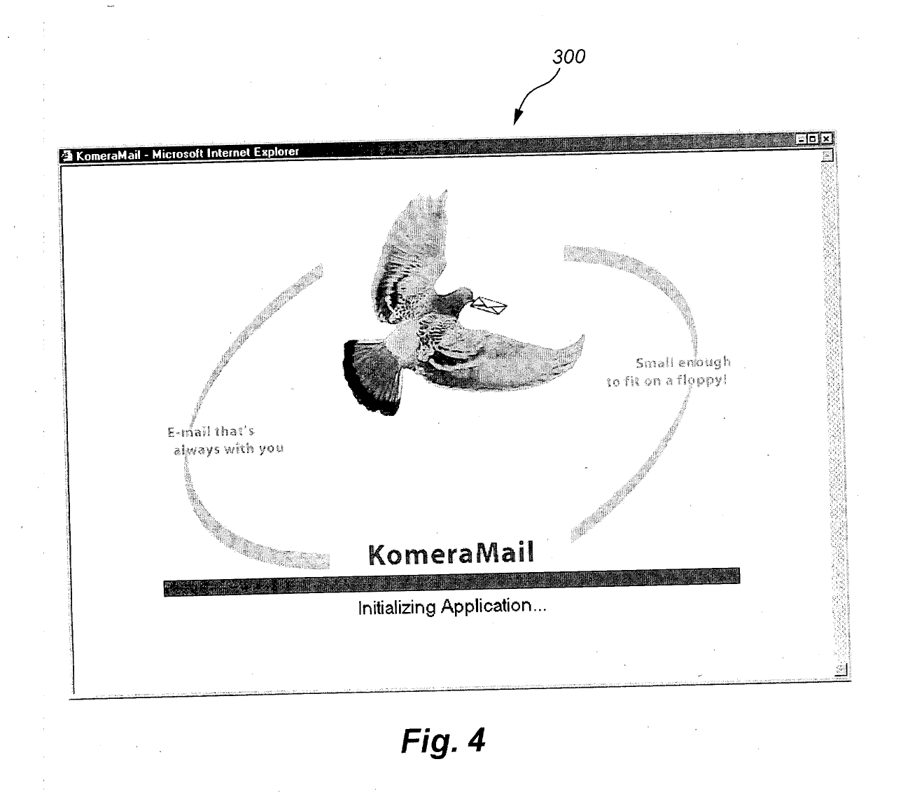

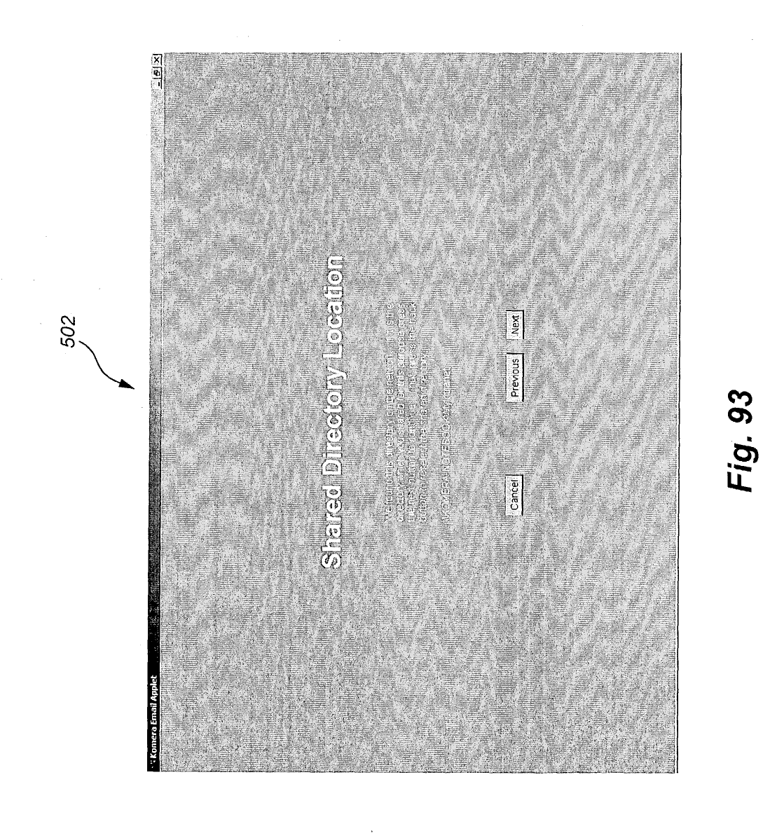

FIGS. 4-93 illustrate example images of screens that may be used for a portable email software package 24. The illustrated screens use the name KOMERA, however any name could be used. Example images of portable email screens are shown in FIGS. 4-57.

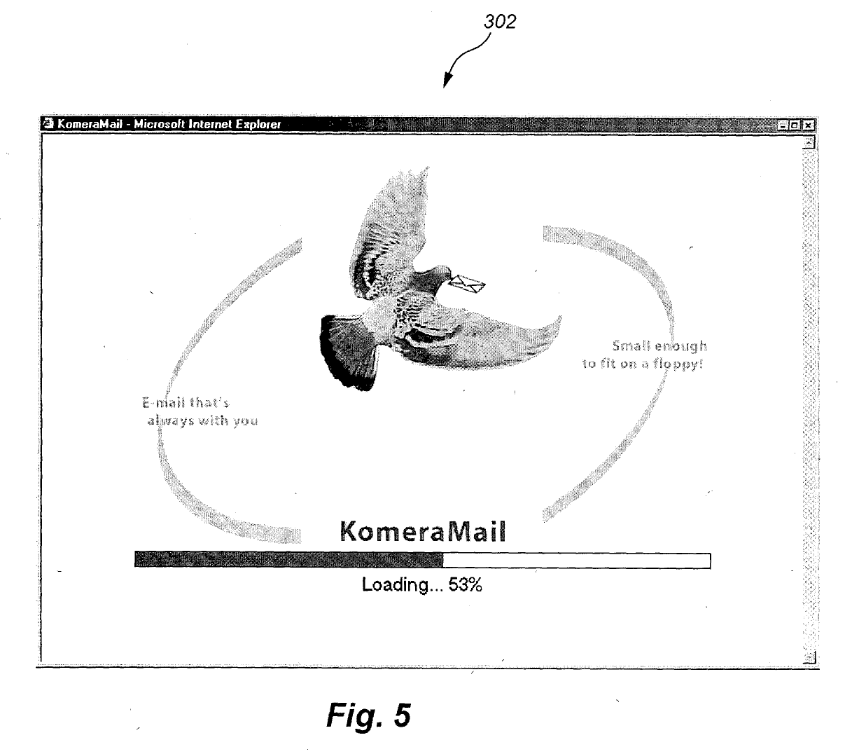

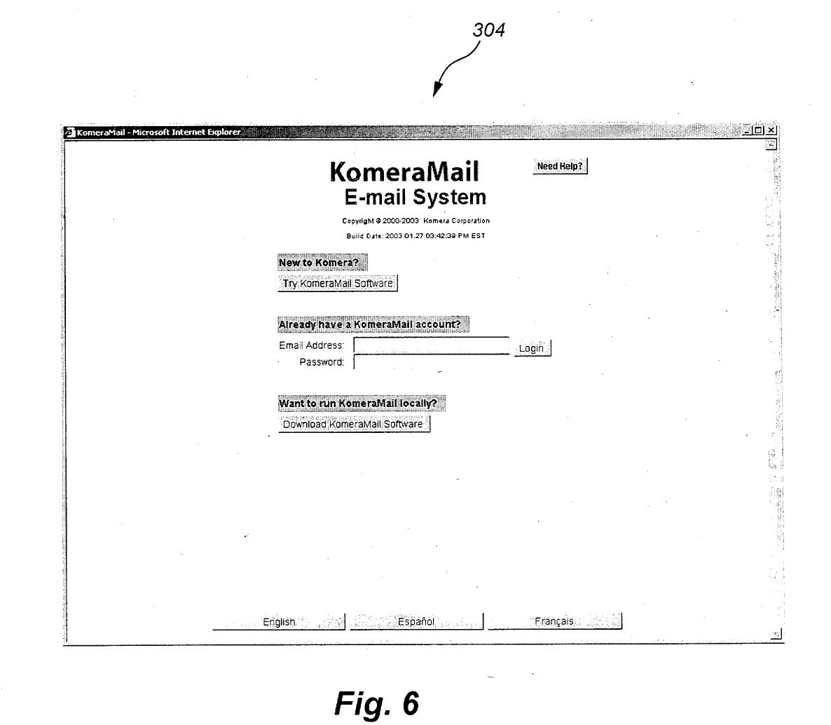

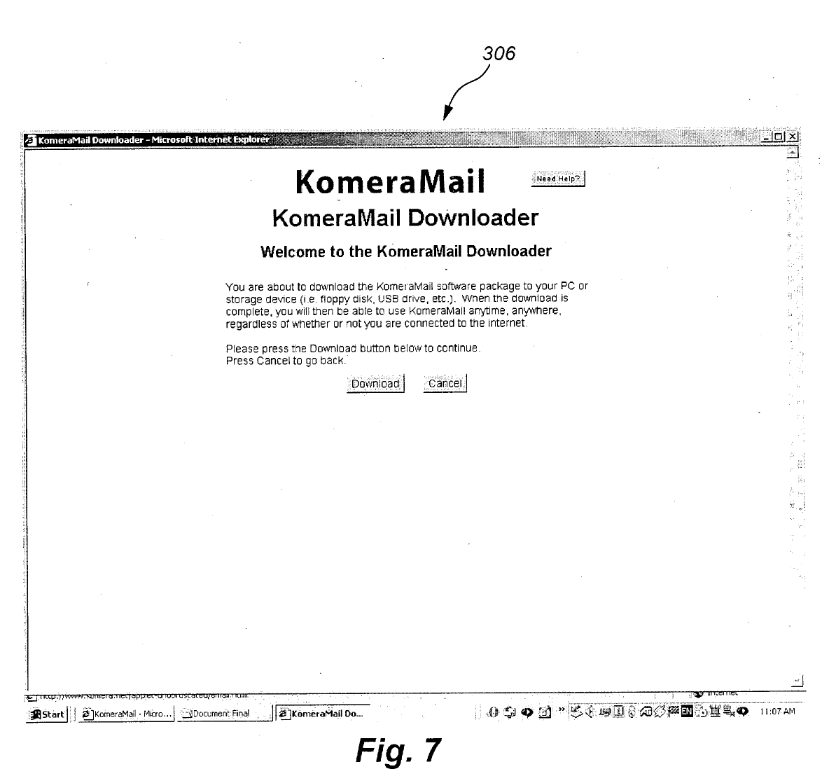

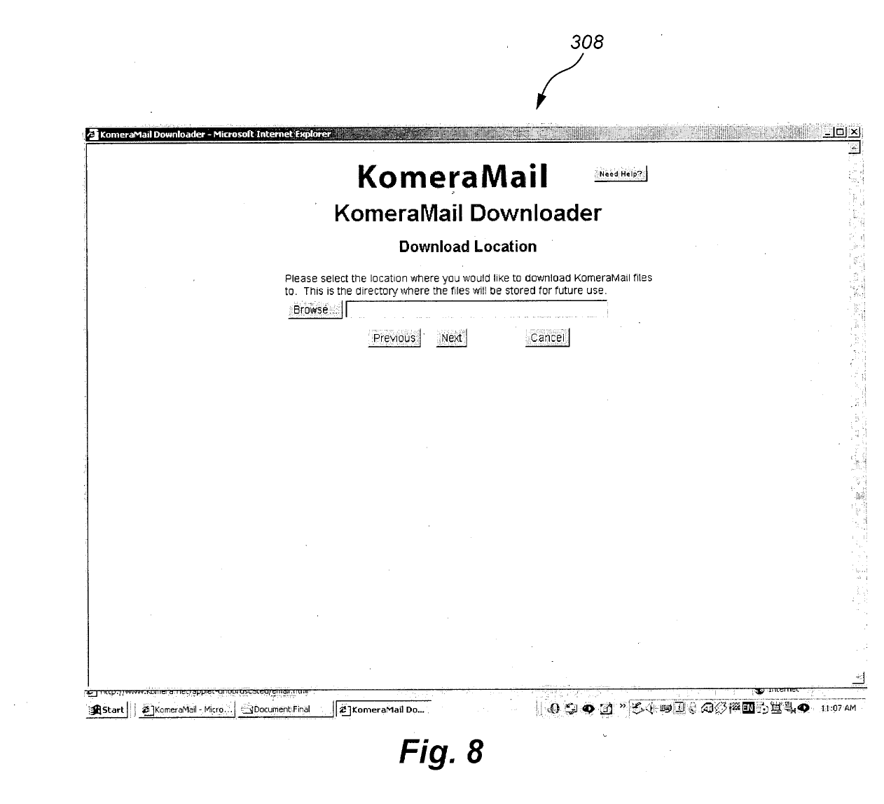

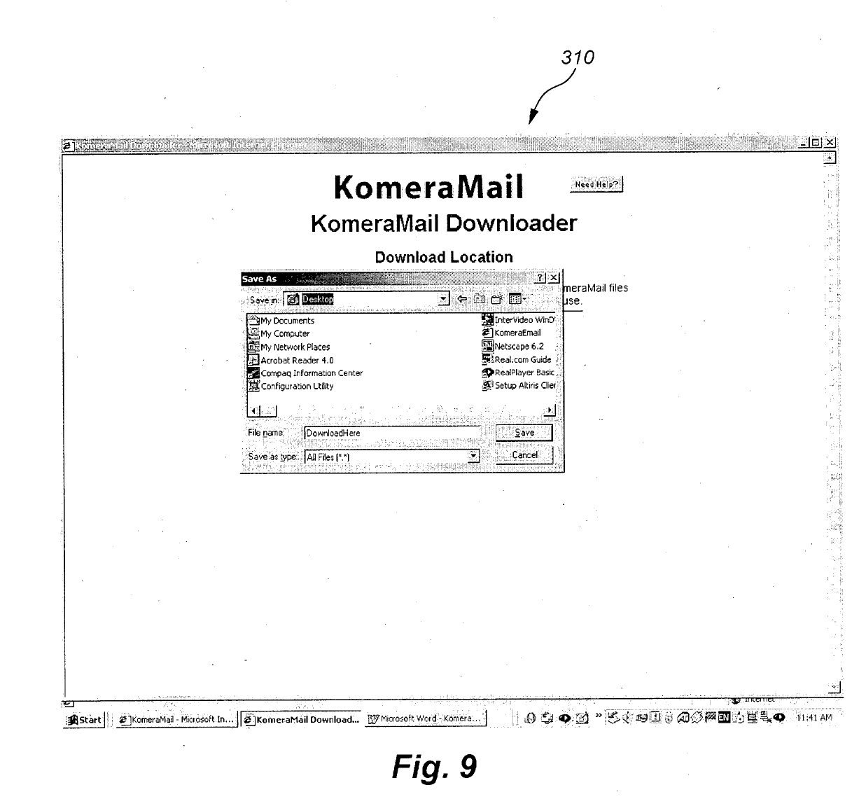

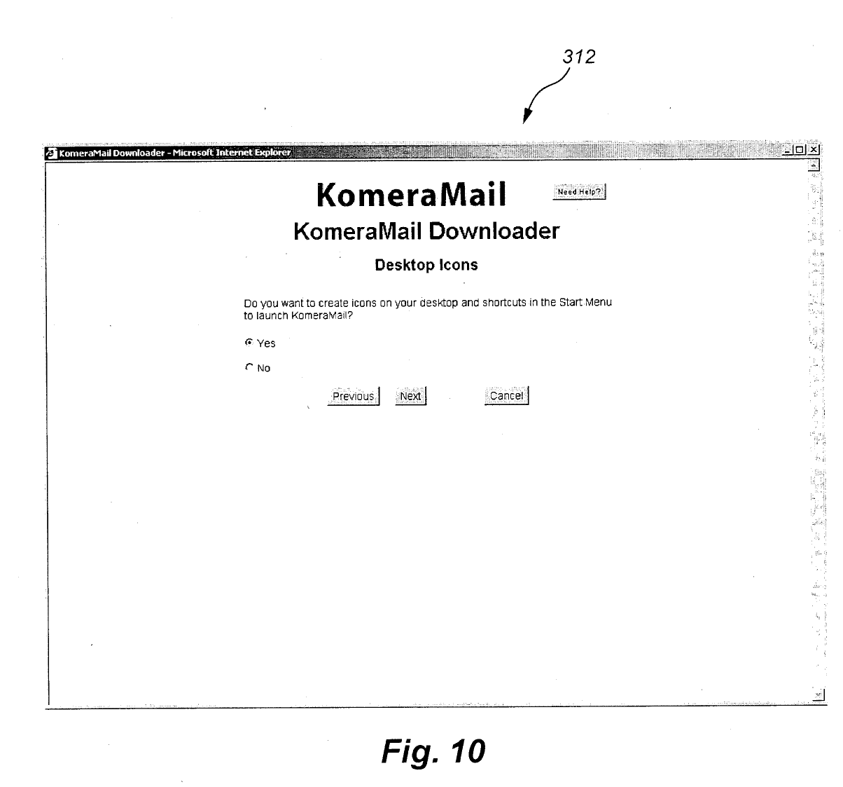

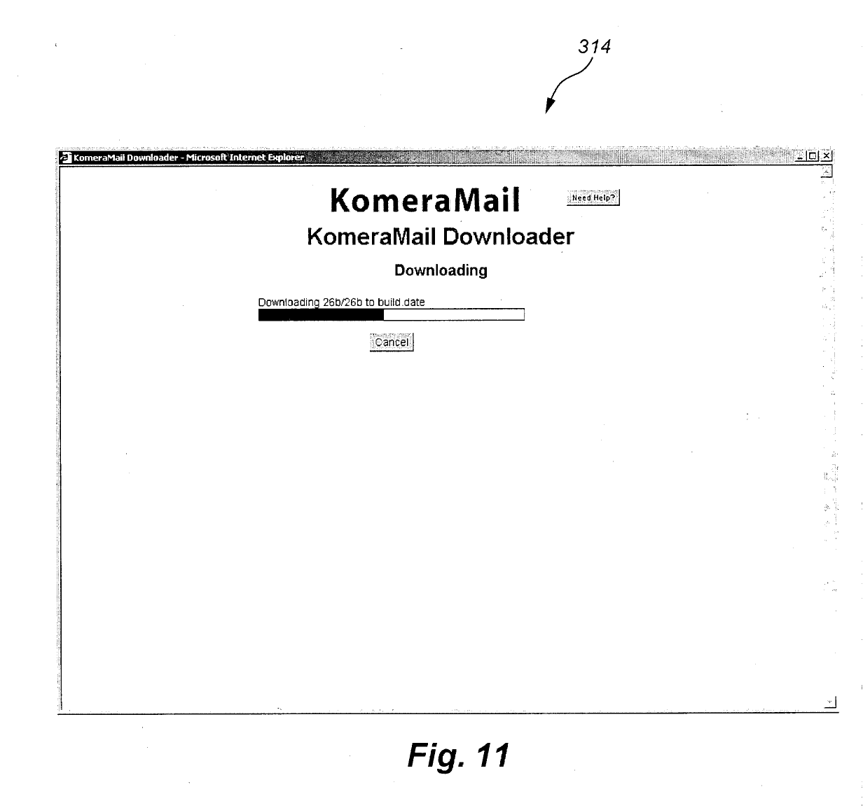

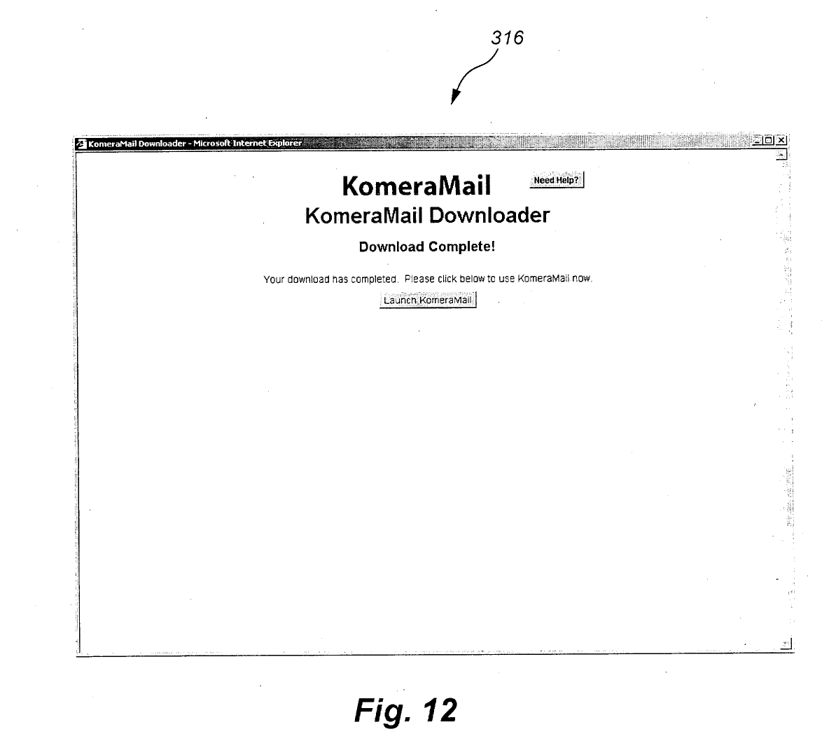

Screens for downloading the portable email software 100 are shown in FIGS. 4-12. FIG. 4 shows an image of a screen 300 initializing the portable email software 100. FIG. 5 shows an image of a screen 302 indicating initializing progress of the portable email software 100. FIG. 6 shows an image of a screen 304 showing options available to a user who visits an Internet website where portable email software is stored on the website server. FIG. 7 shows an image of a screen 306 for selecting whether to download the portable email software 100. FIG. 8 shows an image of a screen 308 for allowing a user to enter or to browse for a location where files for the portable email software 100 will be downloaded. FIG. 9 shows an image of a screen 310 for downloading onto the desktop files for the portable email software 100. FIG. 10 shows an image of a screen 312 for selecting whether to download desktop icons for the portable email software 100. FIG. 11 shows an image of a screen 314 indicating the progress of the portable email software 100 being downloaded. FIG. 12 shows an image of a screen 316 indicating download completion of the portable email software 100.

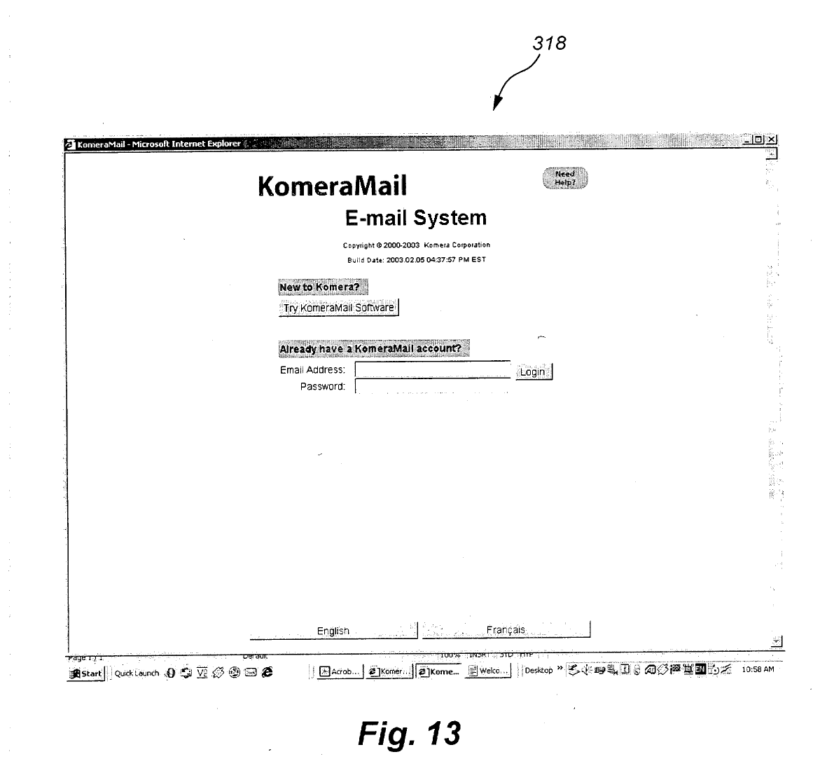

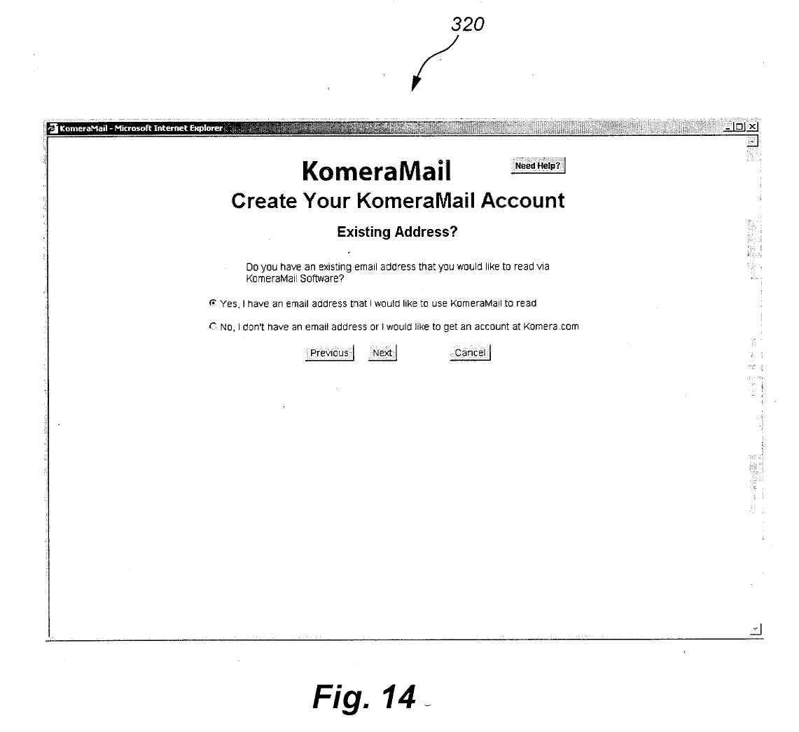

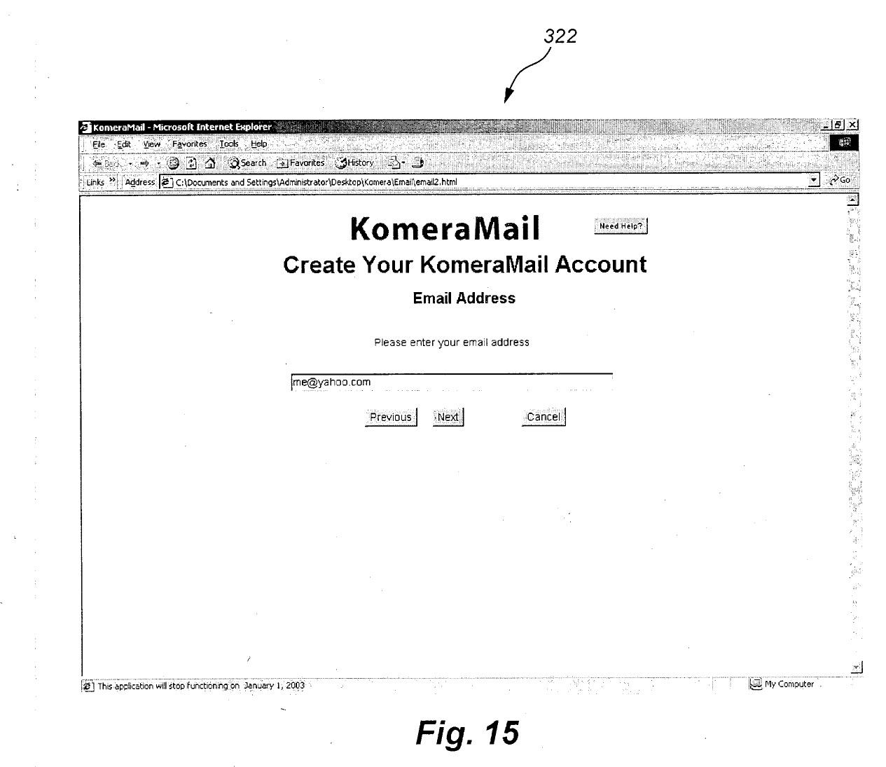

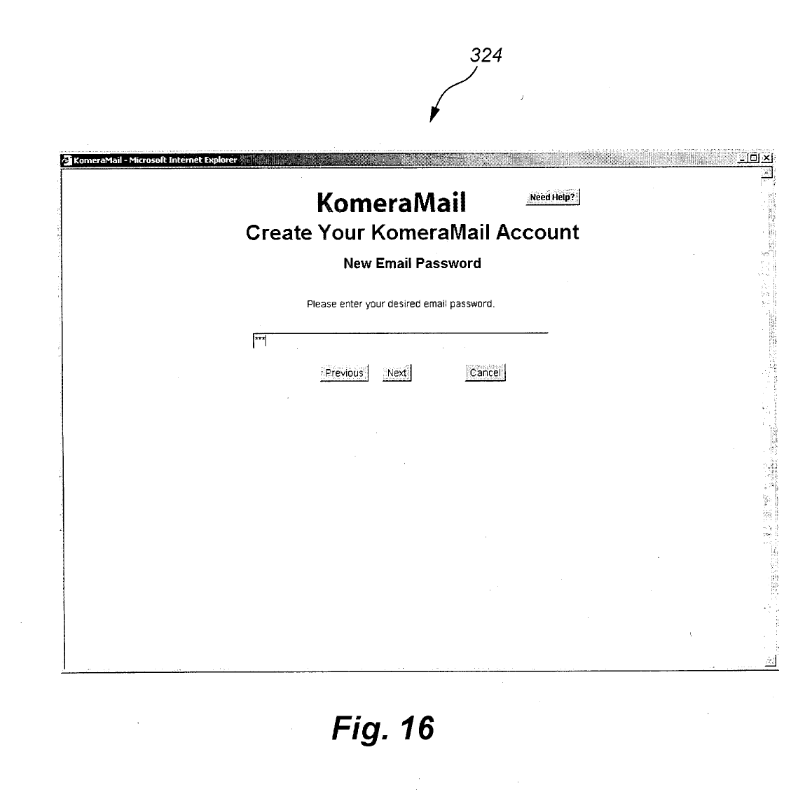

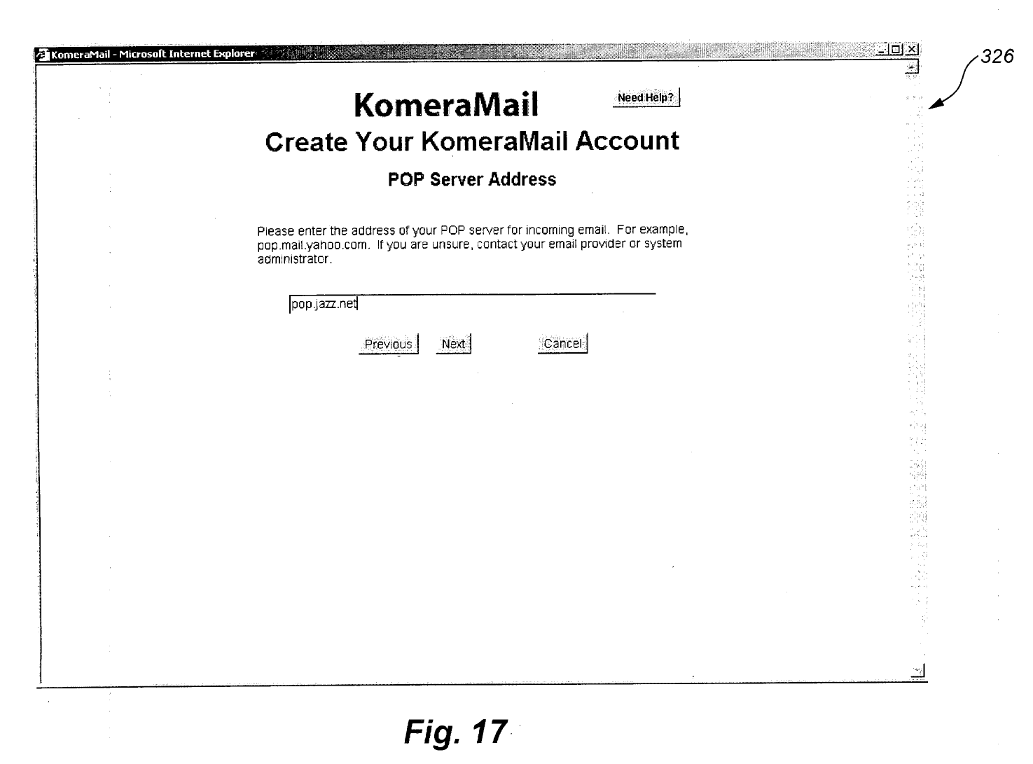

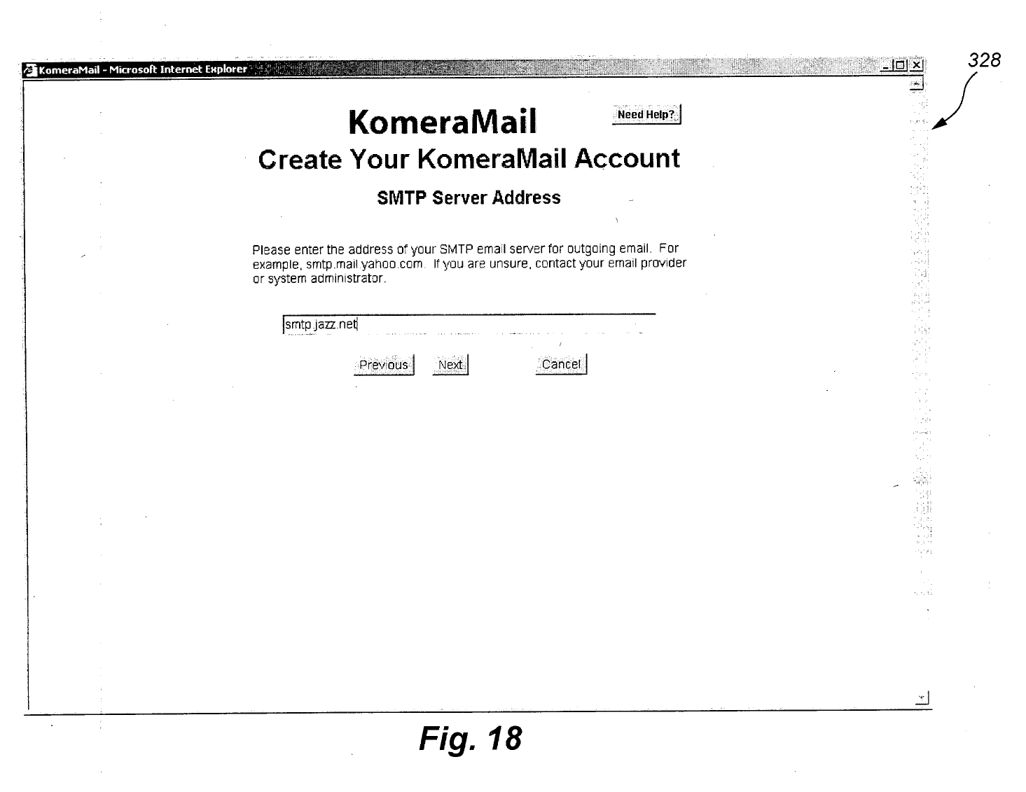

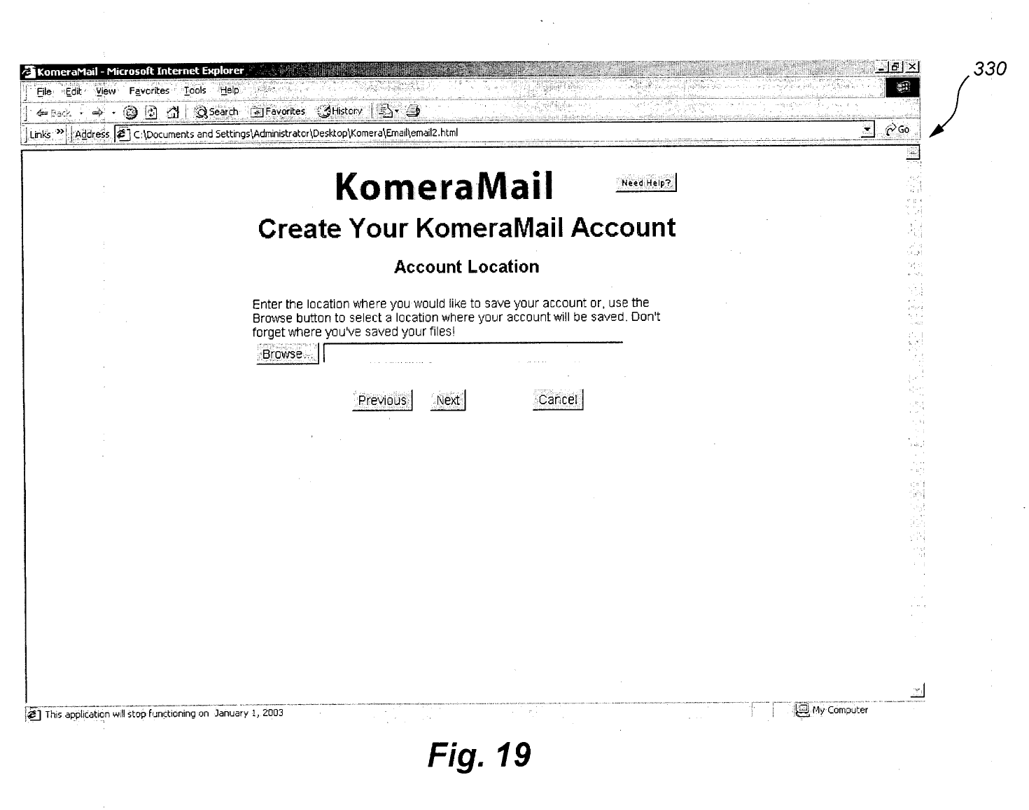

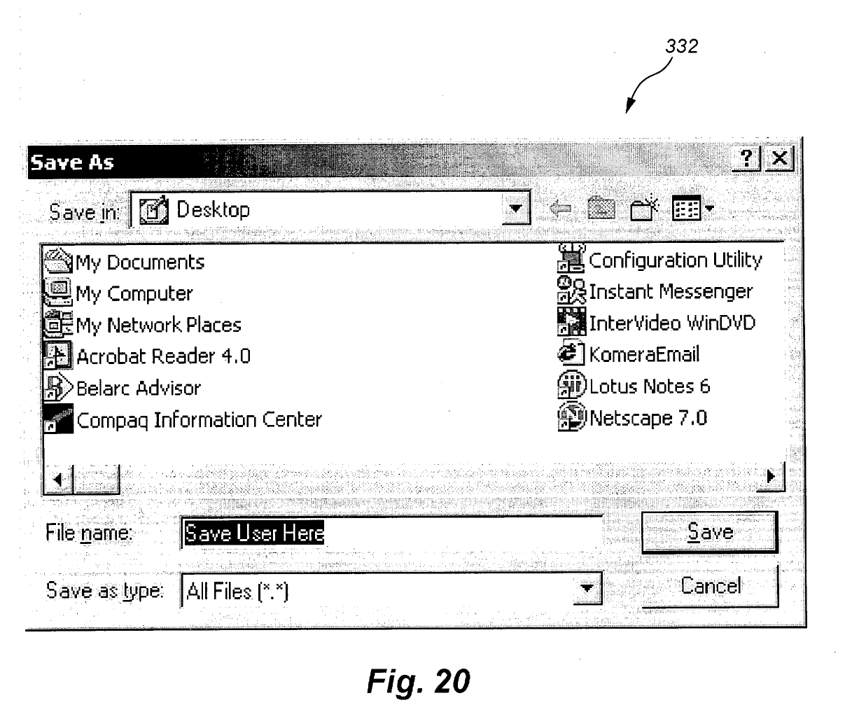

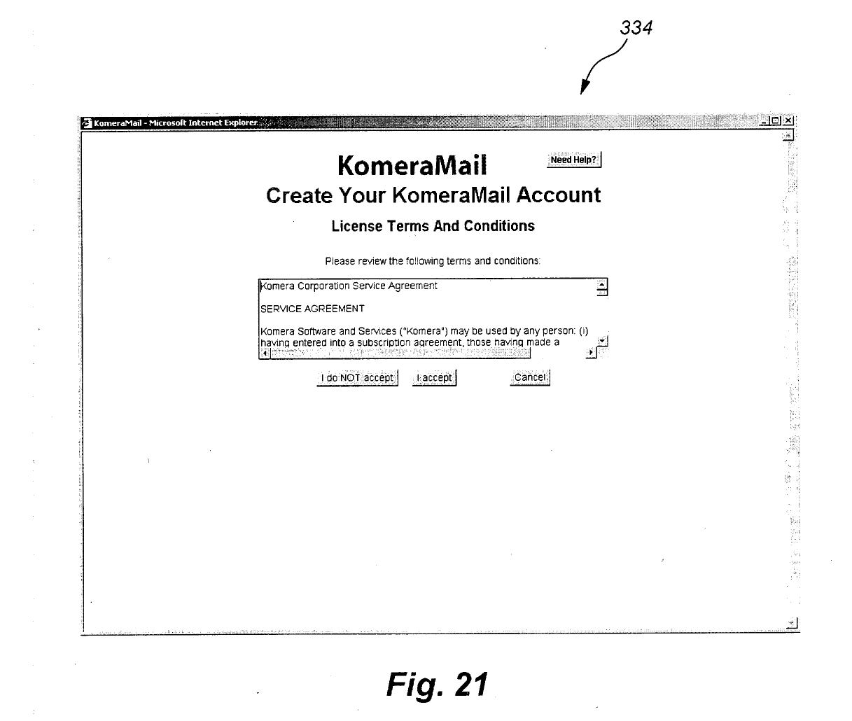

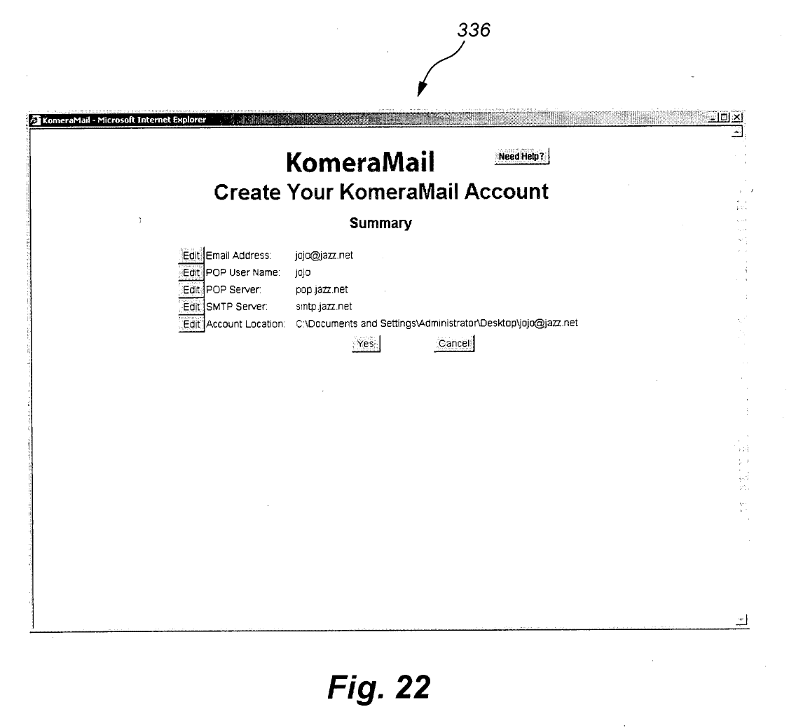

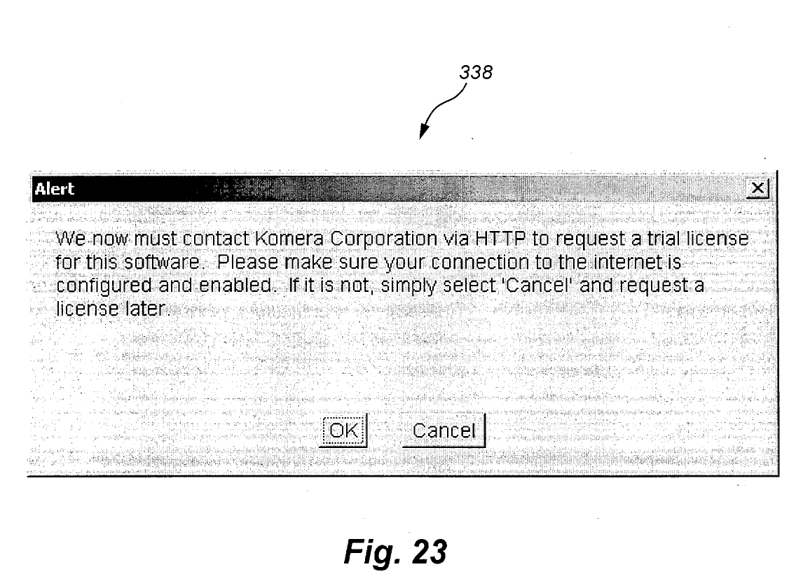

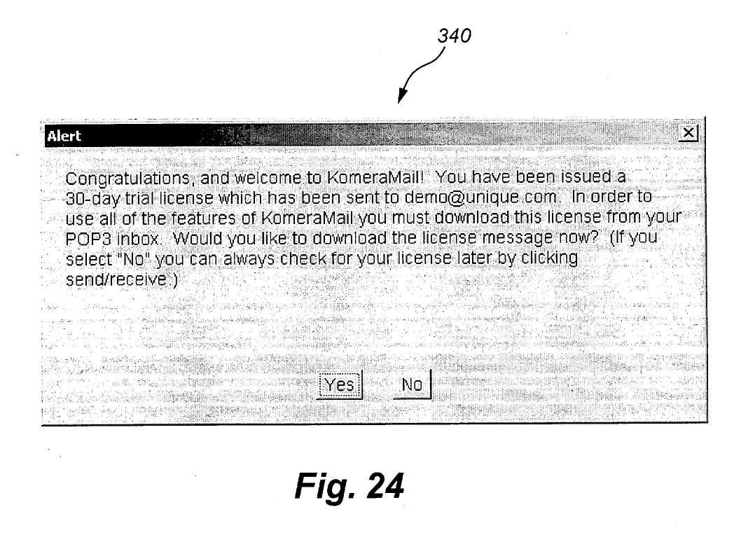

Screens for reading data from an existing email account using the portable email software 100 are shown in FIGS. 13-24. FIG. 13 shows an image of a screen 318 for selecting whether to create a portable email account or to read data from an existing email account using the portable email software 100. FIG. 14 shows an image of a screen 320 presented to a user who has selected to read data from an existing email account using the portable email software 100. FIG. 15 shows an image of a screen 322 for entering the email address of an existing email account. FIG. 16 shows an image of a screen 324 for entering a password for a portable email account that will be able to read data from an existing email account. FIG. 17 shows an image of a screen 326 for entering an address of a POP/IMAP server for incoming mail for a portable email account. FIG. 18 shows an image of a screen 328 for entering an address of an SMTP server for outgoing mail for a portable email account. FIG. 19 shows an image of a screen 330 for entering a location where a portable email account will be saved. FIG. 20 shows an image of a screen 332 for saving a portable email account on the desktop of a computer or some other location. FIG. 21 shows an image of a screen 334 for providing a user with license terms and conditions for a portable email account. FIG. 22 shows an image of a screen 336 for providing the user with a summary of portable email account information. FIG. 23 shows an image of a screen 338 for notifying a user to request a trial license from an entity associated with the portable email messaging software 100. FIG. 24 shows an image of a screen 340 for notifying a user that the user has been provided with a trial license for a portable email account.

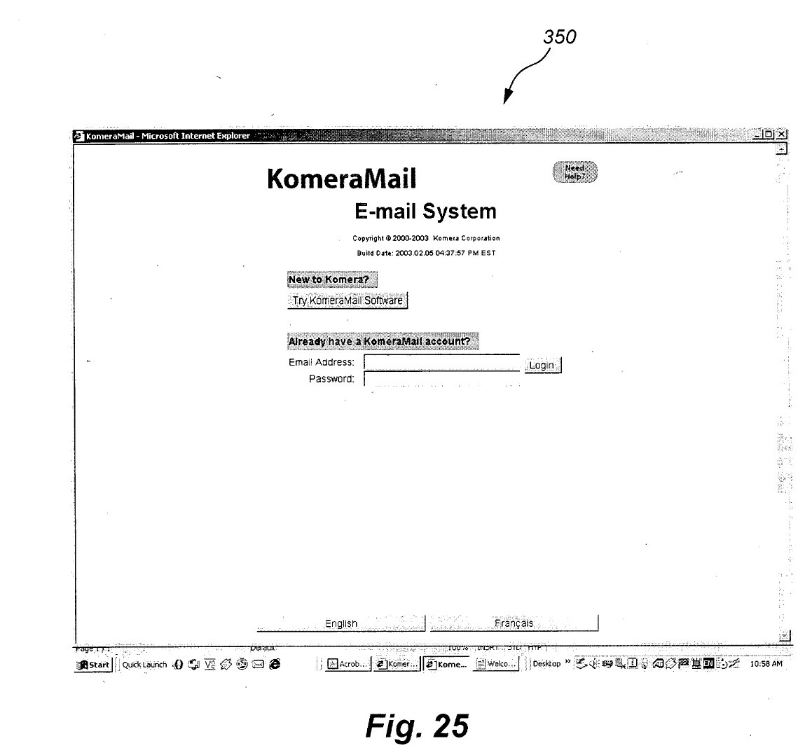

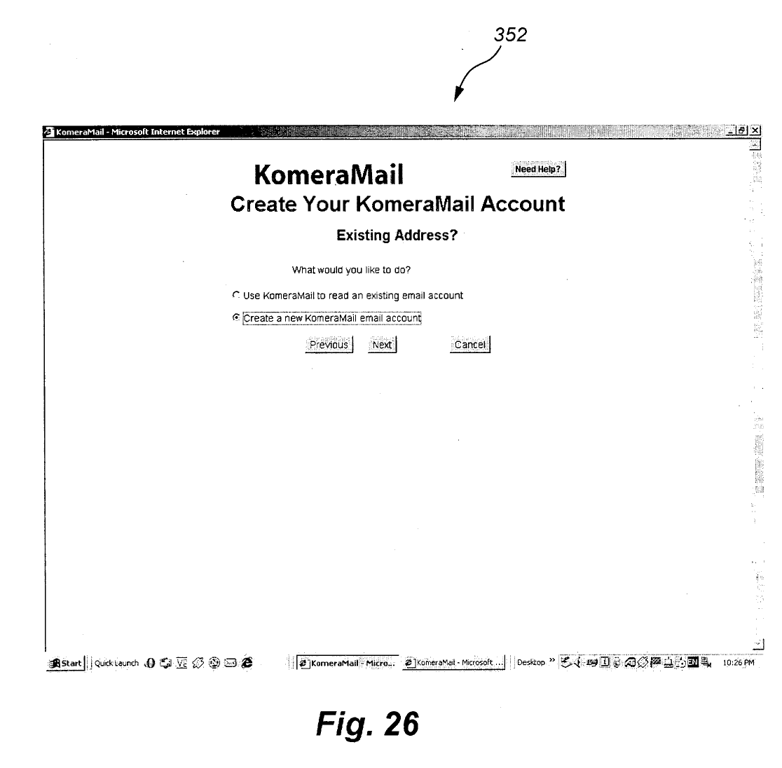

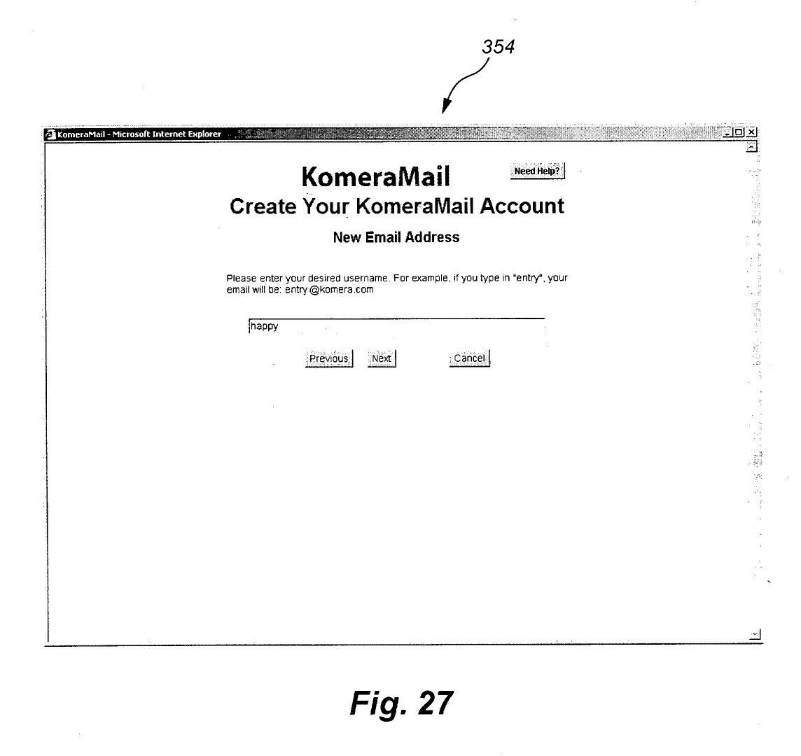

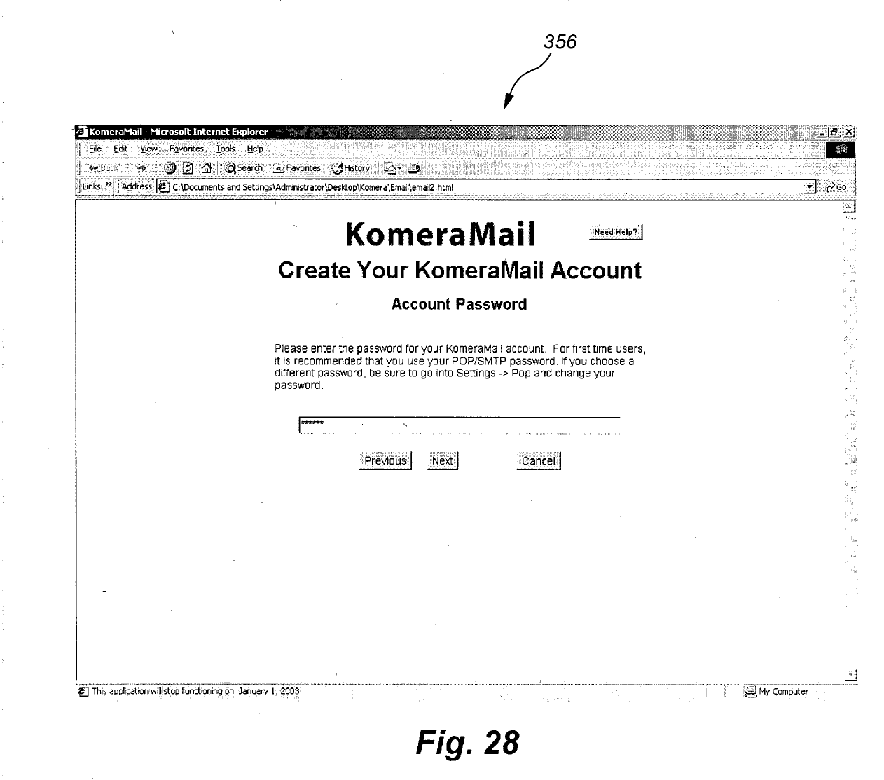

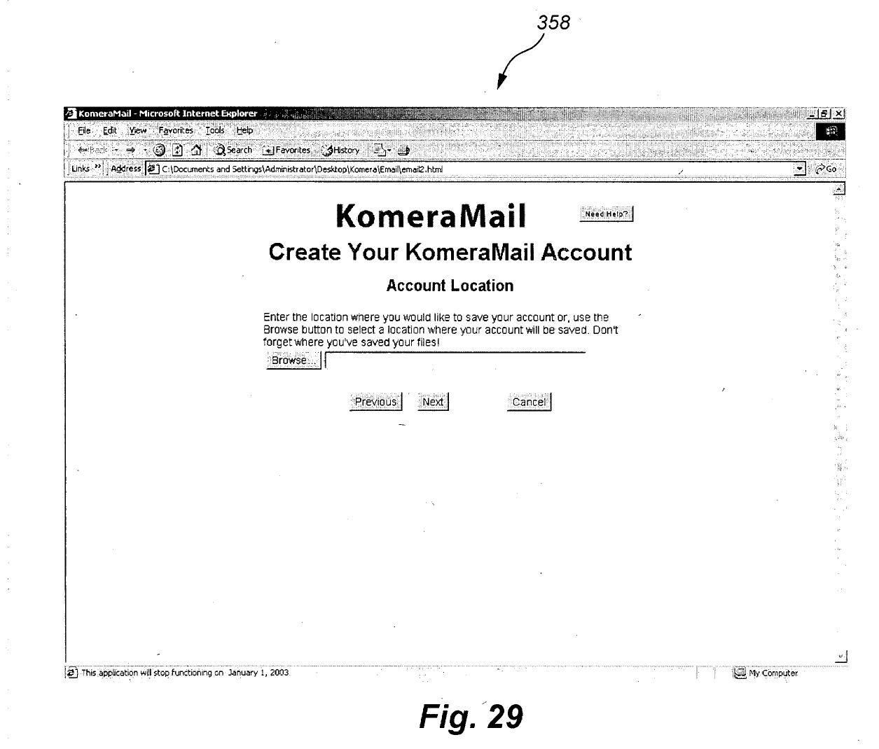

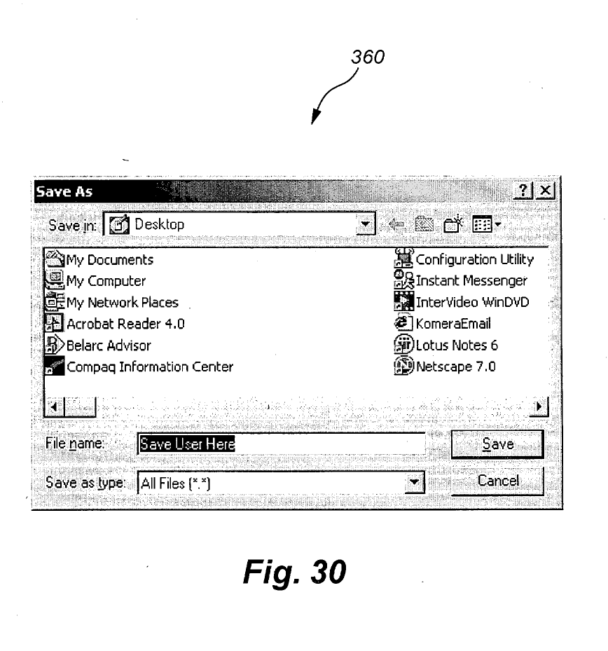

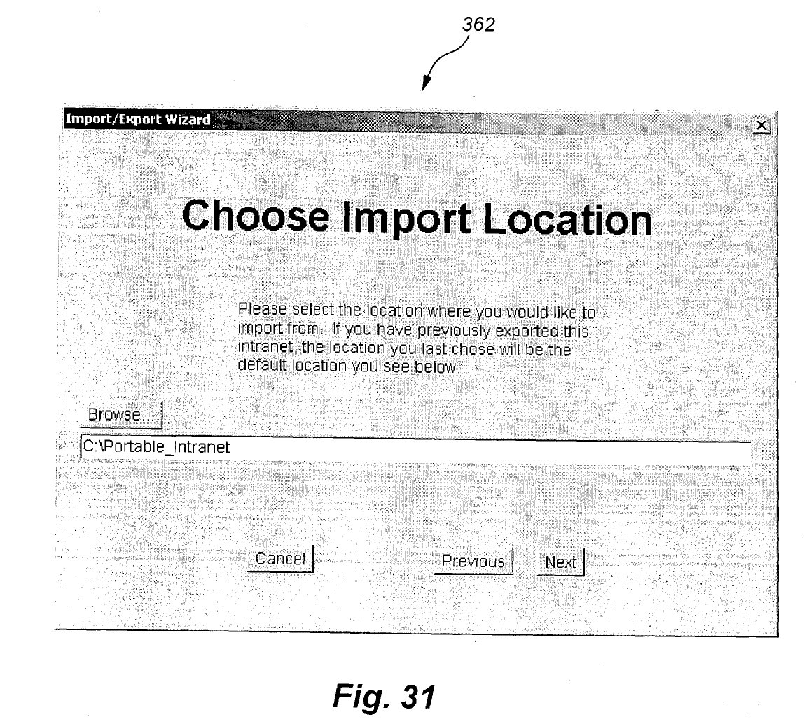

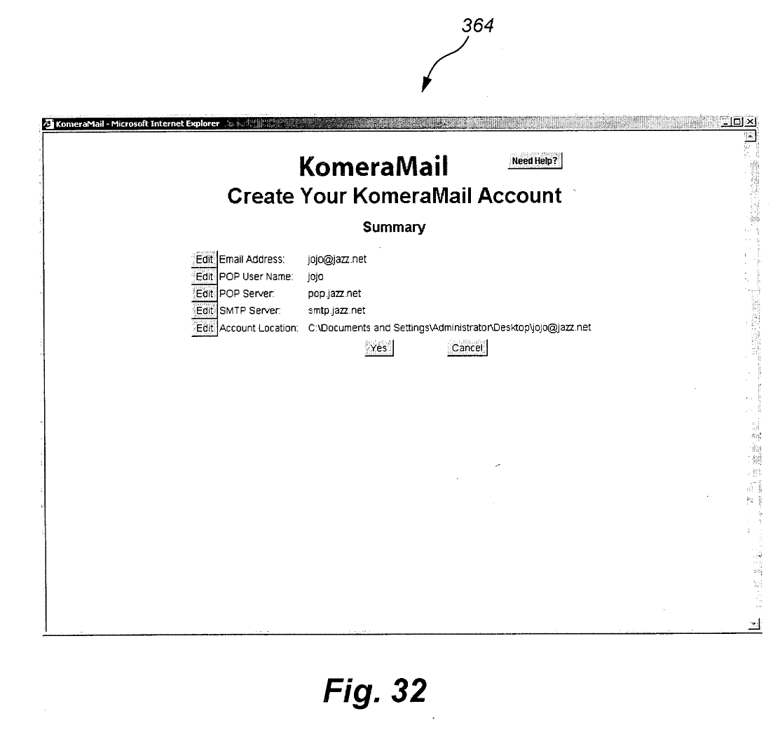

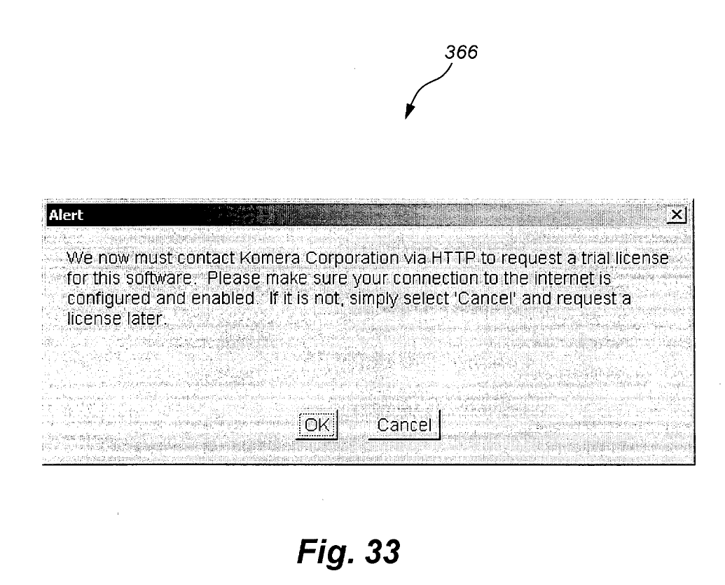

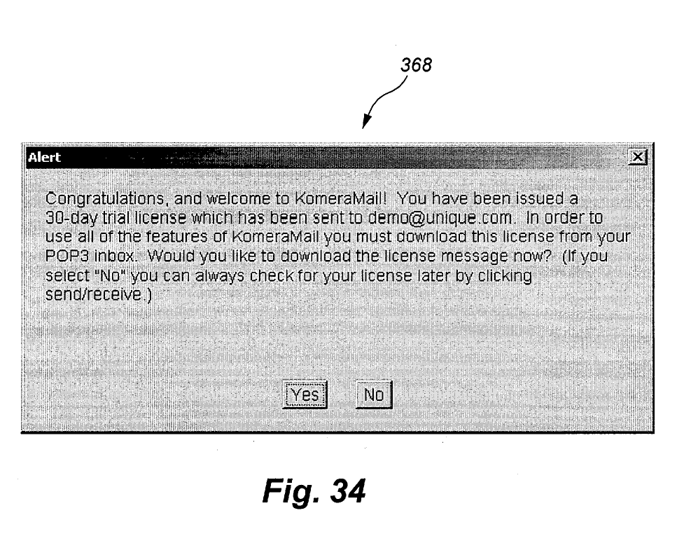

Screens for creating a new portable email account using the portable email messaging software 100 are shown in FIGS. 25-34. FIG. 25 shows an image of a screen 350 for selecting whether to create a portable email account or to log into an existing portable email account using the portable email software 100. FIG. 26 shows an image of a screen 352 presented to a user that has selected to create a new email account on an email server of an entity configured to create email accounts on the fly using the portable email software 100. FIG. 27 shows an image of a screen 354 for entering a username for a portable email account that is being created using the portable email software 100. FIG. 28 shows an image of a screen 356 for entering a password for a portable email account that is being created using the portable email software 100. FIG. 29 shows an image of a screen 358 for entering or browsing for a location where a portable email account will be saved. FIG. 30 shows an image of a screen 360 for saving a portable email account on a desktop of a computer or some other location. FIG. 31 shows an image of a screen 362 providing a user with license terms and conditions of a portable email account. FIG. 32 shows an image of a screen 364 for providing a user with a summary of account information for a portable email account. FIG. 33 shows an image of a screen 366 for notifying a user to request a trial license from an entity associated with portable email software 100. FIG. 34 shows an image of a screen 368 for informing a user that the user has been provided with a trial license for a portable email account.

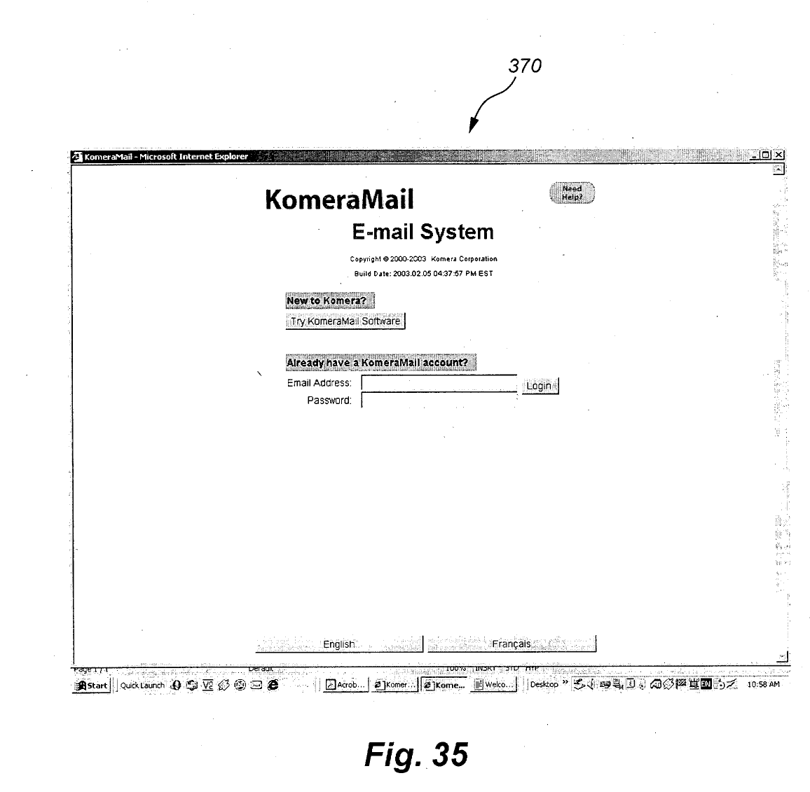

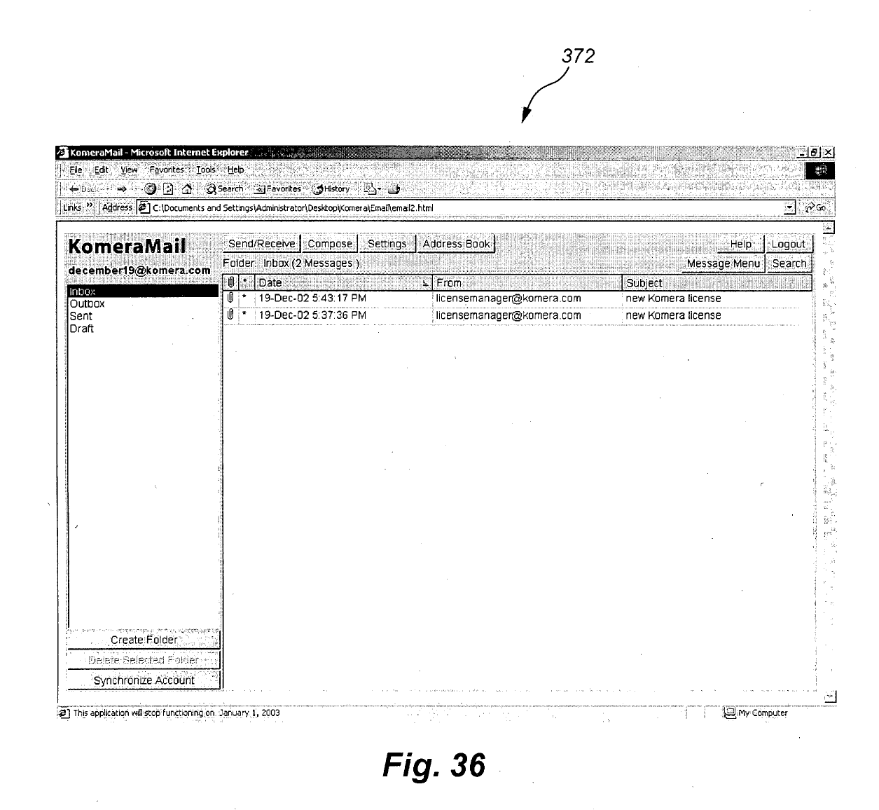

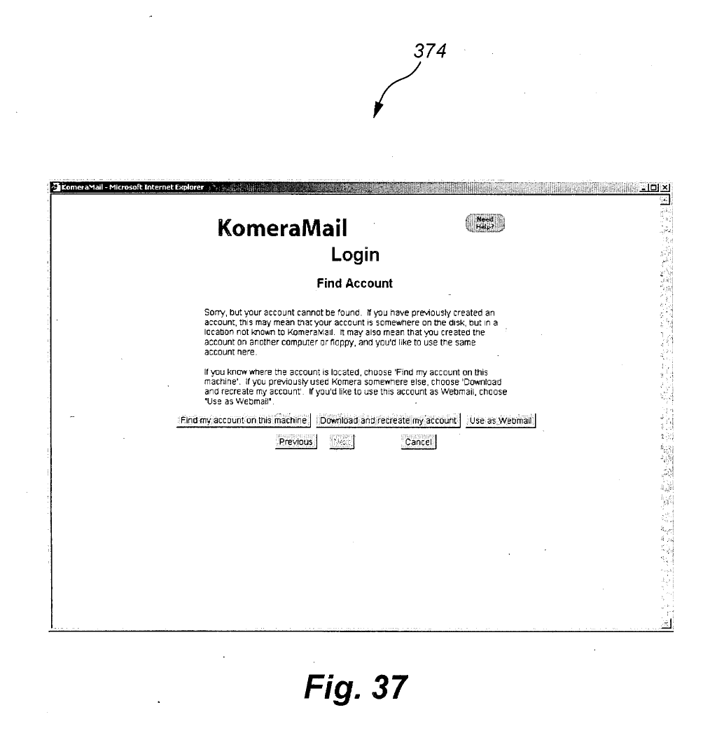

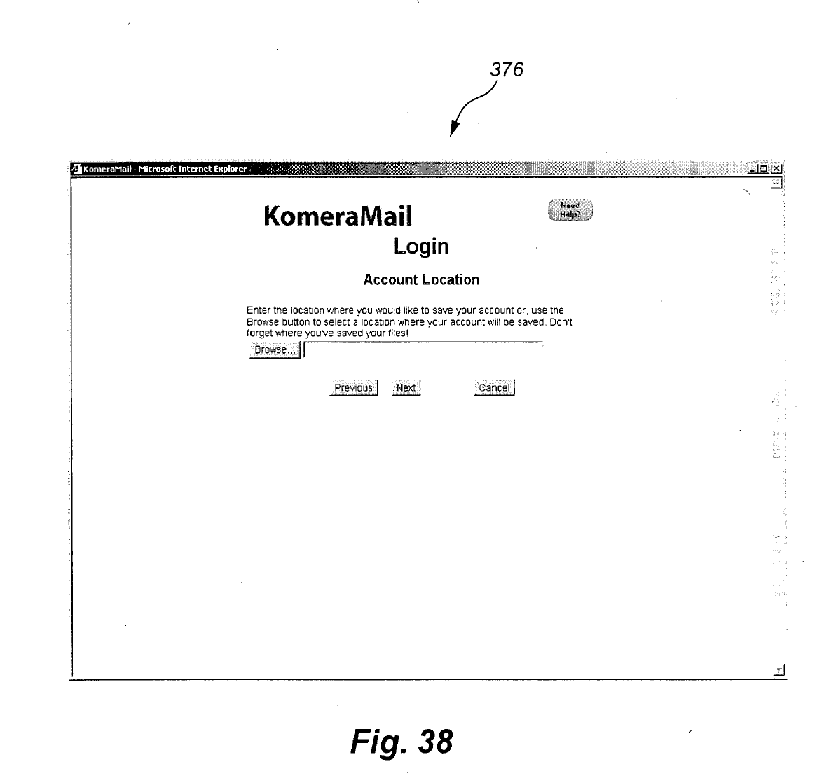

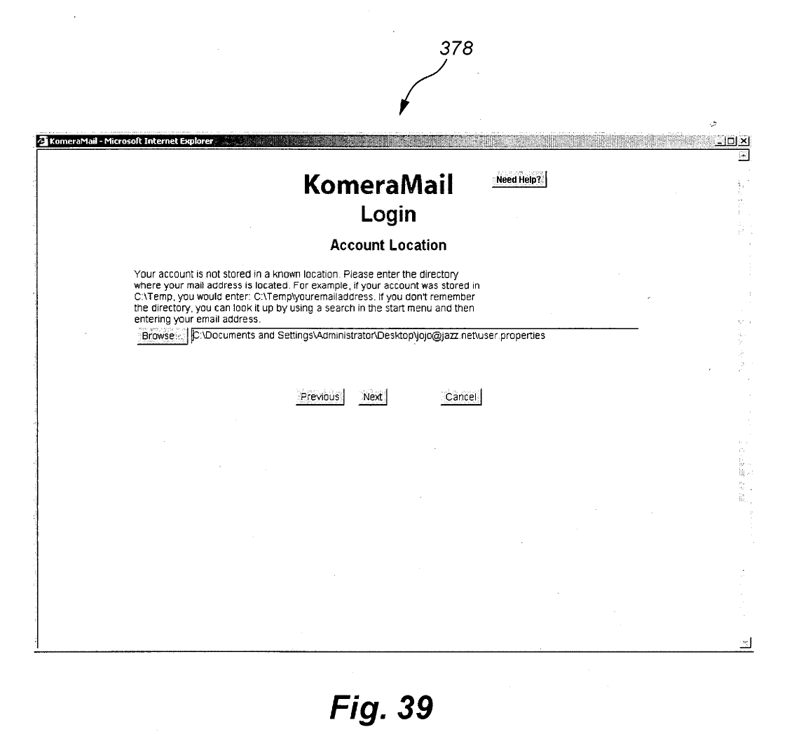

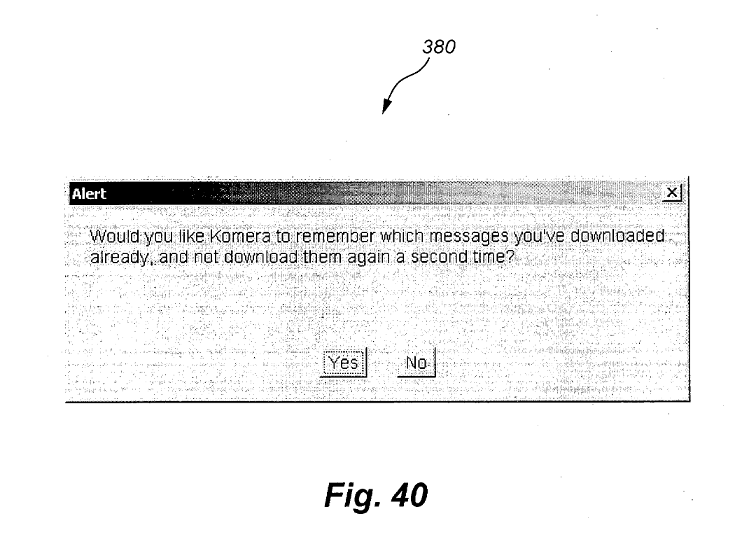

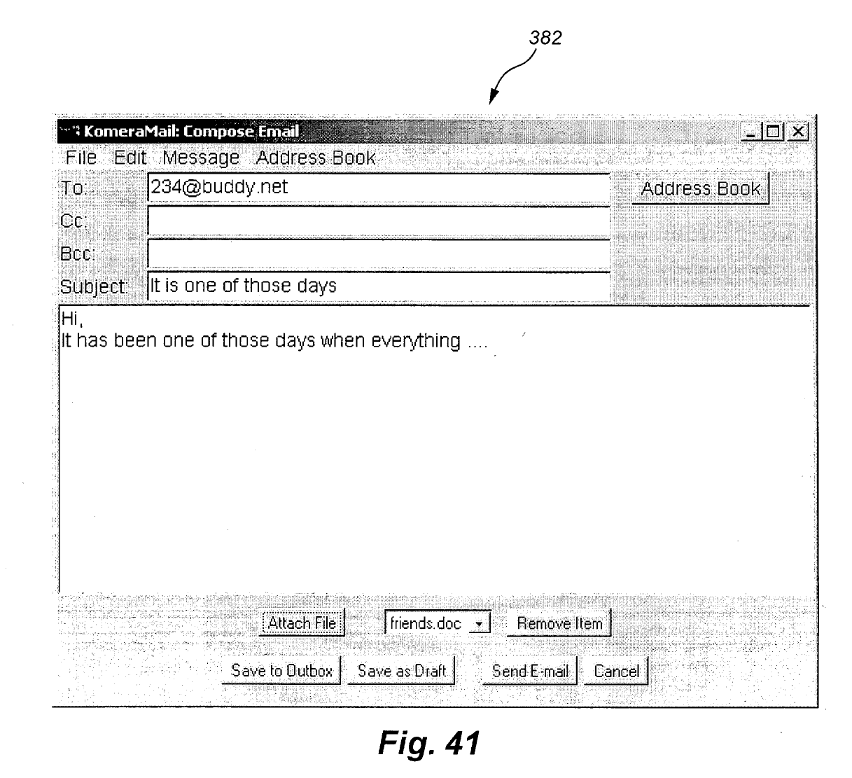

Screens for showing how to log into and use a portable email account that has been created by the portable email software 100 are shown in FIGS. 35-57. FIG. 35 shows an image of a screen 370 for entering an email address and password of a portable email account. FIG. 36 shows an image of a screen 372 for a portable email account. FIG. 37 shows an image of a screen 374 for enabling a user to select whether to find a portable email account on a computer, to download the portable email account from a back-up remote server and recreate the portable email account onto the computer, or to use the portable email account as a webmail. FIG. 38 shows an image of a screen 376 for enabling a user to enter a directory location where a portable email account downloaded from a remote back-up server may be stored. FIG. 39 shows an image of a screen 378 for entering a location where the user portable email account is stored. FIG. 40 shows an image of a screen 380 for selecting whether portable email messaging software should remember messages that have been previously downloaded from a POP/IMAP server. FIG. 41 shows an image of a screen 382 for composing an email message using a portable email account.

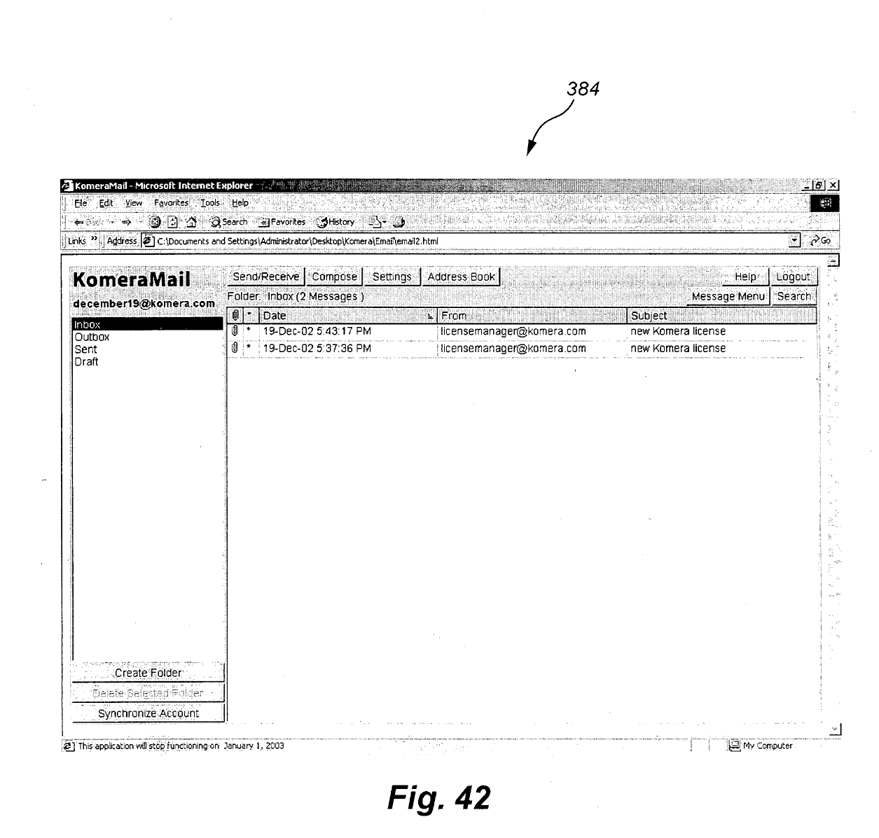

FIG. 42 shows an image of a screen 384 for a portable email account. The screen 384 includes an INBOX folder, an OUTBOX folder, a SENT folder, and a DRAFT folder. The screen 384 also includes a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key. The INBOX, OUTBOX, SENT, and DRAFT folders correspond with INBOX, OUTBOX, SENT, and DRAFT folders found on typical email accounts. Similarly, the SEND/RECEIVE, COMPOSE, ADDRESS BOOK, HELP, SEARCH, and LOGOUT keys correspond to associated keys found on typical email accounts. As described above, users may establish a connection to the Internet at their convenience, on any computer accessible to the Internet, and execute the portable email software, and click on a SEND/RECEIVE key, to send and/or receive email messages. The time period required for establishing a handshake between the user computer and the user's SMTP and/or POP/IMAP server is brief. Once the contact between the user computer and the email server has been established, user ready to send messages are transferred via the user's SMTP server and recent email messages that have not been downloaded from the user's inbox on the user's POP/IMAP server are retrieved when the user clicks on the SEND/RECEIVE key

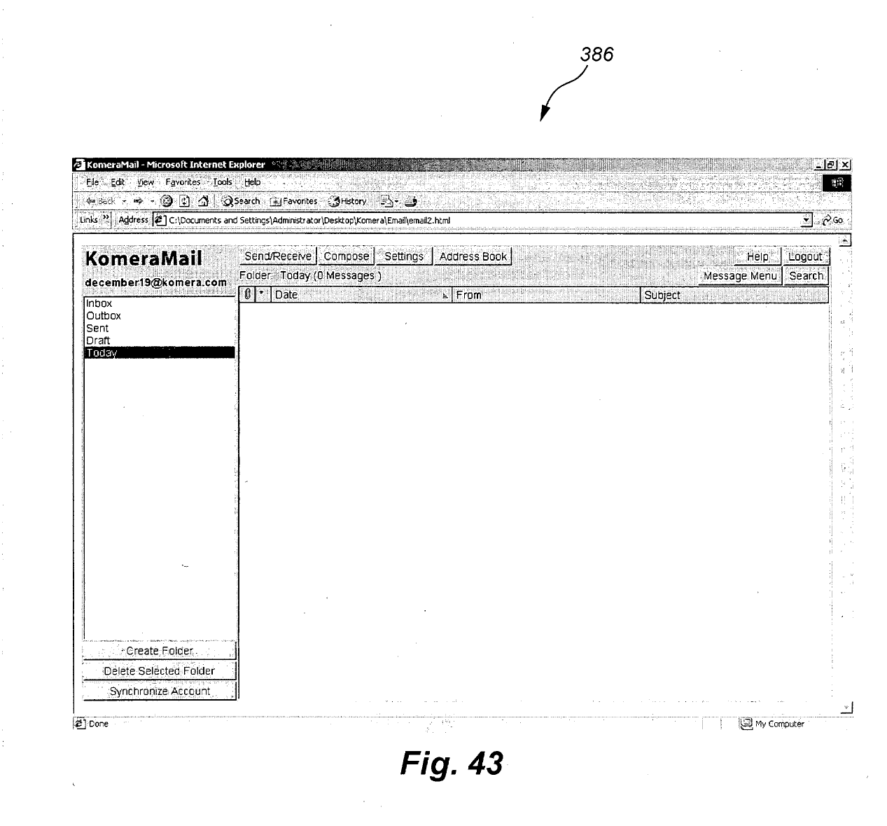

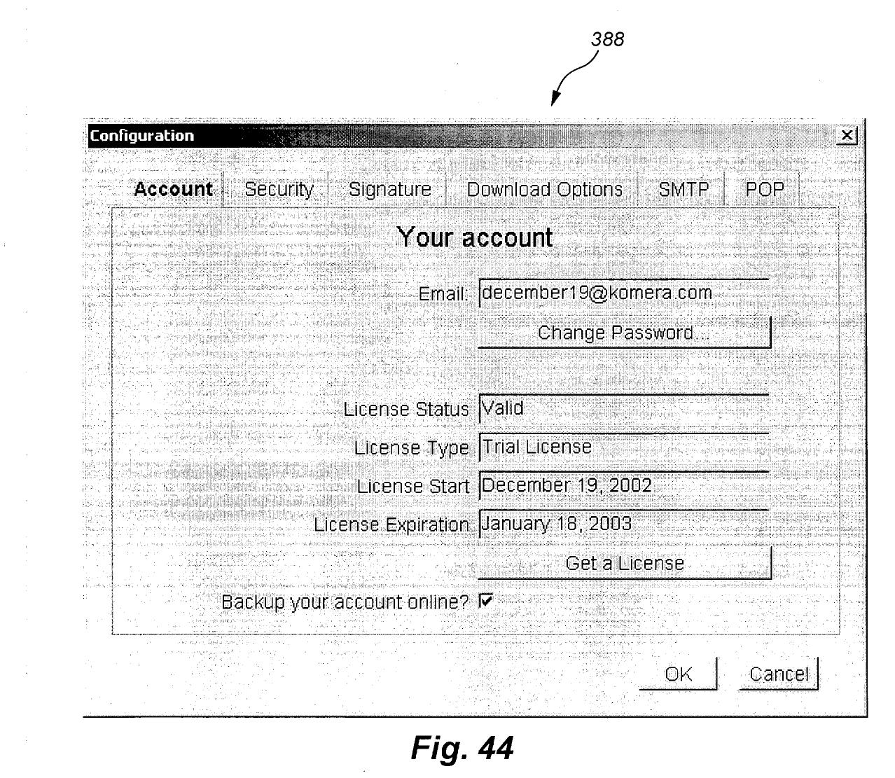

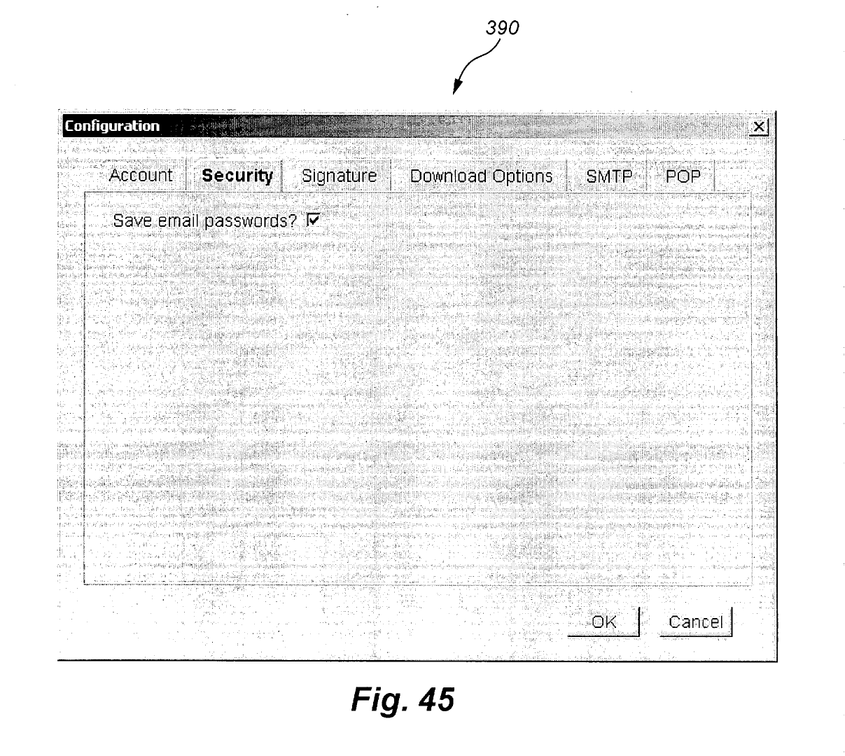

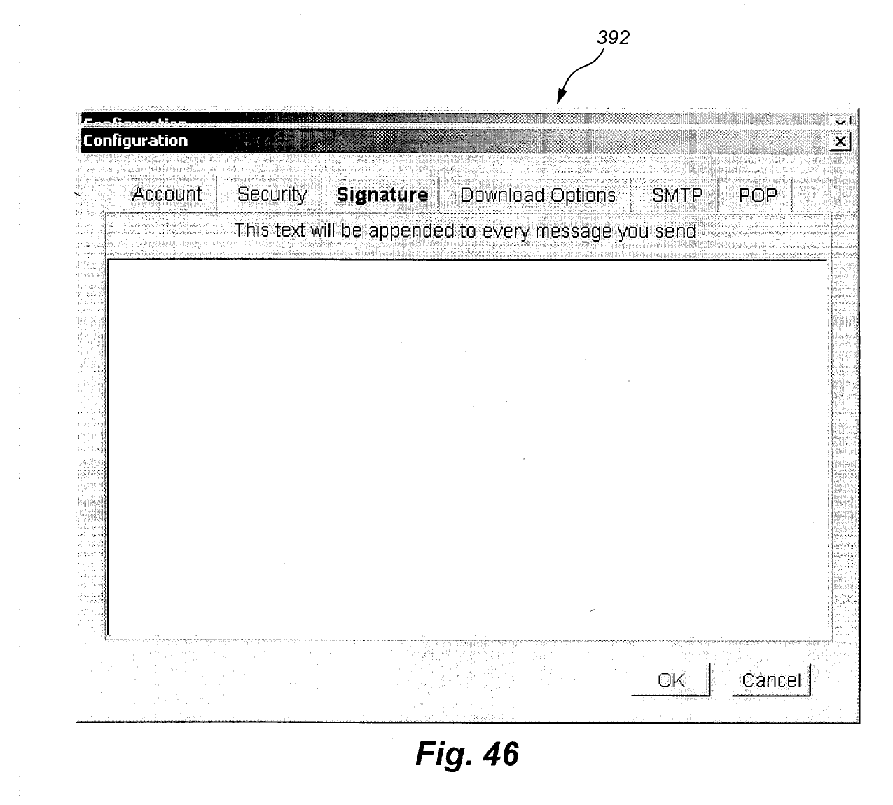

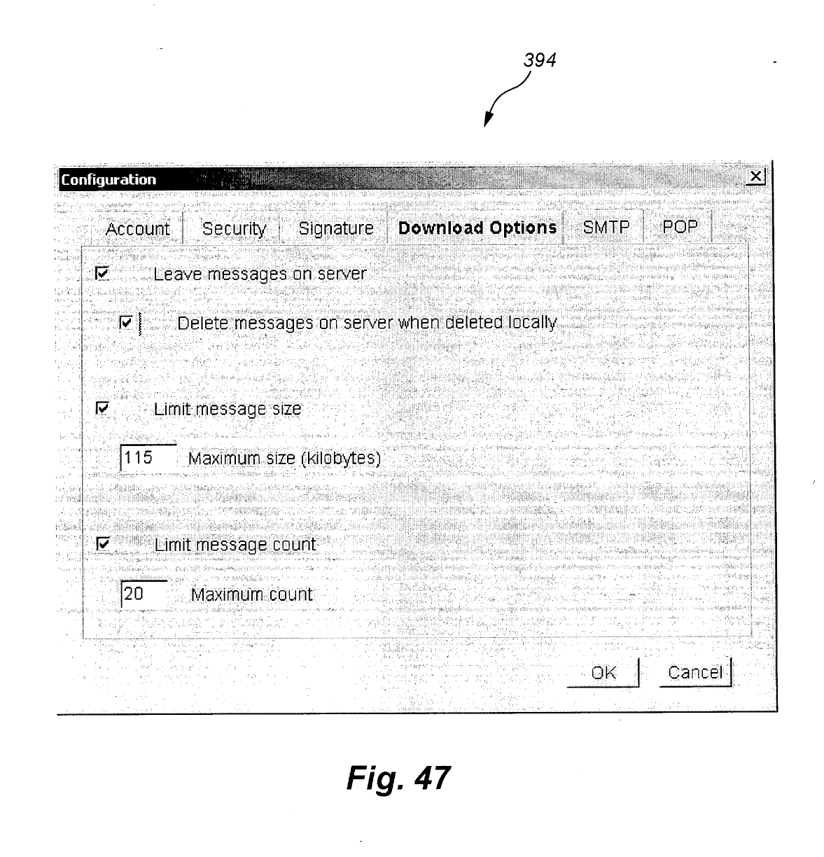

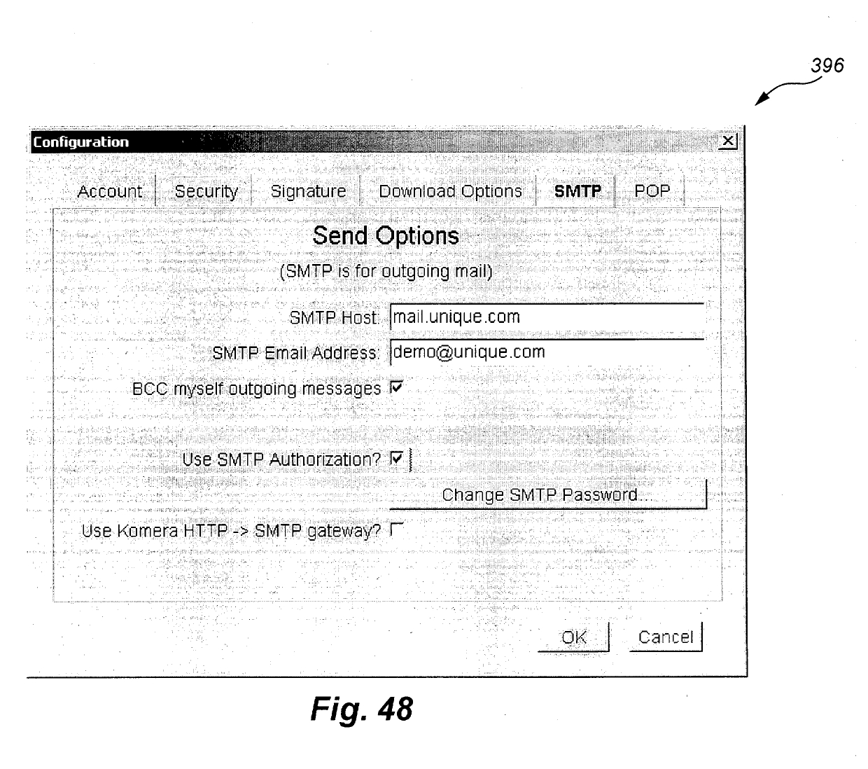

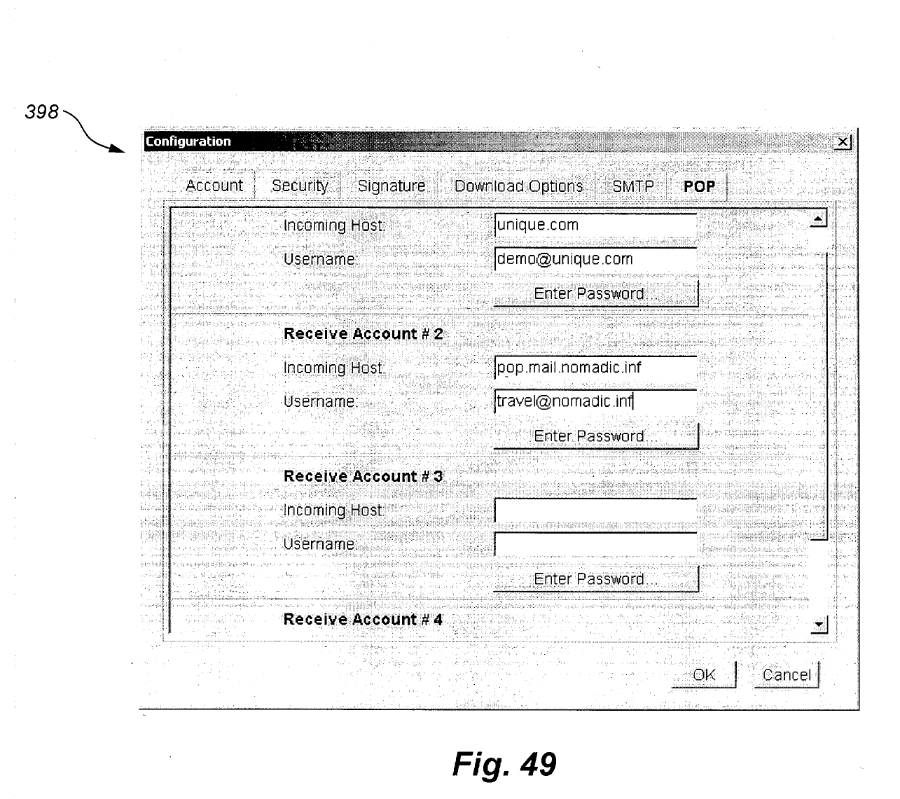

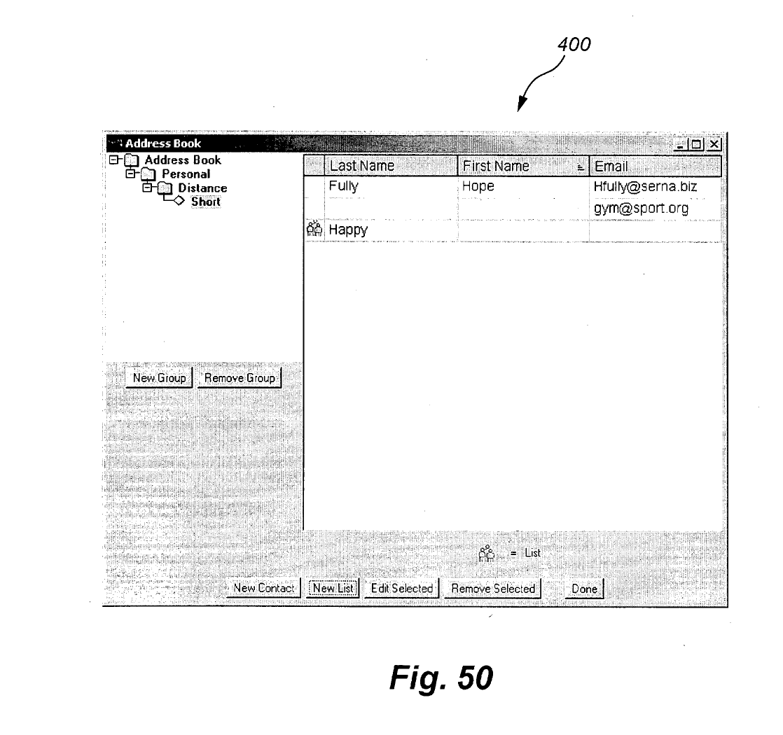

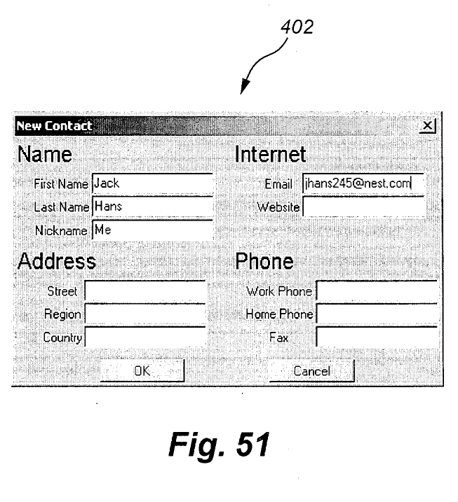

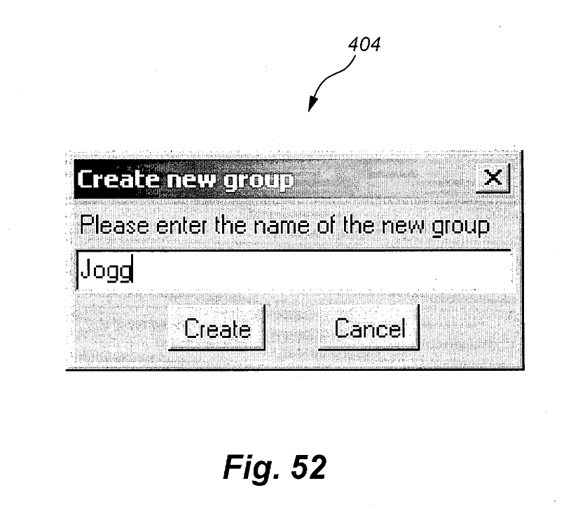

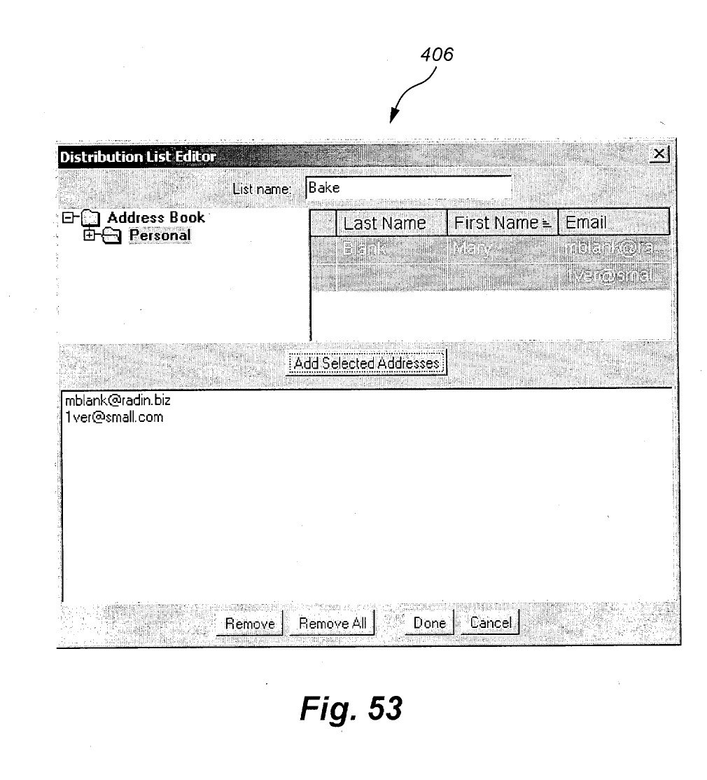

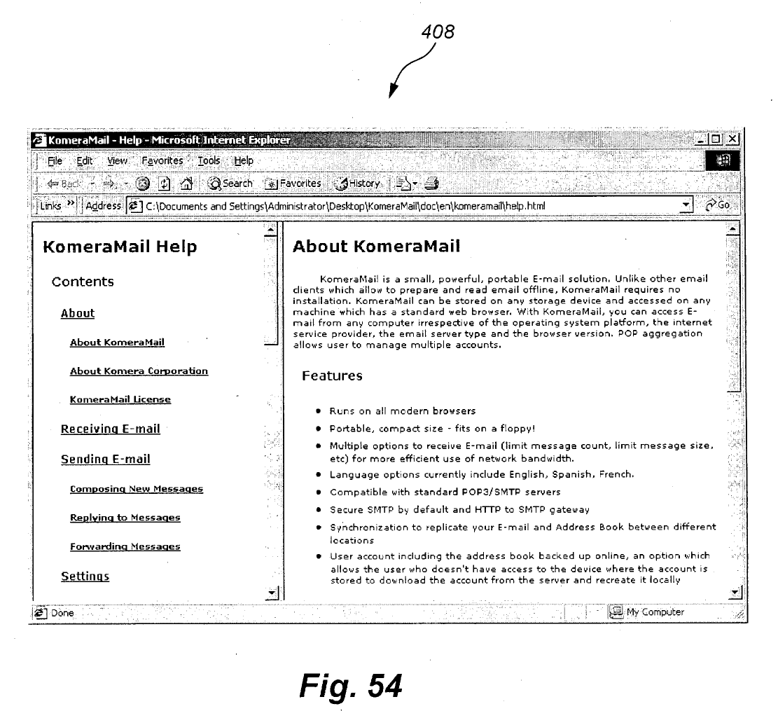

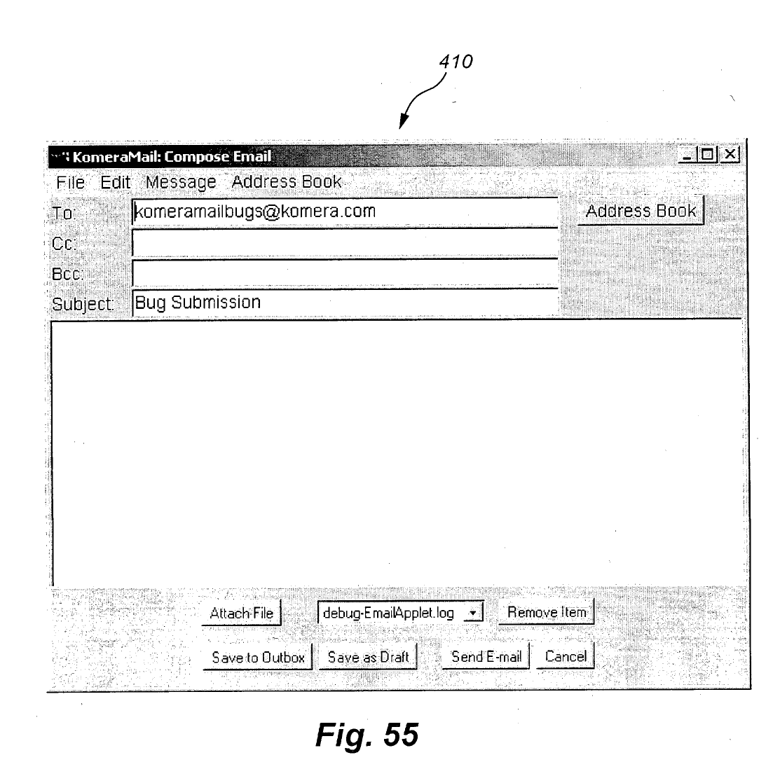

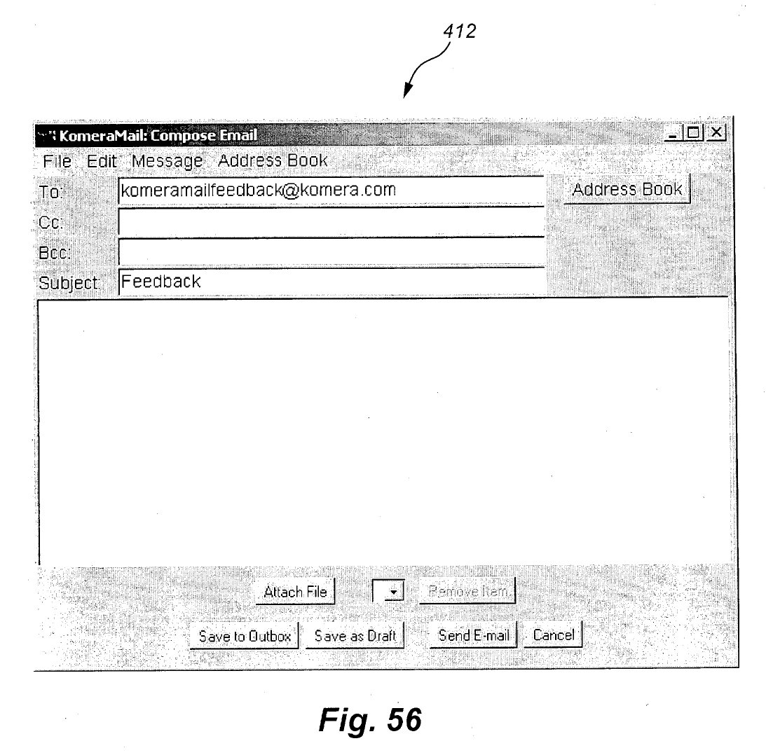

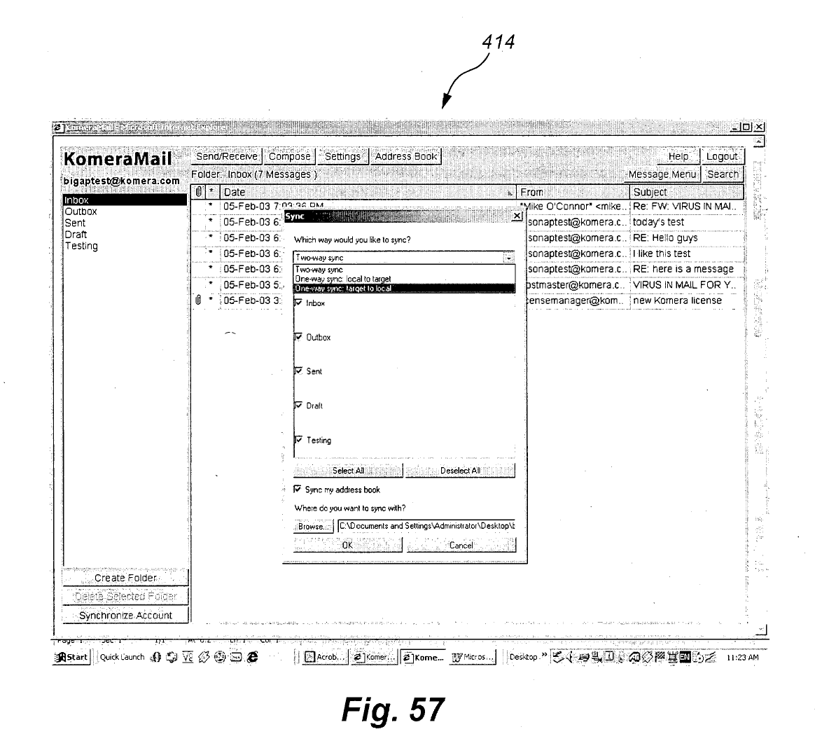

FIG. 43 shows an image of a screen 386 for a portable email account with an added folder. FIG. 44 shows an image of a screen 388 showing account settings for a portable email account. FIG. 45 shows an image of a screen 390 showing security settings for a portable email account. FIG. 46 shows an image of a screen 392 showing signature settings for a portable email account. FIG. 47 shows an image of a screen 394 showing download options settings for a portable email account. FIG. 48 shows an image of a screen 396 showing SMTP settings for a portable email account. FIG. 49 shows an image of a screen 398 showing POP/IMAP settings for a portable email account. FIG. 50 shows an image of an address book screen 400 of a portable email account. FIG. 51 shows an image of a new contact screen 402 of a portable email account. FIG. 52 shows an image of a screen 404 for entering a name of a new group for a portable email account. FIG. 53 shows an image of a distribution list screen 406 of a portable email account. FIG. 54 shows an image of a help screen 408 of a portable email account. FIG. 55 shows an image of a bug submission screen 410 of a portable email account. FIG. 56 shows an image of a feedback screen 412 of a portable email account. FIG. 57 shows an image of a synchronization screen 414 of a portable email account.

The portable email software 100 may be downloaded on a directory of a user's choice, such as a computer hard drive, a floppy disk, Flash memory, optical memory, magnetic media memory, or the like. Once downloaded, the portable email software 100 may be used locally to create a portable email account and access the be used locally to create a portable email account and access the portable email account. Like the software 100, the portable email account may be stored on a directory of a user's choice, which may be a hard disk or a removable storage attached to a computer. The portable email software 100 may be used on and offline, thus ensuring that the user will always have access to the portable email software 100 and his/her portable email account, anywhere, anytime, on any device. In an online mode, a user with an Internet connection will be working as if he/she was using a webmail, but will have the same user interface as in the offline mode. A user who does not have a portable email account stored locally may choose between downloading a copy of the backed-up account and using the portable email account locally or operating the portable email account as a webmail.

Several individual portable email accounts from different service providers may be stored on the same directory and accessed individually through individual login (e.g., with an authorized email address and an authorized password), using the same copy of the downloaded portable email software 100 or accessing the portable email software 100 online.

Like other email clients on the market, the portable email software 100 works with any POP and/or IMAP email systems. To enjoy the benefits of the portable email software 100, the user must create a portable email account. New portable email software users might have an existing POP and/or IMAP email address or choose to create an email account on the fly on email service providers associated with the portable email messaging website 20. The portable email account creation involves entering a number of informational parameters including an email address, a password, an SMTP-POP/IMAP server address and a location of where to save the portable email account. The ability to provide an independent choice of location of where the portable email account resides provides true portability. The user then connects to the website of an entity associated with the portable email software 100 to get a license. Once licensed, the user may use the portable email account on and offline to do email messaging.

Users access their portable email accounts by launching the portable email software 100 which may be read by a Java enabled Web browser, logging into the portable email account by entering the associated email address and password, and finding the location where the portable email account resides. Once logged into the portable email account, users may compose and/or read messages, access the address book, organize messages in folders, and, if there is an Internet connection, send messages waiting to be sent and/or download messages in the users' inbox on the users' SMTP-POP/IMAP mail server.

A user who has an SMTP-POP/IMAP account or has created an email account on an email service provider associated with the portable email software 100, but who has occasional access to different computers, may create and save his/her portable email account on a removable device, such as a floppy diskette or the like. The user may or may not store the portable email software 100 on the same removable device. The user may then go to an unconnected computer with a Java enabled Web browser, e.g., Explorer, Netscape or Opera, launch the portable email software 100, log into his/her portable email account, compose messages and save them into the outbox folder, update his/her address book with new contact entries, organize his/her messages into folders, and logout. The user may then take his/her removable device to an Internet connected machine, launch the portable email software 100, log into his account, click on SEND/RECEIVE, and the messages in the outbox will be sent, and the messages in the inbox on the mail server will be downloaded. The user could read and reply to messages received immediately or do it later at another computer. With the portable email software 100, the user is freed from dependence on a particular computer or Internet access point. The user needs only occasional access to a computer (any computer to work offline) and an Internet connection (any access point) when the user needs to send and/or receive email messages. For those who have easy access to the Internet, they may use the portable email software 100 online, from the portable email messaging website 20, without requiring a download to a local directory. In other words, they may use the portable email software 100 as a plain webmail, where the portable email account, message folders, and the address book is not stored on a local directory.

The following are a few illustrations of how the portable email software 100 may be used.

Consider a company employee who has a company SMTP-POP/IMAP email account, but the company does not have a dial-up service that allows the employee to do email messaging from home. The employee may have access to an unconnected computer at home. The company may have an Internet connection which may be an always-on or dial-up service. The company employee could use the portable email software 100 in the following way:

(i) Download the portable email software 100 in the office on a directory of his/her choice, e.g., on the office desktop and copy the portable email software 100 on a floppy or removable storage device so that he/she may take the portable email software 100 home and copy the portable email software 100 on his/her home computer.

(ii) Create a portable email account and store the portable email account on a directory of the employee's choice, e.g., the employee's local desktop, and then copy the portable email account on a floppy or removable storage or vice versa.

(iii) Log into the employee's portable email account (wherever the account is stored), and compose messages and either save them in the outbox or send them as they are composed if the user has a permanent Internet connection. The employee may then download messages from his email server inbox. The employee may not have time to read and/or reply to email messages in the office. If the portable email account was stored on the desktop, the employee could synchronize between the desktop account location and the removable storage device. The employee may choose which folders to synchronize, the address book may be synchronized by default. Alternatively, if storage space on the removable storage is not an issue, the employee may simply copy the entire account directory from the office computer to the removable storage.

(iv) Launch the portable email software 100 at home on the employee's home computer and log into his/her portable email account, read received messages, reply and create new messages, organize message folders and update the address book if necessary. Depending on whether the employee is saving the portable email account on the employee's home computer directory, in addition to having the portable email account on the removable storage and the office computer, the employee may then synchronize between the removable storage and the employee's home computer in whichever direction he chooses (see synchronization options below).

(v) Launch the software on the office computer and log into the employee's account, synchronize between the removable storage which contains email messages ready to be sent which were prepared on the employee's home computer, and send and/or receive email messages.

Useful features make this portable email software 100 the ideal tool for travelers, whether they are employees of a company or individuals. The company may not have a webmail system in place, may not have subscribed to roaming email services, and may not even have an individual portable computer to hand over to traveling staff.

The travelers may store their portable email accounts and or portable email software 100 on a removable device or have a portable computer. They would behave as in the case of the individual user above.

A feature in the portable email software 100 provides for the case where a user would not have access to the directory where the user's portable email account is stored. It could be because of a lost or damaged disk or simply because the user did not take the portable email account with him.

A “backup your account online” option in the portable email account SETTINGS allows a portable email account user to have a copy of the user's portable email account saved and regularly updated on a remote email server associated with the portable email messaging software where the user has created a portable email account. The backed up account includes the user properties, such as portable email address, username/password, the SMTP-POP/IMAP server address, the various download options, the index of messages which have been downloaded and any other options selected in the SETTINGS. A user who does not have access to the user's locally saved portable email account would thus launch the portable email software 100 wherever the user can access the portable email software 100, such as an Internet kiosk or the like.

The user would then log into the user's portable email account and, when prompted, find the portable email account location, choose to download the portable email account, and recreate the account locally or use the account as webmail. The user who chooses to download the account or use the account as webmail will be asked whether email messages that have been already downloaded should be remembered so that they may not be downloaded again.

In the same way that a browser residing on a local computer useable medium communicates to a website on the Internet, the portable email software 100 provides a universal webmail interface that communicates with all SMTP-POP/IMAP compliant email servers connected to the Internet. With the portable email software 100, there is no longer the need for an entity wanting to provide the entity's users with access to their email folders, the ability to compose and/or read email messages, and to utilize their address book when they are connected to the Internet, to implement proprietary webmail solutions that must be integrated with the entity's email server. Nor is there a requirement that the portable email account be residing on their email server. When the portable email software 100 is used as a webmail, a user does not need to store the portable email account, messages folders, and address book on a local computer useable medium. The user interface remains the same whether the portable email software 100 is used in a webmail or offline environment.

This is a useful feature, not only for traveling staff, but also for someone who may have his locally downloaded inbox destroyed, such as by a computer crash, virus attack, etc., and wants to reconstitute the user's portable email inbox entirely.

When a traveling individual uses the Internet, he/she may not know whether the ISP being used to connect to the Internet allows or portable email software 100 includes a portable email HTTP−−>SMTP gateway which by-passes this filter if there is one.

Most email users prefer to limit download time while on the road or if they have a slow/expensive Internet connection or limited storage space. The portable email software download options include the option to limit the size of individual messages as well as the number of messages. When there are messages whose size exceeds a predetermined threshold or when the number of messages in the inbox exceeds a predetermined maximum number established in the user download options, the user will receive an alert prompt asking to choose between downloading only small and/or recent messages or all messages.

It is a good insurance policy to have a copy of sent messages on a server in addition to having them in the local Sent folder so that they may be accessed when the local directory is not available (traveling, computer crash, lost or damaged disk). The portable email messaging software includes the option to send a copy of each sent message to oneself. Thus, the user who chooses this option will have all his incoming and outgoing messages available locally and on the email server.

The portable email software 100 enables users to manage their online inbox through an offline client. There are two options that allow the user to do this. The user may choose to leave messages on server or delete them after they are downloaded. The user may choose to delete messages on the user's SMTP-POP/IMAP mail server when they are deleted locally. The latter function is a convenient tool to are deleted locally. The latter function is a convenient tool to manage online disk storage allocation. In this case, the user who wants to make space on the user's SMTP-POP/IMAP mail server but who wants to keep a copy of the user's messages, would create a local folder to archive the user's messages, copy to the created local folder messages from the inbox, and then delete messages in the inbox which, if the user has checked the “delete message on server when deleted locally” option, would clear the user's online inbox of those deleted messages. Portable email account holders may also select which messages to delete without even downloading them using the index of message headers which is downloaded/displayed at the user request before the actual download of messages takes place.

The synchronization option is a handy tool for users who are using different computers to access their email. The user may choose to synchronize all folders, selected folders, and/or the address book, in any combination desired.

One synchronization option is a two-way synchronization, which takes place between two directories: the origination directory which is the account the user is logged in and a target/destination directory where there might be a portable email account already created. If there is no portable email account already created at the target/destination directory, the portable email account will be created there the first time the synchronization takes place. In a two-way synchronization, the synchronized folders/address book in the two synchronized accounts are the exact replica of each other when the synchronization is complete.

Another synchronization option is a one way synchronization from a local directory to a target directory. A user who does not have an Internet connection or who is about to travel, but is not going to take along the computer where the user has the portable email account stored may synchronize to a target directory. The user has the choice to synchronize any selected folders, the address book, or any combination of the user's choosing. The target directory may be a computer or a removable storage device.

Another synchronization option is a one way synchronization from a target to a local directory. A user who returns from a trip or an Internet access point having downloaded and sent messages, may want to bring the portable email account the user left home in synchronization with the portable email account the user took on the road or to the Internet kiosk to send and/or receive email message.

The portable intranet software 200 of the portable email software package 24 is completely portable and requires no installation. The intranet instructions are best suited for a group or organization that wants to establish messaging for all members of the group or organization. The portable intranet software 200 provides a number of features that make management and message sending in a multi-user environment quick and effortless. An intranet administrator may download the portable intranet software 200 of the portable email messaging software package 24 from a website operated by a server upon which is stored the portable email messaging software package 24, or may use portable intranet software 200 already downloaded from a website operated by a server upon which is stored the portable email messaging software package 24 or a website having a link to a server upon which is stored the portable email messaging software package 24. The portable intranet software 200 may be configured to run either on a single computer or in a multi-machine environment.

The intranet administrator configures the intranet by entering the intranet information parameters, such as domain name, SMTP-POP/IMAP server name, the location of the intranet directory, and chooses the email addressing convention from a built-in system which simplifies the creation of email accounts for members. The intranet administrator may add new members or members who already have email addresses. The intranet administrator may also remove members at any time. Existing email accounts, e.g., ones with POP/IMAP server email mailboxes, may be used, or a brand new email account may be created using the portable intranet software 200 of the portable email messaging software package 24. Intranet membership provides access to group contacts, group calendar, and shared documents. Messages between members of the group are exchanged locally irrespective of whether they belong to the same email address domain or not. The intranet manager may send and/or receive Internet bound messages for intranet members.

In a single machine setting users may read and/or compose their messages anywhere, but must log into their account on the computer upon which the portable intranet software 200 is configured, in order to exchange email messages locally with other intranet members, send outgoing Internet email messages, and receive new email messages downloaded by the intranet manager from the user's POP/IMAP server email mailbox.

In a multi-machine environment (e.g., one that requires a local area network with Windows file-sharing capabilities or the like), any intranet member may log into any intranet configured computer to carry out their email messaging activities. Configuring a computer to be part of an intranet configured by the portable intranet software merely involves running a small script that is automatically created at the time the intranet is originally configured.

All intranet members of an intranet configured by the portable intranet software 200 automatically have all other intranet members' names and addresses, of the intranet configured by the portable intranet software 200, appear in their own address book. They have access also to other email addresses contacts entered in the address book by the intranet administrator, which could include, for example, company clients, as well as group calendar and shared documents. The intranet administrator may add, remove, or edit contacts as well, and those changes are automatically synchronized to each member's local address book.

In addition, members of an intranet configured by the portable intranet software 200 may send and/or receive email messages to and from the Internet without ever having to worry about establishing an Internet connection themselves. All outgoing Internet email messages (created by intranet members) are queued up and sent in aggregate when an Internet connection is established. At the same time, all new email messages are downloaded from each member's online POP/IMAP server email mailbox. This aggregation can result in substantial savings on Internet costs.

The portable intranet software 200 of the portable email messaging software package 24 provides the ability for local exchange of email messages on a portable device, such as a floppy disk or the like, and the ability to take a collective outbox and inbox to another location and send and/or receive email messages for intranet members.

To illustrate the intranet portability, a family with no access to the Internet from the home but with one shared computer could be exchanging messages between family members locally. For Internet bound messages, one member of the family may then export the intranet from the shared computer to a floppy diskette, a process which will copy the outbox content of each individual user and their account property, take the floppy diskette to an Internet cafe, send and/or receive Internet messages for intranet members, bring the floppy diskette back home, log into the intranet on the shared computer and import from the floppy diskette which will contain downloaded email messages from intranet members and sent email messages that were previously in the outbox folder. Each intranet member may then log into his/her individual email account, read his/her inbox, reply to email messages, and/or compose new email messages as desired. The trip to the Internet access point may then be repeated the next day.

A school with no local area network but where there are individual computers scattered around the campus, with only one computer having access to the Internet through dial-up modem may serve all students and the teaching community. Each group on the school campus may have an intranet on a machine, a floppy diskette, or other storage device. They may use a floppy diskette or another portable device to carry messages for all members of the group to the computer with the dial-up modem, conduct email transactions for all members of the group, and bring the portable memory storage device back to the group to enable each member to access his account and view messages.

A conference organizer could provide email access to all participants without setting up a networked environment or an ‘always on’ connection to the Internet. A company team on a business trip may have one laptop and share it to exchange email messages locally among members of the team, and send and/or receive Internet email messages for all members of the team.

An Internet service provider may optimize bandwidth utilization and contain the investment in additional modems through load shedding techniques. The provider may use the intranet scheduler and offer preferential rates for users who accept to send and/or receive email messages during off-peak hours. The intranet provides the option for either the email user to initiate the contact to the ISP or the ISP to initiate the contact to the email address subscriber. The fact that the portable intranet software 200 works both ways and enables a remote caller, through dial-up or intranet IP address, to log into an account on a local directory on a user computer provides for file sharing and collaboration among remote intranet members. A company/organization with decentralized entities may use the intranet to exchange email among remote centers without ever going through a central email server. A consortium of ISPs in a country or city may use one intranet as a central exchange pool or peering point where messages destined to email account holders on the various ISPs who have created an intranet with the portable intranet software 200 are exchanged. Only those messages that are destined to non-members of the ISPs intranet consortium would be sent to the Internet. Besides exchanging messages through the intranet exchange point, messages may be exchanged between ISPs in a one to one peering relationship.

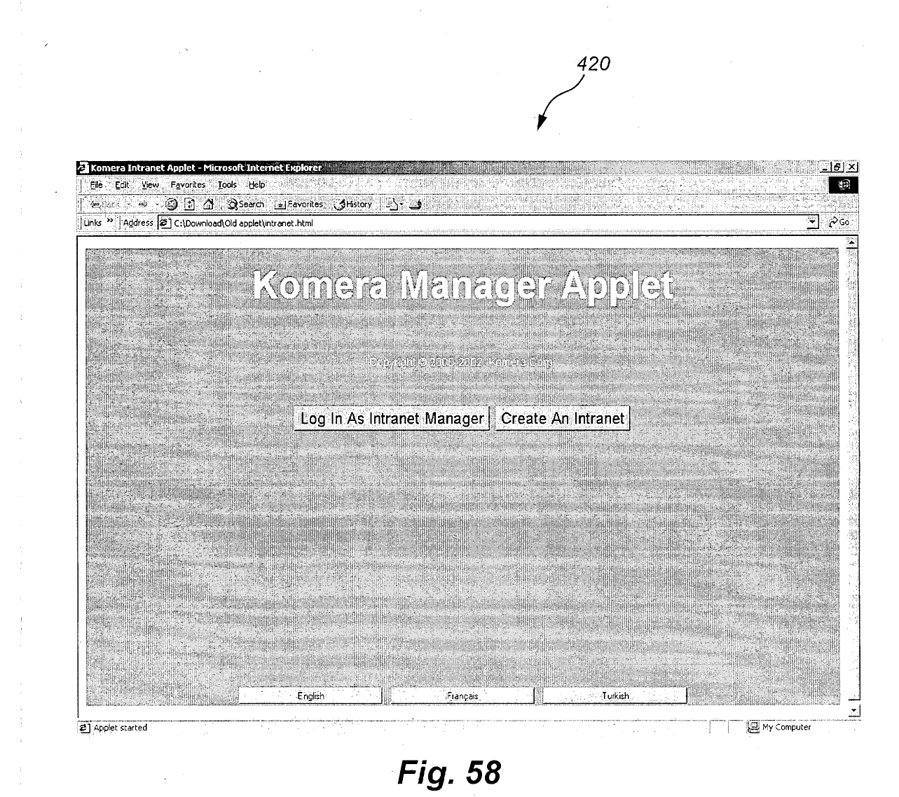

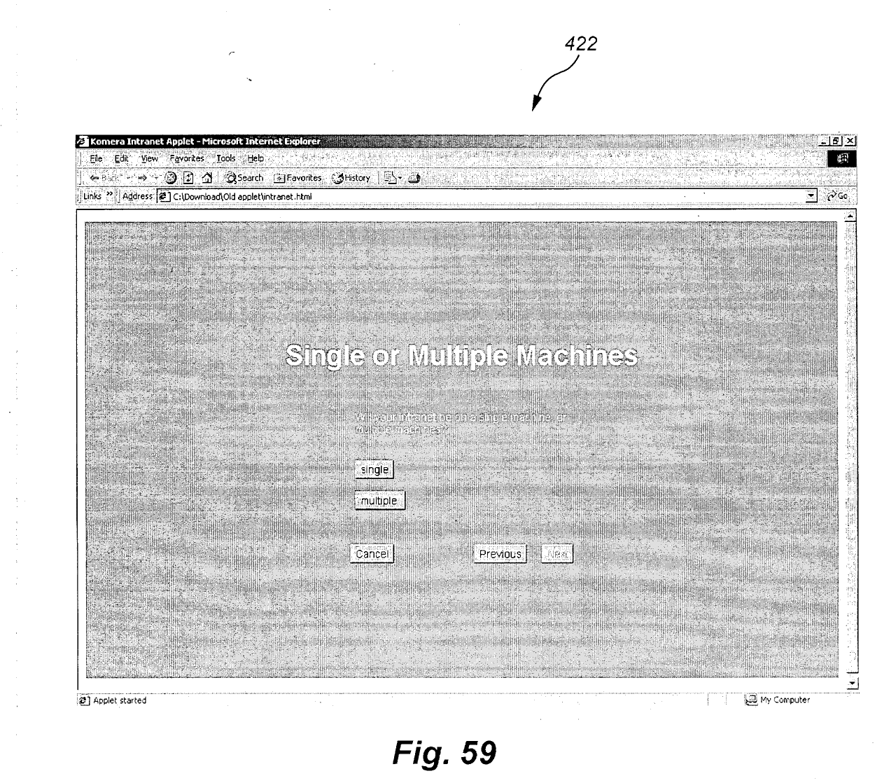

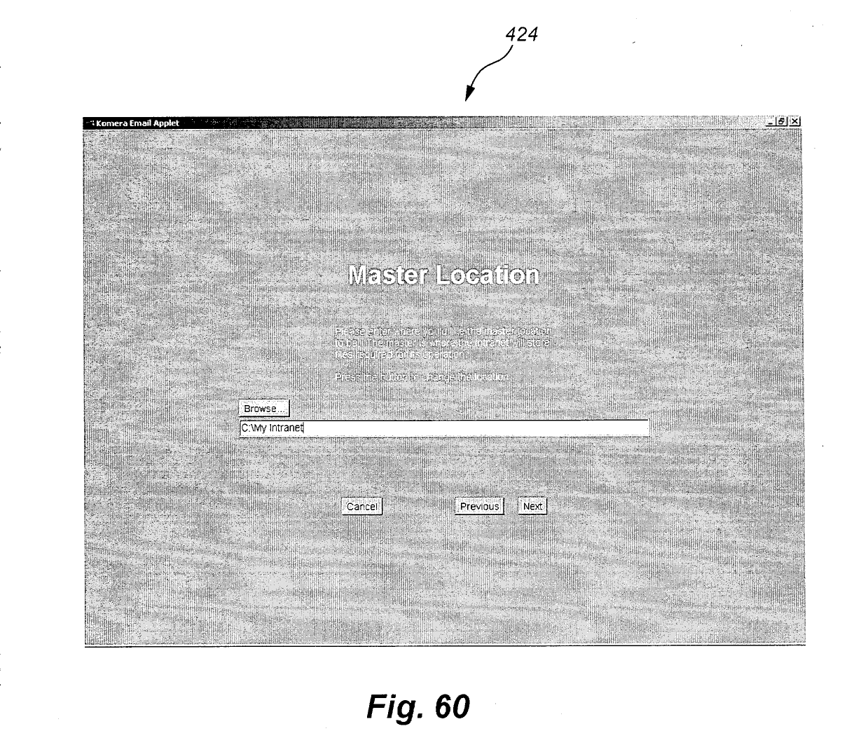

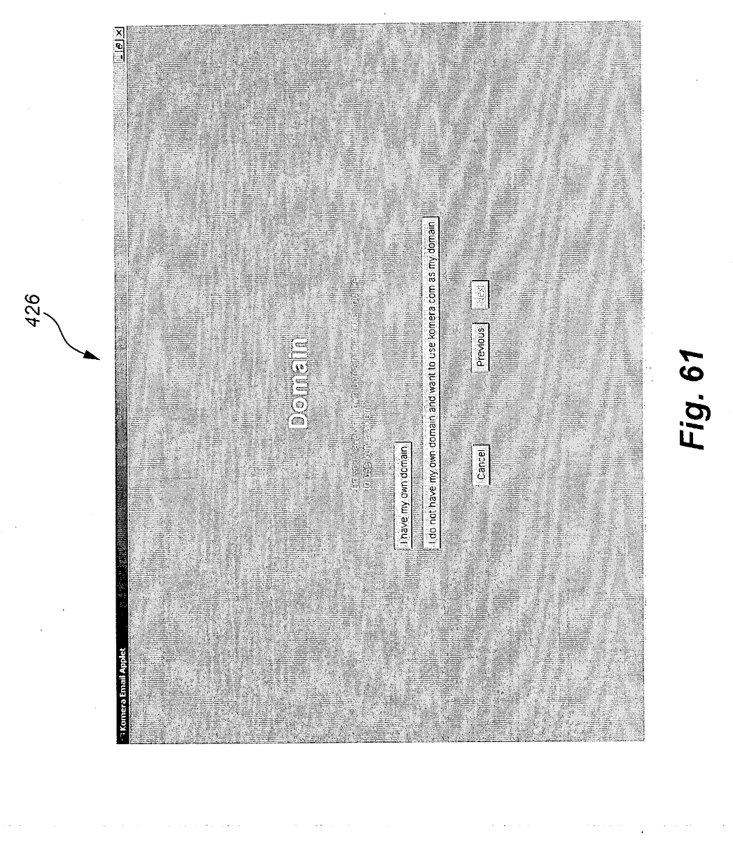

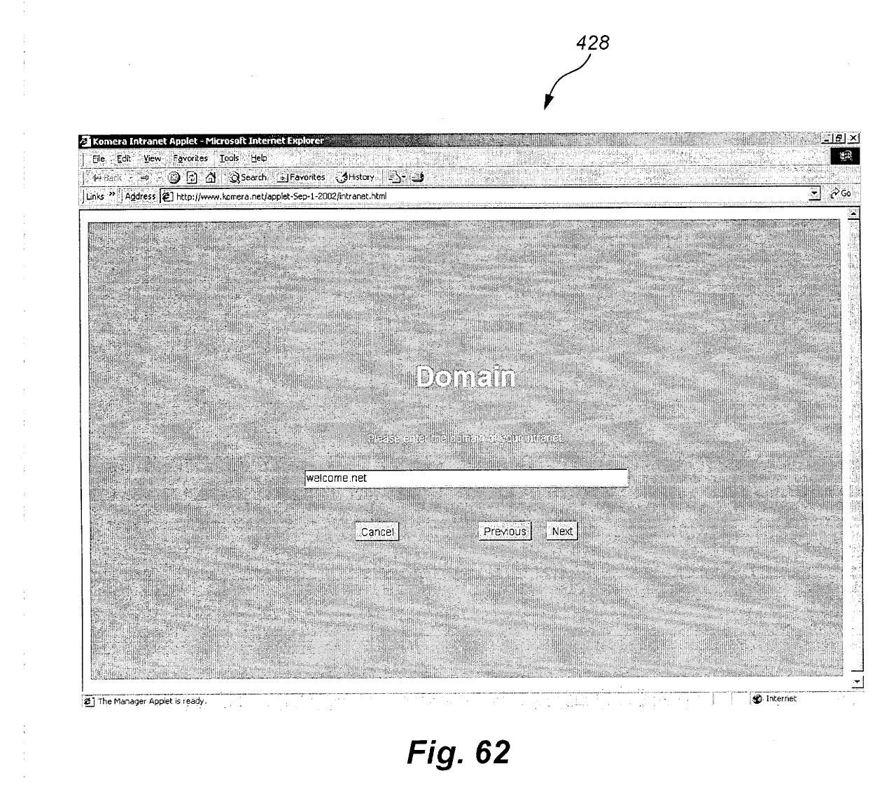

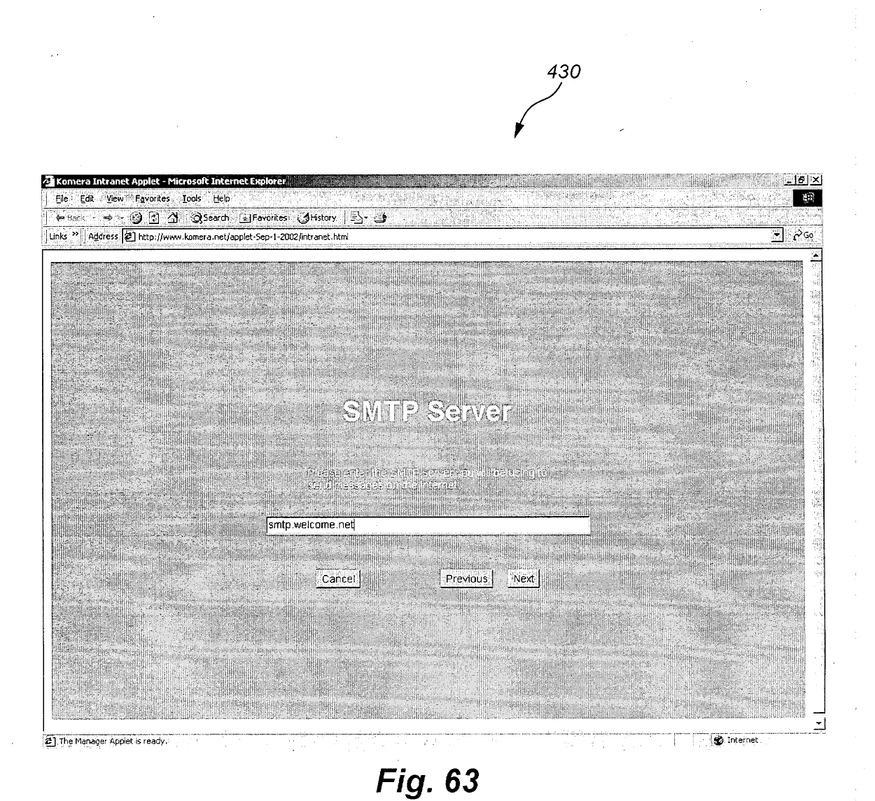

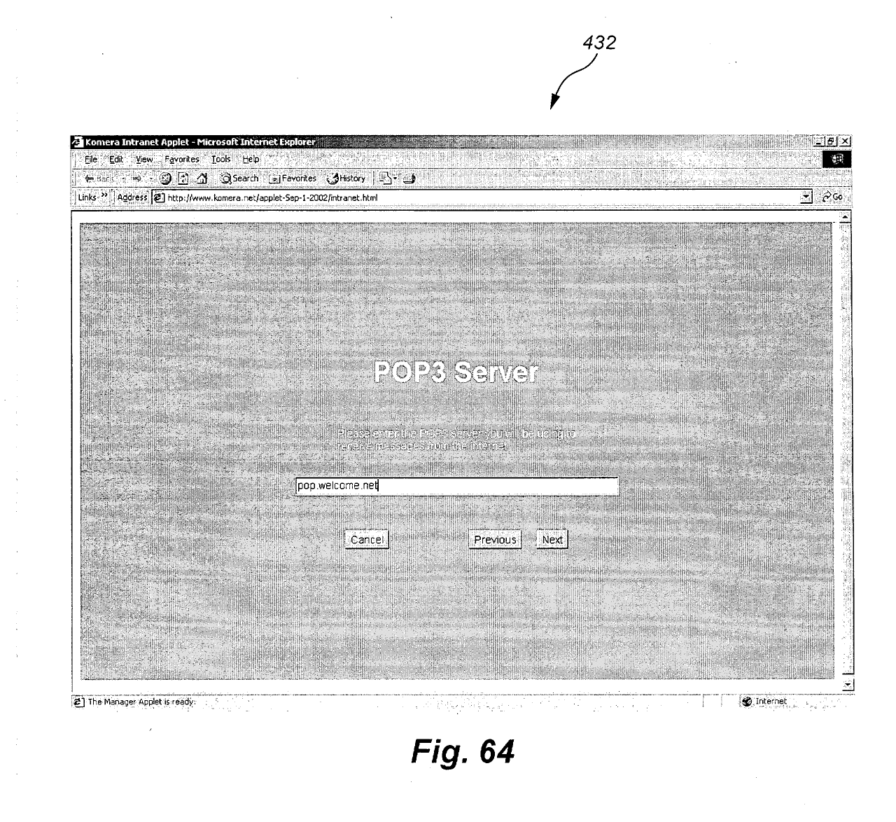

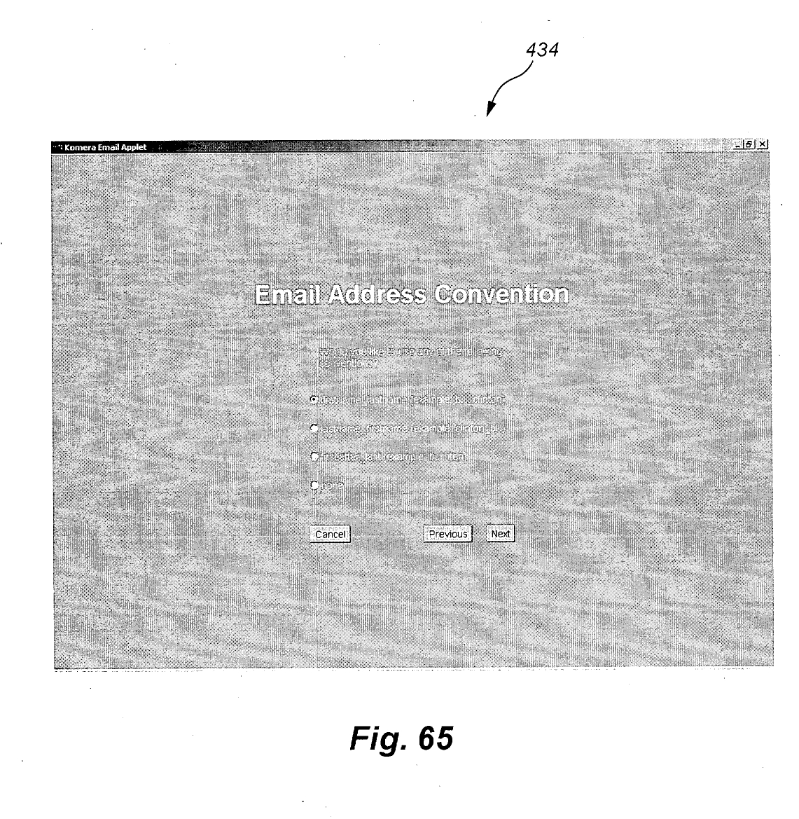

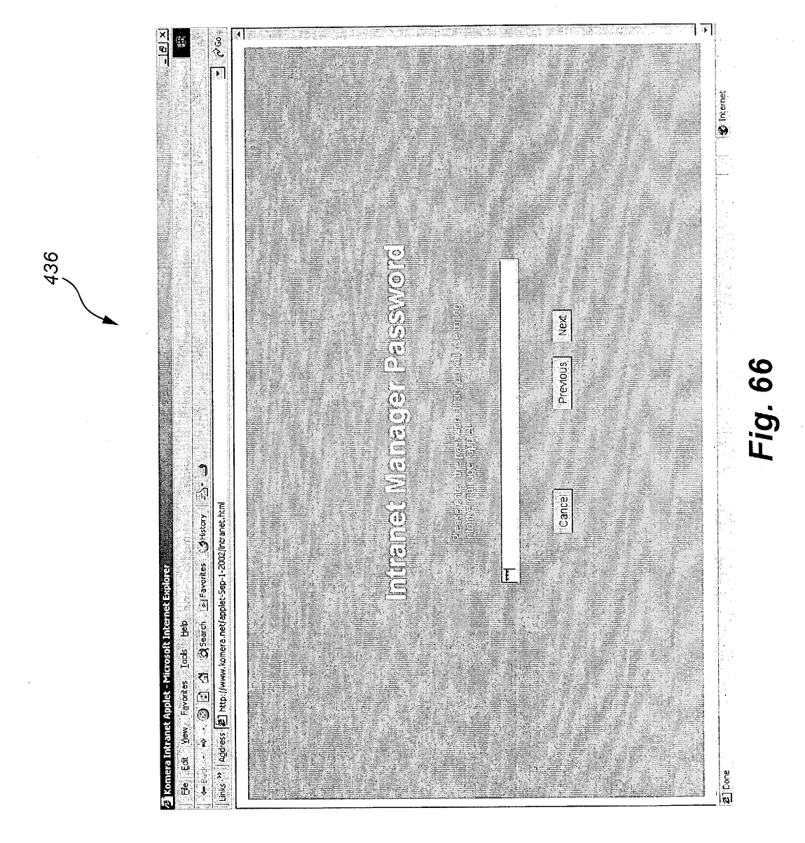

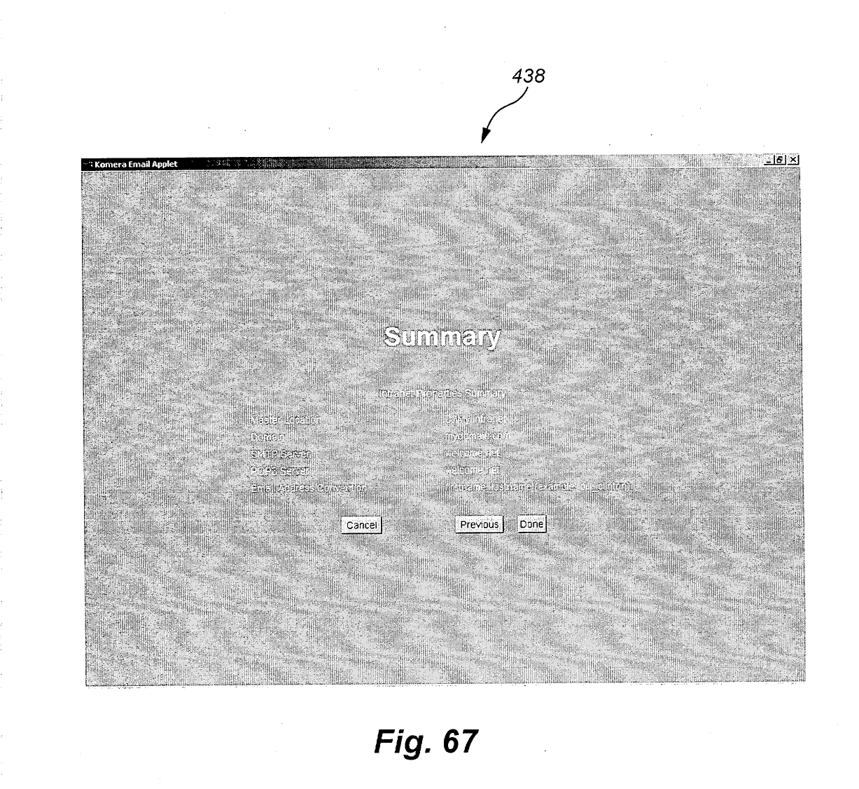

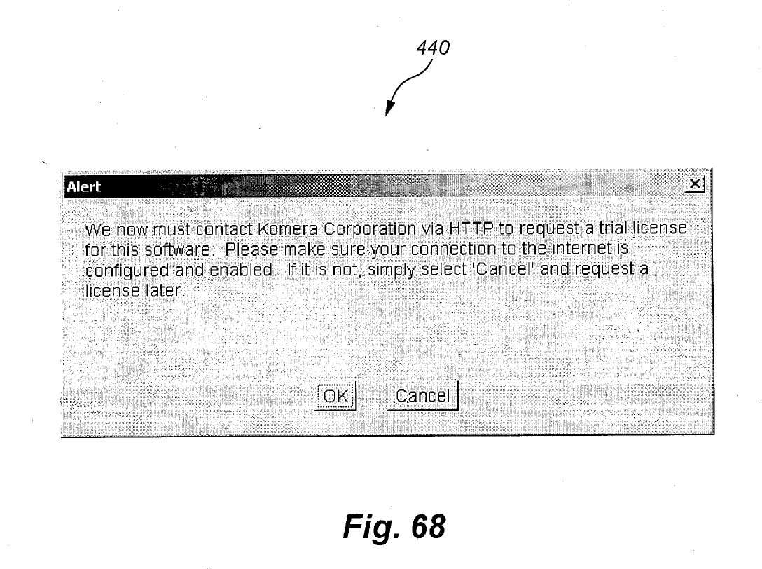

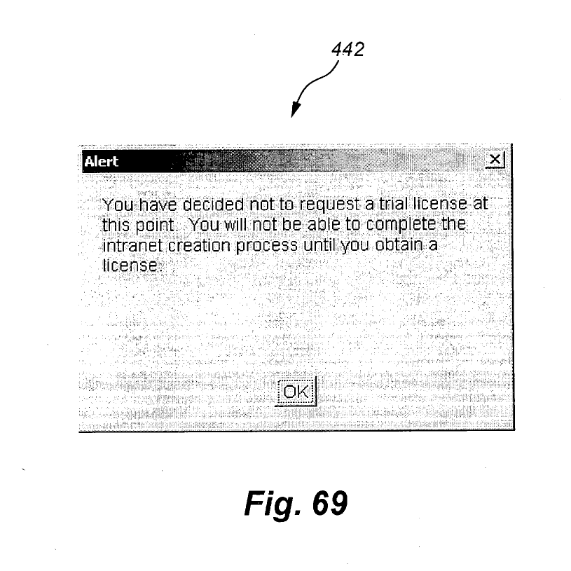

Example images of intranet screens are shown in FIGS. 58-93. FIG. 58 shows an image of a screen 420 for selecting whether to log on as an intranet manager or to create an intranet using the portable intranet software 200. FIG. 59 shows an image of a screen 422 for selecting whether to create an intranet on a single machine or multiple machines by the portable intranet software 200. FIG. 60 shows an image of a screen 424 for designating a particular location where intranet files will be stored for an intranet using the portable intranet software 200. FIG. 61 shows an image of a screen 426 for selecting whether a user has or does not have a registered Internet domain to associate with an intranet being created using the portable intranet software 200. FIG. 62 shows an image of a screen 428 for entering an intranet registered domain for an intranet being created using the portable intranet software 200. FIG. 63 shows an image of a screen 430 for entering an SMTP server that will be used for an intranet being created using the portable intranet software 200. FIG. 64 shows an image of a screen 432 for entering a POP and/or IMAP server that will be used for an intranet being created using the portable intranet software 200. FIG. 65 shows an image of a screen 434 for selecting an email address convention to use for an intranet being created using the portable intranet software 200. FIG. 66 shows an image of a screen 436 for entering an intranet manager password to use for an intranet being created using the portable intranet software 200. FIG. 67 shows an image of a screen 438 for providing a summary of intranet parameters of an intranet being created using the portable intranet software 200. FIG. 68 shows an image of a screen 440 for informing a user that an entity associated with the portable intranet software 200 will be notified of a request for a trial license. FIG. 69 shows an image of a screen 442 for informing a user that a request has not been made for a trial license for an intranet.

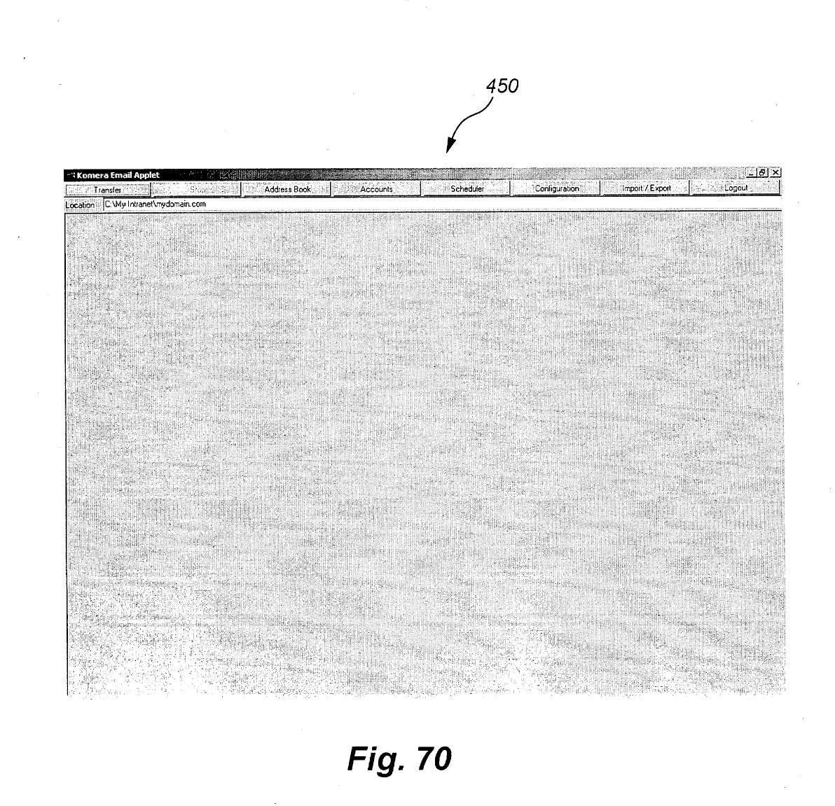

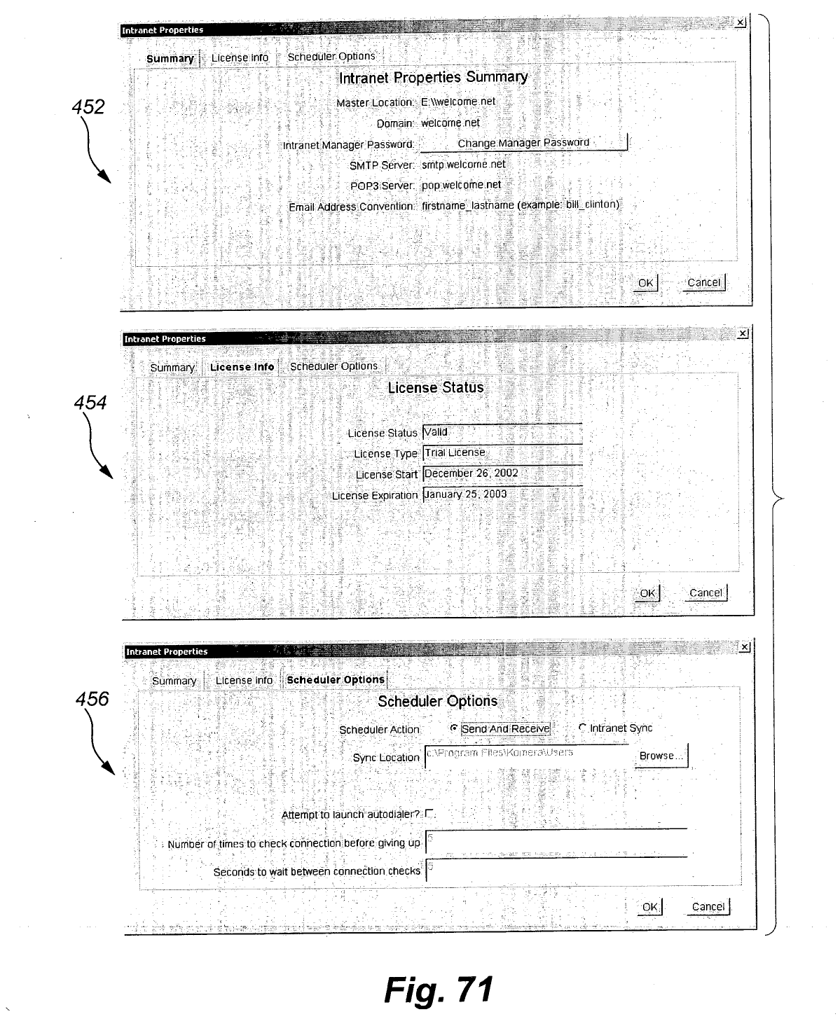

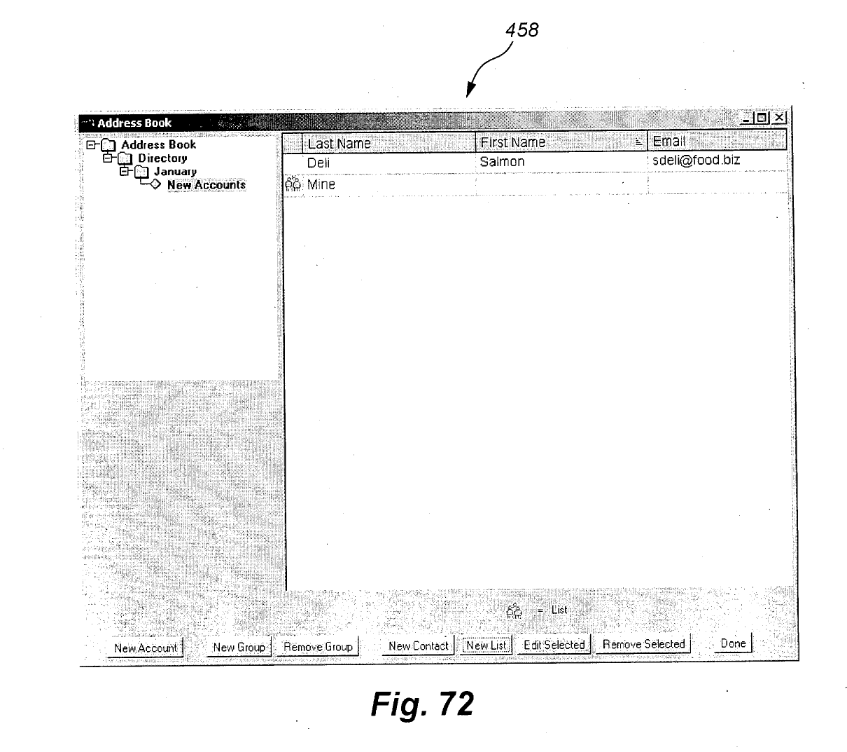

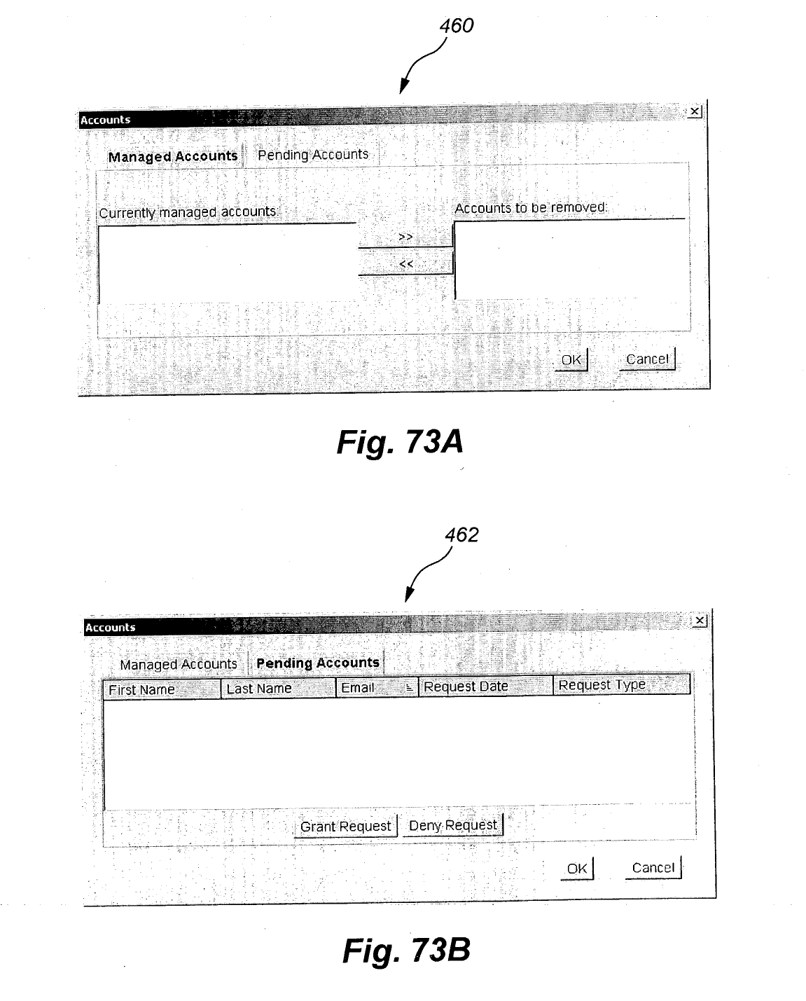

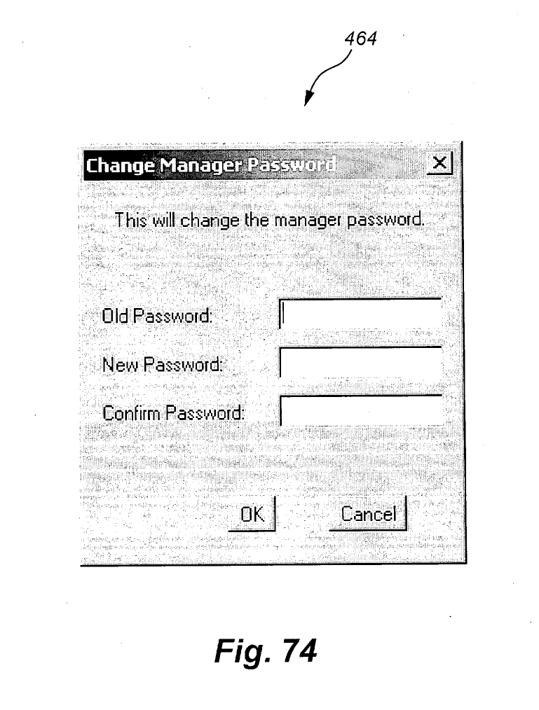

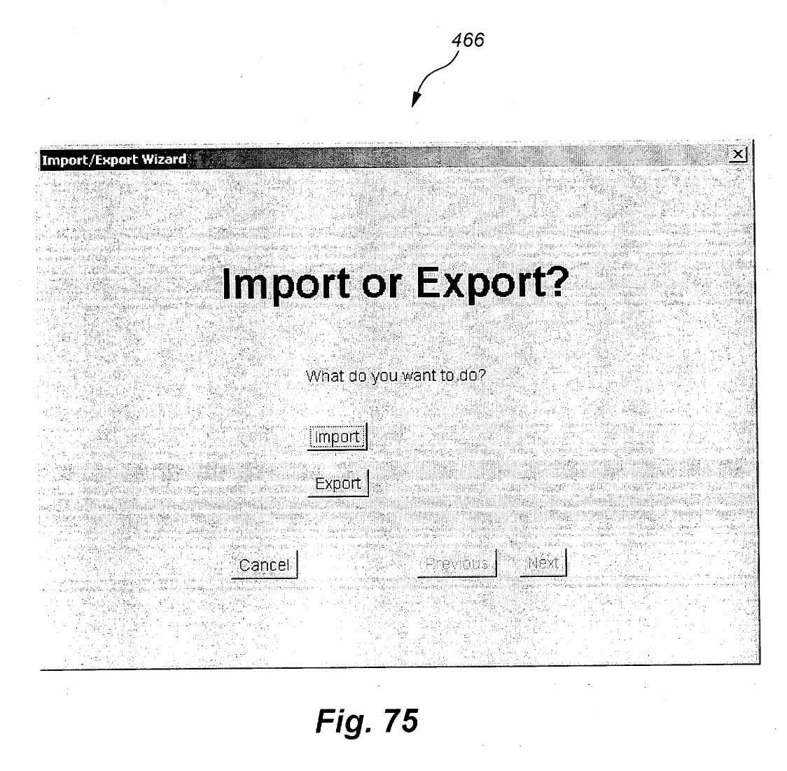

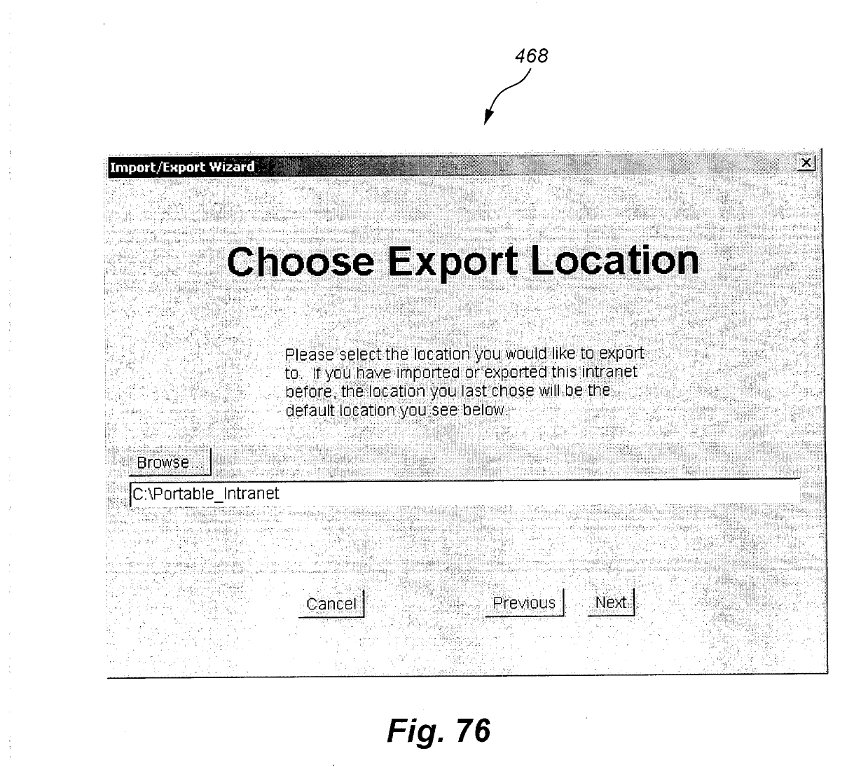

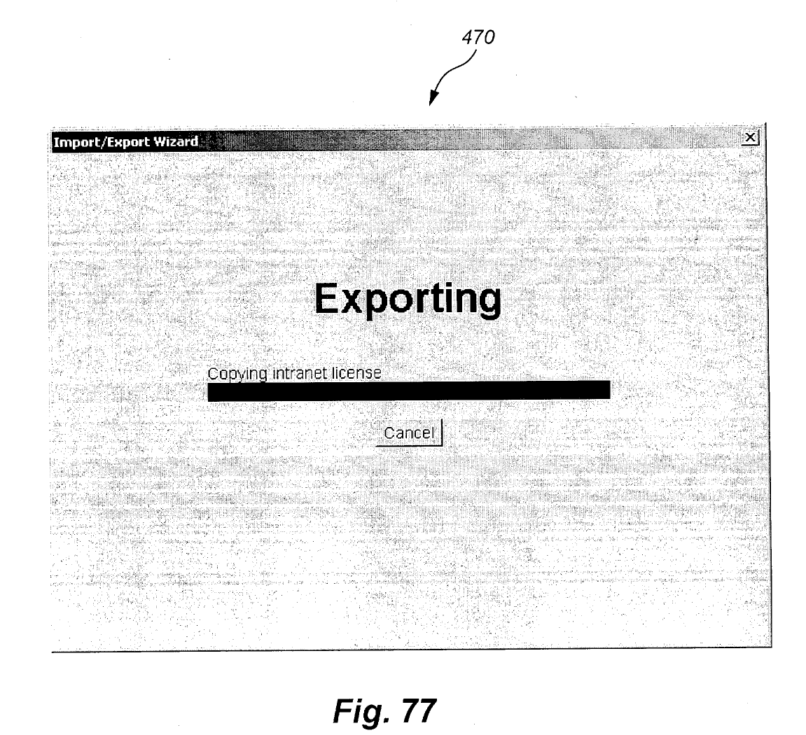

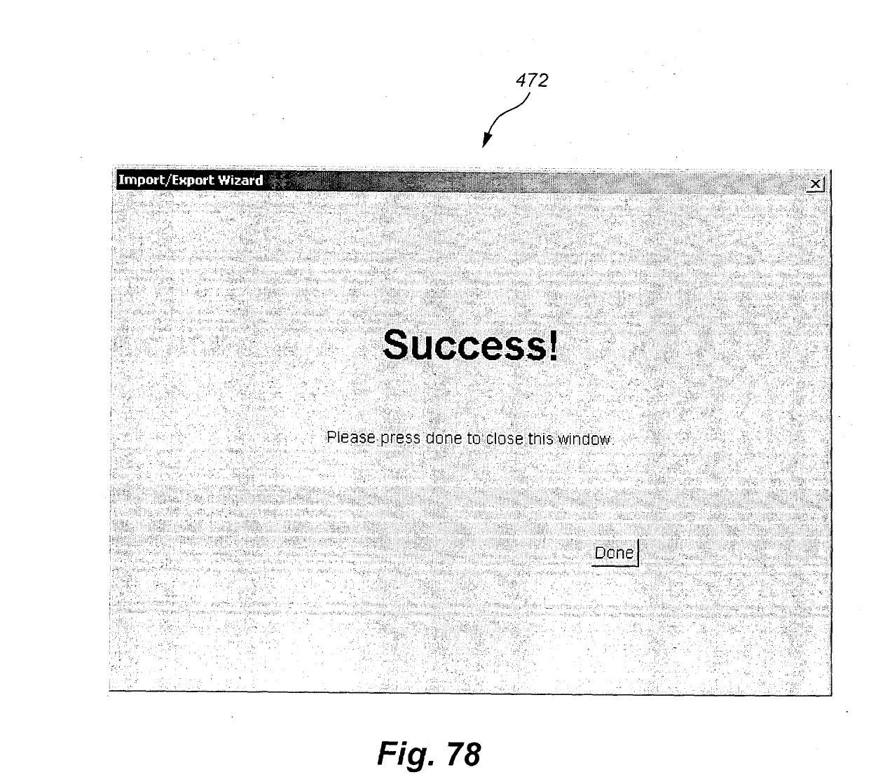

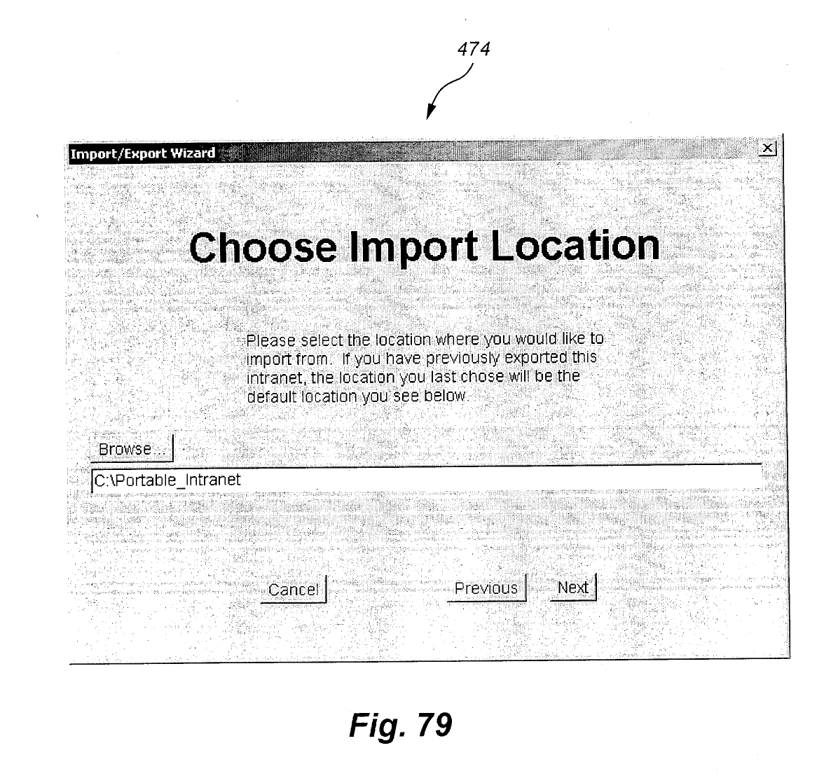

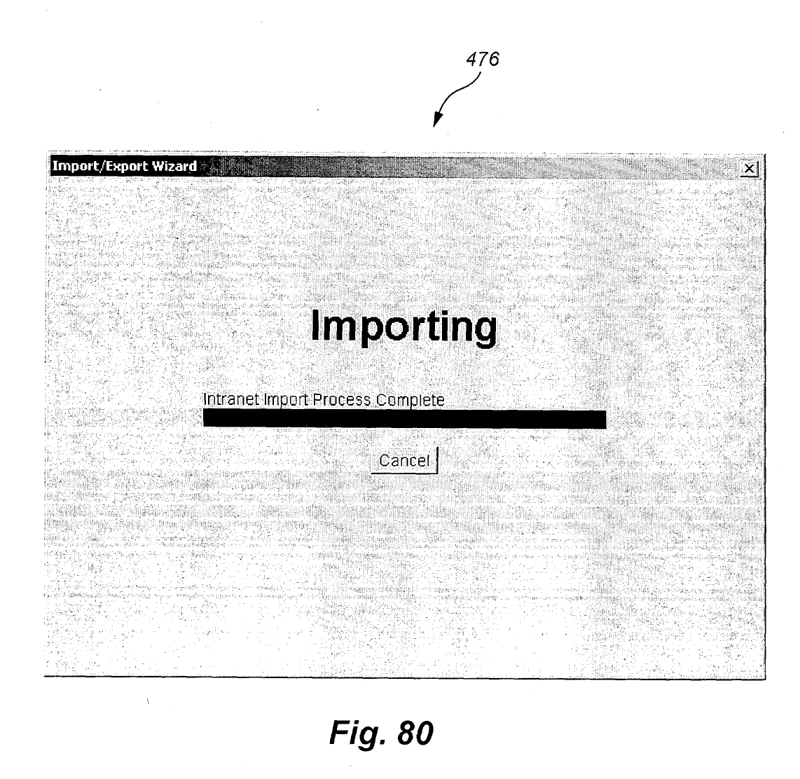

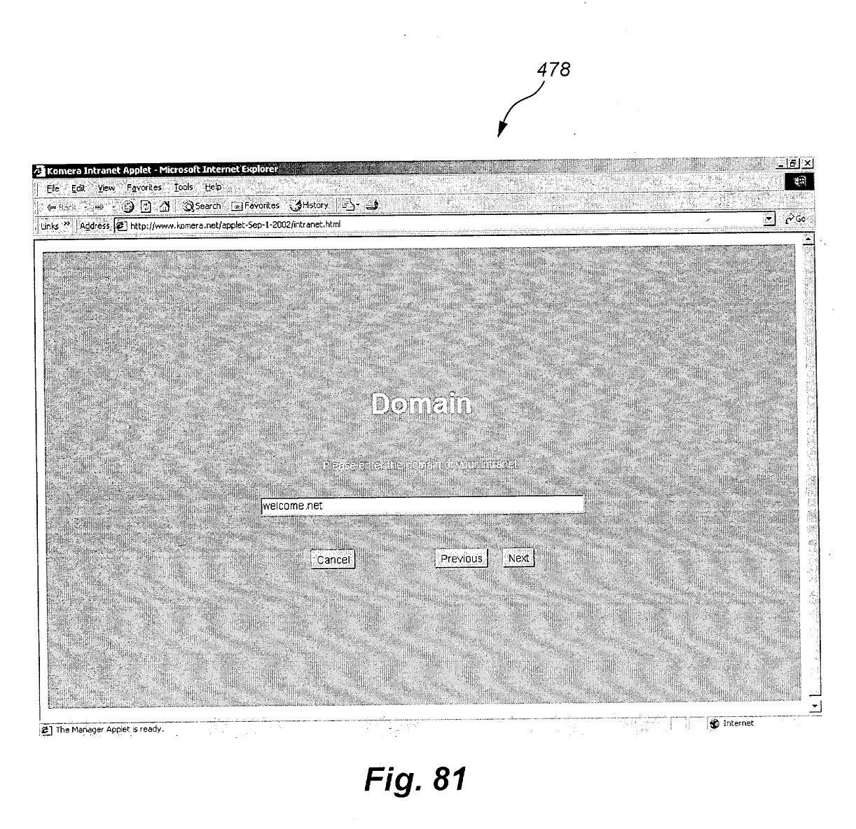

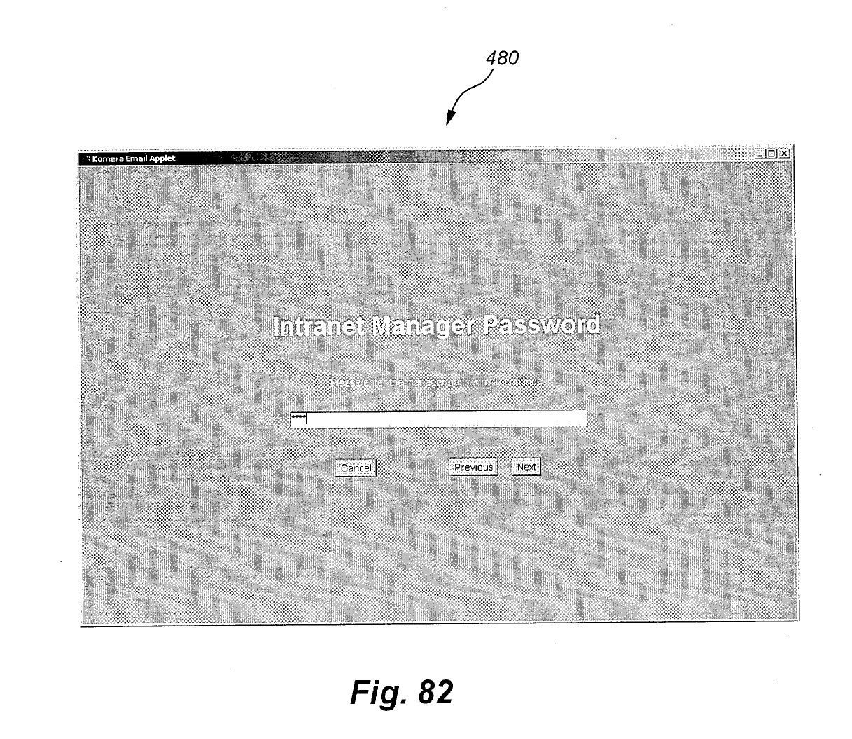

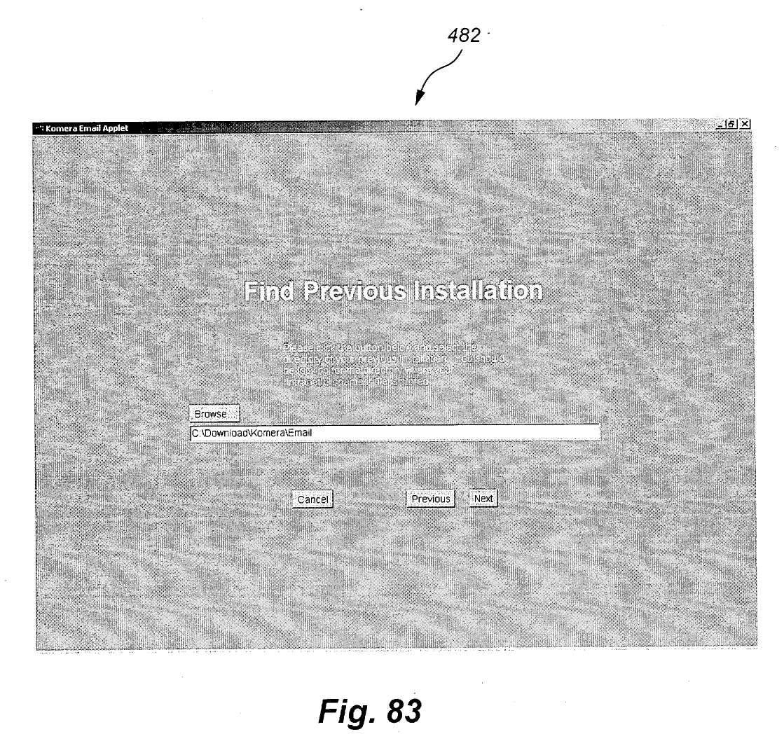

FIG. 70 shows an image of an intranet screen 450 for an intranet created using the portable intranet software 200. FIG. 71 shows an image of screens for intranet properties summary 452, license information 454, and scheduler options 456 of intranet properties of an intranet created using the portable intranet software 200. FIG. 72 shows an image of an address book screen 458 for an intranet created using the portable intranet software 200. FIG. 73A shows an image of a screen 460 of managed accounts of an intranet created using the portable intranet software 200. FIG. 73B shows an image of a screen 462 of pending accounts of an intranet created using the portable intranet software 200. FIG. 74 shows an image of a screen 464 for changing a manager password for an intranet created using the portable intranet software 200. FIG. 75 shows an image of a screen 466 for selecting whether to import or export messages to/from an intranet created using the portable intranet software 200. FIG. 76 shows an image of a screen 468 for entering an export location for intranet data for an intranet created using the portable intranet software 200. FIG. 77 shows an image of a screen 470 indicating export progress of intranet data for an intranet created using the portable intranet software 200. FIG. 78 shows an image of a screen 472 indicating export success for an intranet created using the portable intranet software 200. FIG. 79 shows an image of a screen 474 for entering an import location for intranet data for an intranet created using the portable intranet software 200. FIG. 80 shows an image of a screen 476 indicating import success for an intranet created using the portable intranet software 200. FIG. 81 shows an image of a screen 478 for entering an intranet domain to log into an intranet created using the portable intranet software 200. FIG. 82 shows an image of a screen 480 for entering an intranet manager password to log into an intranet created using the portable intranet software 200. FIG. 83 shows an image of a screen 482 for entering or browsing for a location where intranet files were stored for an intranet created using the portable intranet software 200.

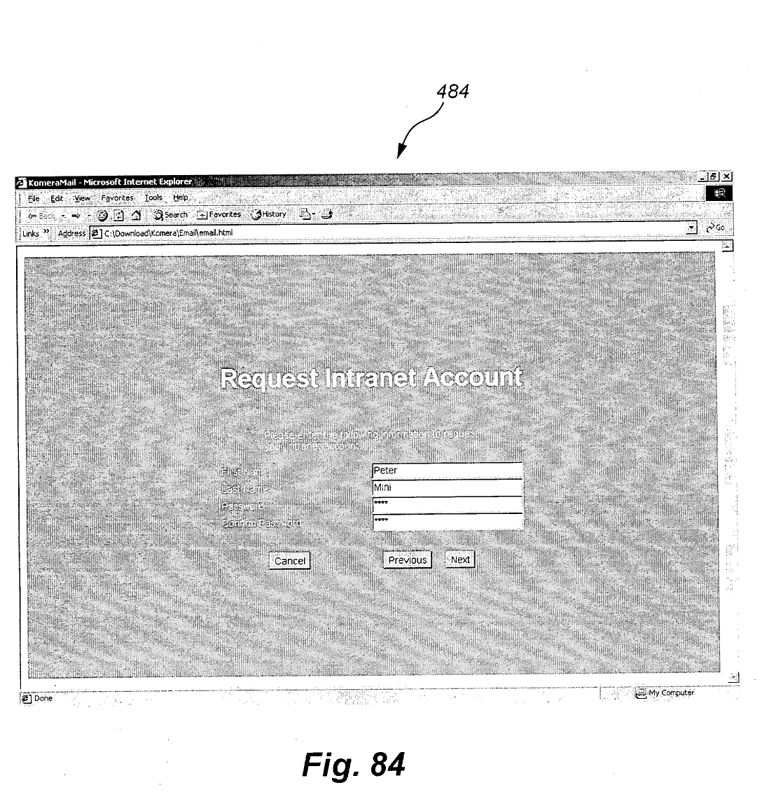

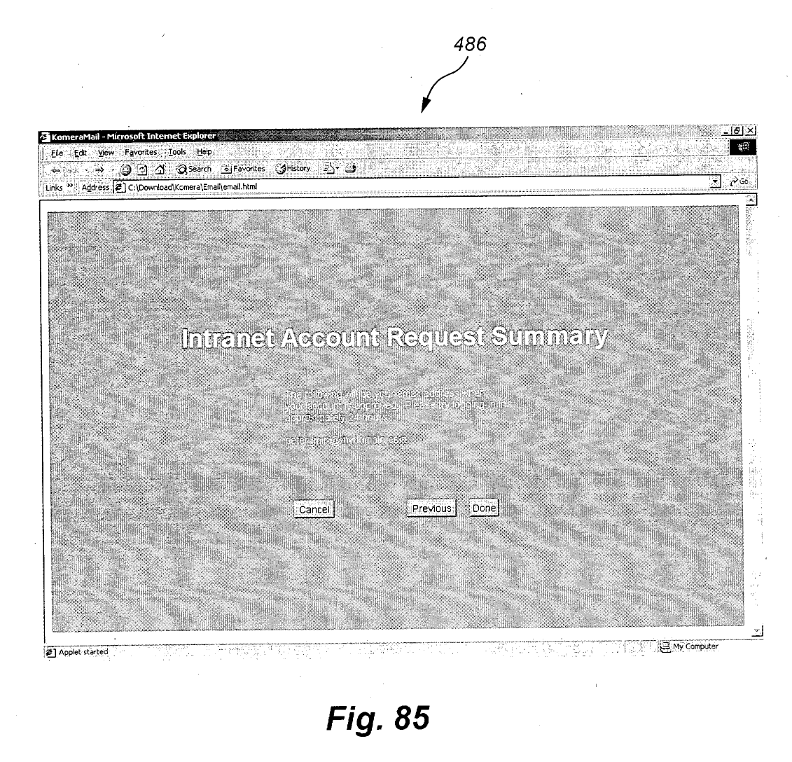

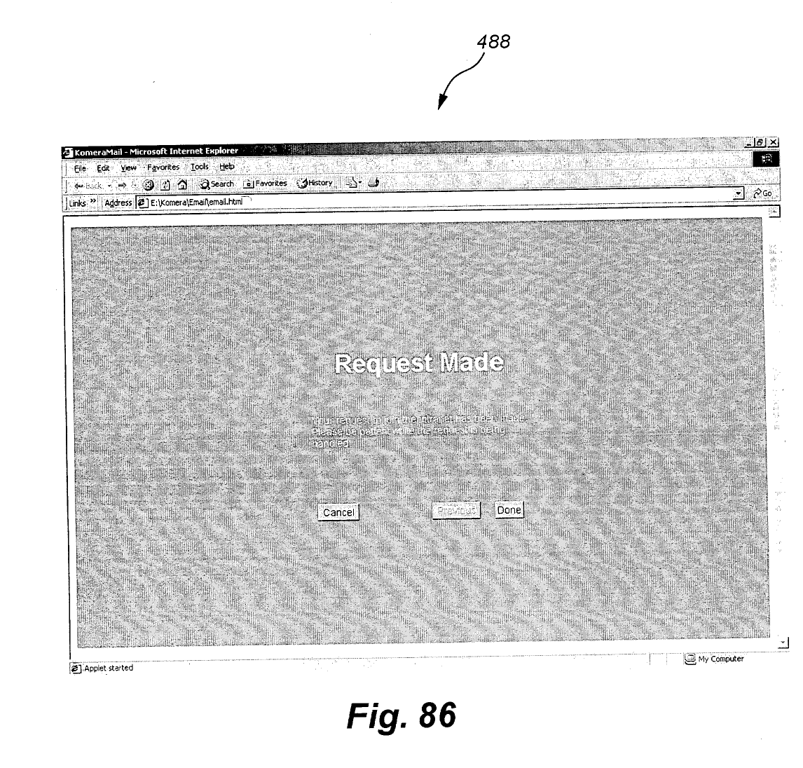

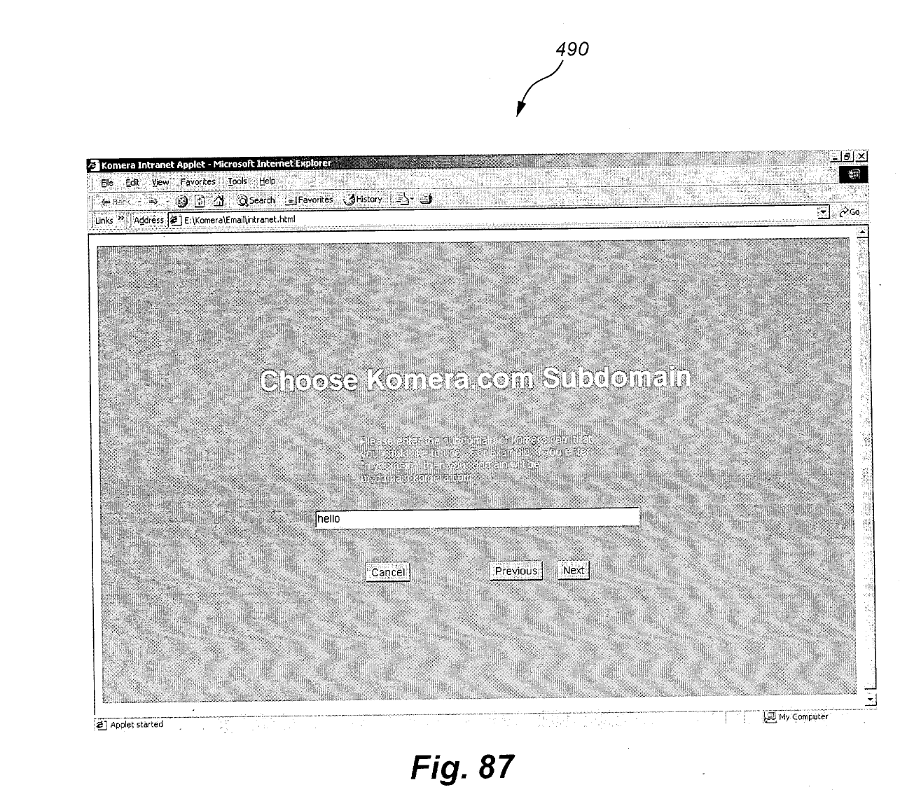

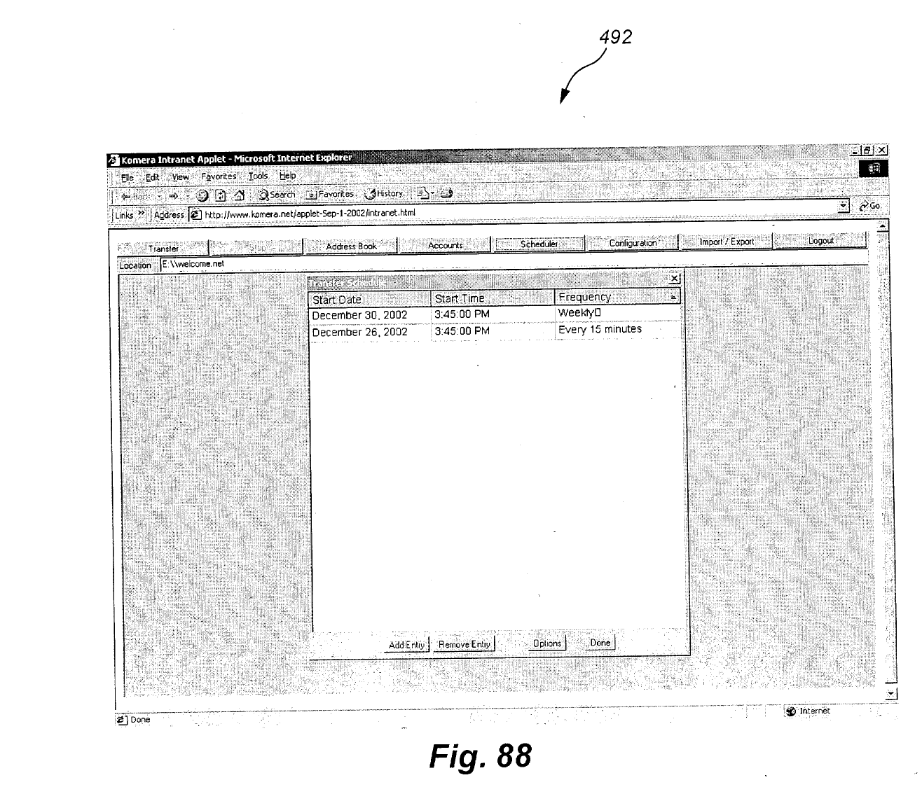

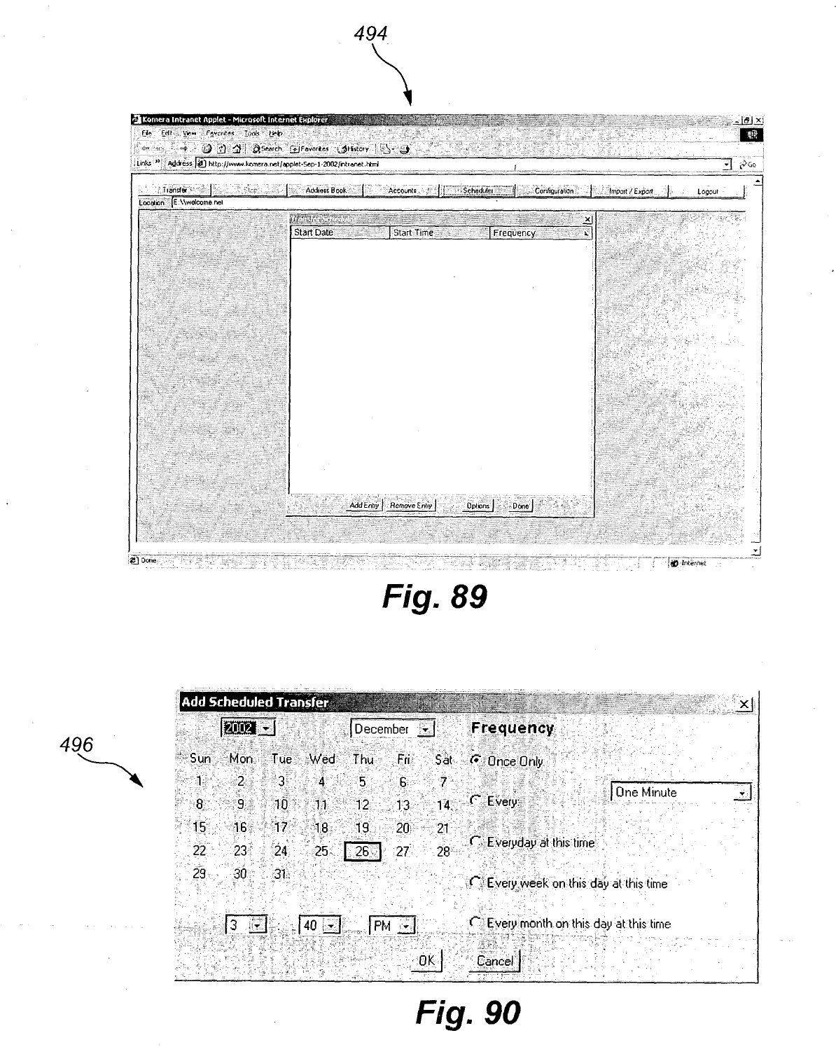

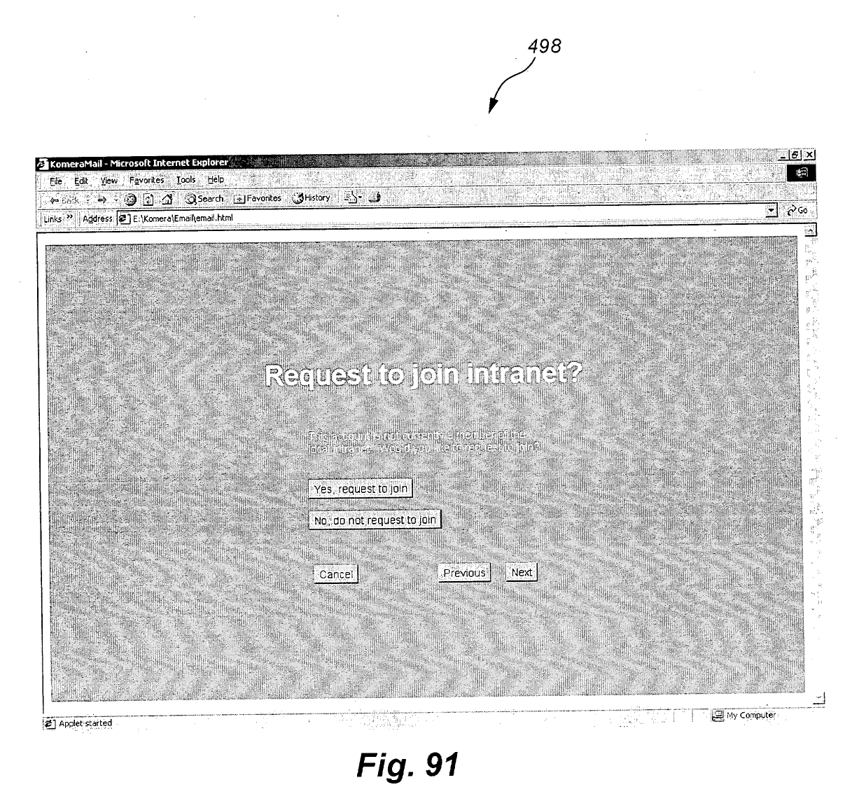

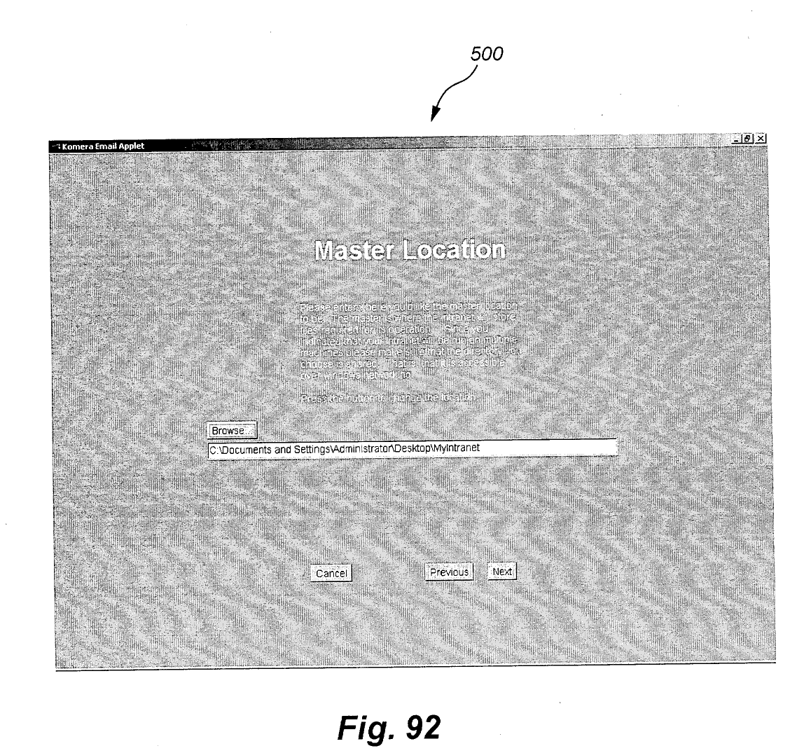

FIG. 84 is an image of a screen 484 for a new user to use to create an email account following the email convention of an intranet created using the portable intranet software 200. FIG. 85 shows an image of a screen 486 informing a user who has just created an email account following an intranet email convention, what his/her email address is after an email account request has been submitted to an intranet created using the portable intranet software 200. FIG. 86 shows an image of a screen 488 for informing a user that a request has been made for an intranet account for an intranet created using the portable intranet software 200. FIG. 87 shows an image of a screen 490 for entering a subdomain of an intranet created using the portable intranet software 200. FIG. 88 shows an image of a screen 492 showing transfer schedule settings for an intranet created using the portable intranet software 200. FIG. 89 shows an image of a screen 494 for entering or removing entries for a transfer schedule of an intranet created using the portable intranet software 200. FIG. 90 shows an image of a screen 496 for entering criteria for a schedule to be added to a transfer schedule of an intranet created using the portable intranet software 200. FIG. 91 shows an image of a screen 498 for a user with an existing portable email account to select whether to request to join an intranet created using the portable intranet software 200. FIG. 92 shows an image of a screen 500 for entering or browsing to find the location where are stored intranet files for an intranet created using the portable intranet software 200. FIG. 93 shows an image of a screen 502 for indicating to a user that a directory has been located with intranet files for an intranet created using the portable intranet software 200.

The method, computer useable medium, and system for portable email messaging according to the invention provides professionalism not found in free online email services and the ability to tailor an intranet service to a particular business or organization, including individual families utilizing a single computer. The portable email messaging software also provides a generalized webmail solution which works instantly with any SMTP-POP/IMAP email server, that is, without installation, and the privacy of keeping an email account where an individual wants.

While the invention has been described with references to its preferred embodiments, it will be understood by those skilled in the art that various changes may be made and equivalents may be substituted for elements thereof without departing from the true spirit and scope of the invention.

I claim:

1. A portable email messaging method comprising:
storing a portable email account associated with a particular user on the computer useable medium;
activating the portable email account on the computer device while the device is not communicatively linked to the Internet;
composing email messages, reading email messages, synchronizing selected message folders and address book of the portable email account between two independent directory locations, organizing email messages in folders, or accessing an address book of the portable email account while the computer device is not communicatively linked to the Internet;
communicatively linking the computer device to the Internet;
sending/receiving email messages to and from the portable email account; and
storing online a copy of user account parameters of the portable email account while the computer device is communicatively linked to the Internet.

2. The portable email messaging method according to claim 1, further comprising:
creating a portable email account, wherein the portable email account being created is associated with an existing email account or is a new email account;
entering an email address for the portable email account being created;
entering a password for the portable email account being created;
entering POP/IMAP and SMTP server information for the portable email account being created; and
entering a location where to locally save or choosing to operate the portable email account being created as a webmail.

3. The portable email messaging method according to claim 2, further comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

4. The portable email messaging method according to claim 3, further comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the signature settings folder for the portable email account, the download options settings folder for the portable email account, the SMTP settings folder for the portable email account, and the POP/IMAP settings folder for the portable email account.

5. The portable email messaging method according to claim 3, further comprising:
enabling a user to use the SYNCHRONIZE ACCOUNT key to select synchronization options and choose which folders/address book of the portable email account should be synchronized; and
synchronizing selected folders/address book of the portable email account.

6. The portable email messaging method according to claim 1, further comprising:
entering a portable email address and password for an existing portable email account; and
accessing the portable email account by locally finding the portable email account, downloading and saving the portable email account, or operating the portable email account as a webmail account.

7. The portable email messaging method according to claim 6, further comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

8. The portable email messaging method according to claim 7, further comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the signature settings folder for the portable email account, the download options settings folder for the portable email account, the SMTP settings folder for the portable email account, and the POP/IMAP settings folder for the portable email account.

9. The portable email messaging method according to claim 7, further comprising:
enabling a user to use the SYNCHRONIZE ACCOUNT key to select synchronization options and choose which folders/address book of the portable email account should be synchronized; and
synchronizing selected folders/address book of the portable email account.

10. The portable email messaging method according to claim 1, further comprising:
entering or browsing for a location where portable email software will be downloaded;
selecting whether to download desktop icons for portable email software;
downloading portable email software; and
indicating progress of portable email software being downloaded.

11. A computer useable medium carrying thereon portable email software which, when executed by a processor, causes the processor to carry out steps:
storing a portable email account associated with a particular user;
activating the portable email account on the computer device while the device is not communicatively linked to the Internet;
composing email messages, reading email messages, synchronizing selected message folders and address book of the portable email account between two independent directory locations, organizing email messages in folders, or accessing an address book of the portable email account while the computer device is not communicatively linked to the Internet;
communicatively linking the computer device to the Internet;
sending/receiving email messages to and from the portable email account; and
storing online a copy of user account parameters of the portable email account while the computer device is communicatively linked to the Internet.

12. The computer useable medium according to claim 11, wherein said portable email software, when executed by the processor, further causes the processor to carry out steps comprising:
creating a portable email account, wherein the portable email account being created is associated with an existing email account or is a new email account;
entering an email address for the portable email account being created;
entering a password for the portable email account being created;
entering POP/IMAP and SMTP server information for the portable email account being created; and
entering a location where to locally save or choosing to operate the portable email account being created as a webmail.

13. The computer useable medium according to claim 12, wherein said portable email software, when executed by the processor, further causes the processor to carry out steps comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

14. The computer useable medium according to claim 13, wherein said portable email software, when executed by the processor, further causes that processor to carry out steps comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the signature settings folder for the portable email account, the download options settings folder for the portable email account, the SMTP settings folder for the portable email account, and the POP/IMAP settings folder for the portable email account.

15. The computer useable medium according to claim 13, wherein said portable email software, when executed by the processor, further causes that processor to carry out steps comprising:
enabling a user to use the SYNCHRONIZE ACCOUNT key to select synchronization options and choose which folders/address book of the portable email account should be synchronized; and
synchronizing selected folders/address book of the portable email account.

16. The computer useable medium according to claim 11, wherein said portable email software, when executed by the processor, further causes that processor to carry out steps comprising:
entering a portable email address and password for the portable email account; and
accessing the portable email account by locally finding the portable email account, downloading and saving the portable email account, or operating the portable email account as a webmail account.

17. The computer useable medium according to claim 16, wherein said portable email software, when executed by the processor, further causes that processor to carry out steps comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

18. The computer useable medium according to claim 17, wherein said portable email software, when executed by the processor, further causes that processor to carry out steps comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the signature settings folder for the portable email account, the download options settings folder for the portable email account, the SMTP settings folder for the portable email account, and the POP/IMAP settings folder for the portable email account.

19. The computer useable medium according to claim 17, wherein said portable email software, when executed by the processor, further causes that processor to carry out steps comprising:
enabling a user to use the SYNCHRONIZE ACCOUNT key to select synchronization options and which folders/address book of the portable email account should be synchronized; and
synchronizing selected folders/address book of the portable email account.

20. The computer useable medium according to claim 11, wherein said portable email software, when executed by the processor, further causes that processor to carry out steps comprising:
entering or browsing for a location where portable email software will be downloaded;
selecting whether to download desktop icons for portable email software;
downloading portable email software; and
indicating progress of portable email software being downloaded.

21. A portable email messaging system comprising:
a computer useable medium; and
a computer device communicatively linkable to the Internet, the computer device having a processor;
wherein the computer useable medium carries thereon portable email software which, when executed by the processor of the computer device, causes the processor to carry out steps:
storing a portable email account associated with a particular user on the computer useable medium;
activating the portable email account on the computer device while the device is not communicatively linked to the Internet;
composing email messages, reading email messages, synchronizing selected message folders and address book of the portable email account between two independent directory locations, organizing email messages in folders, or accessing an address book of the portable email account while the computer device is not communicatively linked to the Internet;
communicatively linking the computer device to the Internet;
sending/receiving email messages to and from the portable email account; and
storing online a copy of user account parameters of the portable email account while the computer device is communicatively linked to the Internet.

22. The portable email messaging system according to claim 21, wherein said portable email software, when executed by the processor of the computer device, further causes the processor to carry out steps comprising:
creating a portable email account, wherein the portable email account being created is associated with an existing email account or is a new email account;
entering an email address for the portable email account being created;
entering a password for the portable email account being created;
entering POP/IMAP and SMTP server information for the portable email account being created; and
entering a location where to locally save or choosing to operate the portable email account being created as a webmail.

23. The portable email messaging system according to claim 22, wherein said portable email software, when executed by the processor of the computer device, further causes the processor to carry out steps comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

24. The portable email messaging system according to claim 23, wherein said portable email software, when executed by the processor of the computer device, further causes the processor to carry out steps comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the, signature settings folder for the portable email account, the download options settings folder for the portable email account, the SMTP settings folder for the portable email account, and the POP/IMAP settings folder for the portable email account.

25. The portable email messaging system according to claim 23, wherein said portable email software, when executed by the processor of the computer device, further causes the processor to carry out steps comprising:
enabling a user to use the SYNCHRONIZE ACCOUNT key to select synchronization options and choose which folders/address book of the portable email account should be synchronized; and
synchronizing selected folders/address book of the portable email account.

26. The portable email messaging system according to claim 21, wherein said portable email software, when executed by the processor of the computer device, further causes the processor to carry out steps comprising:
entering a portable email address and password for the portable email account; and
accessing the portable email account by locally finding the portable email account, downloading and saving the portable email account, or operating the portable email account as a webmail account.

27. The portable email messaging system according to claim 26, wherein said portable email software, when executed by the processor of the computer device, further causes the processor to carry out steps comprising:
providing a screen of the portable email account, wherein the screen includes an INBOX folder, an OUTBOX folder, a SENT folder, and a DRAFT folder, a CREATE FOLDER key, a DELETE SELECTED FOLDER key, a SYNCHRONIZE ACCOUNT key, a SEND/RECEIVE key, a COMPOSE key, a SETTINGS key, an ADDRESS BOOK key, a HELP key, a MESSAGE MENU key, a SEARCH key, and a LOGOUT key.

28. The portable email messaging system according to claim 27, wherein said portable email software, when executed by the processor of the computer device, further causes the processor to carry out steps comprising:
enabling a user to use the SETTINGS key to access a security settings folder for the portable email account, a signature settings folder for the portable email account, a download options settings folder for the portable email account, an SMTP settings folder for the portable email account, and a POP/IMAP settings folder for the portable email account; and
enabling a user to use the SETTINGS key to change settings in the security settings folder for the portable email account, the signature settings folder for the portable email account, the download options settings folder for the portable email account, the SMTP settings folder for the portable email account, and the POP/IMAP settings folder for the portable email account.

29. The portable email messaging system according to claim 27, wherein said portable email software, when executed by the processor of the computer device, further causes the processor to carry out steps comprising:
enabling a user to use the SYNCHRONIZE ACCOUNT key to select synchronization options and choose which folders/address book of the portable email account should be synchronized; and
synchronizing selected folders/address book of the portable email account.

30. The portable email messaging system according to claim 21, wherein said portable email software, when executed by the processor of the computer device, further causes the processor to carry out steps comprising:
entering or browsing for a location where portable email software will be downloaded;
selecting whether to download desktop icons for portable email software;
downloading portable email software; and
indicating progress of portable email software being downloaded.

31. A portable intranet method comprising:
locally exchanging email messages among independent email addresses and updating an intranet address book directory;
enabling an intranet manager to establish a connection with the Internet, and send/receive email messages to and from the Internet for intranet members without each member having to individually log into their account;
enabling independently created intranets to exchange intranet member messages in a peer to peer environment or through an intranet exchange point where multiple independent intranets exchange email messages and obtain an updated membership directory; and
enabling an intranet exchange point to send/receive Internet bound messages for independent intranet members.

32. The portable intranet method according to claim 31, further comprising:
aggregating and sending outgoing Internet email messages created by intranet members, and sending the aggregated outgoing email messages when an Internet connection is established; and
downloading in aggregate on behalf of intranet members email messages from associated POP/IMAP server email mailboxes when an Internet connection is established.

33. The portable intranet method according to claim 31, further comprising:
creating a portable intranet;
selecting whether to create an intranet on a single or on multiple machines;
choosing a location where to save an intranet being created;
entering an Internet domain name for an intranet being created;
entering POP/IMAP and SMTP server information for an intranet account being created;
entering an email address convention to follow for creating email accounts for intranet members for an intranet being created; and
entering a password for an intranet being created.

34. The portable intranet method according to claim 33, further comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

35. The portable intranet method according to claim 34, further comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

36. The portable intranet method according to claim 33, further comprising:
entering an intranet domain name and password for an existing intranet; and
accessing the created intranet by locally finding an existing intranet directory.

37. The portable intranet method according to claim 36, further comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

38. The portable intranet method according to claim 37, further comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

39. The portable intranet method according to claim 33, further comprising:
deploying intranet clients on computer desktops;
providing a screen for users to create portable email accounts following the email convention for the intranet;
enabling users with portable email accounts to request to join an intranet;
approving users with portable email accounts to join an intranet;
providing a screen for users to log into a portable email accounts and to compose/read/send/receive email messages;
enabling users to access an intranet address book directory, personal directory, group calendar, and shared documents; and
enabling users to manage message folders.

40. The portable intranet method according to claim 33, further comprising:
entering or browsing for a location where portable intranet software will be downloaded;
selecting whether to download desktop icons for portable intranet software;
downloading portable intranet software; and
indicating progress of portable intranet software being downloaded.

41. A computer usable medium carrying thereon portable intranet software which, when executed by a processor, causes the processor to carry out steps comprising:
locally exchanging email messages among independent email addresses and updating an intranet address book directory;
enabling an intranet manager to establish a connection to the Internet and send/receive email messages to and from the Internet for intranet members without each member having to individually log into their account;
enabling independently created intranets to exchange intranet member messages in a peer to peer environment or through an intranet exchange point where multiple independent intranets exchange email messages and obtain an updated membership directory; and
enabling an intranet exchange point to send/receive Internet bound messages for independent intranet members.

42. The computer useable medium according to claim 41, wherein said portable intranet software, when executed by the processor, further causes the processor to carry out steps comprising:
aggregating and sending outgoing Internet email messages created by intranet members, and sending the aggregated outgoing email messages when an Internet connection is established; and
downloading in aggregate on behalf of intranet members email messages from associated POP/IMAP server email mailboxes when an Internet connection is established.

43. The computer usable medium according to claim 41, wherein said portable intranet software, when executed by the processor, further causes the processor to carry out steps comprising:
creating a portable intranet;
selecting whether to create an intranet on a single or on multiple machines;
choosing a location where to save an intranet being created;
entering an Internet domain name for an intranet being created;
entering POP/IMAP and SMTP server information for an intranet account being created;
entering an email address convention to follow for creating email accounts for intranet members for an intranet being created; and
entering a password for an intranet being created.

44. The computer usable medium according to claim 43, wherein said portable intranet software, when executed by the processor, further causes the processor to carry out steps comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

45. The computer usable medium according to claim 44, wherein said portable intranet software, when executed by the processor, causes the processor to carry out steps comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

46. The computer usable medium according to claim 43, wherein said portable intranet software, when executed by the processor, further causes the processor to carry out steps comprising:
entering an intranet domain name and password for an existing intranet; and
accessing the created intranet by locally finding an existing intranet directory.

47. The computer usable medium according to claim 46, wherein said portable intranet software, when executed by the processor, further causes the processor to carry out steps comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

48. The computer usable medium according to claim 47, wherein said portable intranet software, when executed by a processor, causes the processor to carry out steps comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

49. The computer usable medium according to claim 43, wherein said portable intranet software, when executed by a processor, causes the processor to carry out steps comprising:
deploying intranet clients on computer desktops;
providing a screen for users to create portable email accounts following the email convention for the intranet;
enabling users with portable email accounts to request to join an intranet;
approving users with portable email accounts to join an intranet;
providing a screen for users to log into a portable email accounts and to compose/read/send/receive email messages;
enabling users to access an intranet address book directory, personal directory, group calendar, and shared documents; and
enabling users to manage message folders.

50. The computer usable medium according to claim 43, wherein said portable intranet software, when executed by a processor, causes the processor to carry out steps comprising:
entering or browsing for a location where portable intranet
software will be downloaded;
selecting whether to download desktop icons for portable intranet software;
downloading portable intranet software; and
indicating progress of portable intranet software being downloaded.

51. A portable email messaging system comprising:
a computer useable medium; and
a computer device communicatively linkable to the Internet, the computer device including a processor;
wherein the computer useable medium carries thereon portable intranet software which, when executed by the processor of the computer device, causes the processor to carry out steps comprising:
locally exchanging email messages among independent email addresses and updating an intranet address book directory;
enabling an intranet manager to establish a connection to the Internet and send/receive email messages to and from the internet for intranet members without each member having to individually log into their account;
enabling independently created intranets to exchange intranet member messages in a peer to peer environment or through an intranet exchange point where multiple independent intranets exchange email messages and obtain an updated membership directory; and
enabling an intranet exchange point to send/receive Internet bound messages for independent intranet members.

52. The portable email messaging system according to claim 51, wherein said portable intranet software, when executed by the processor of the computer device, further causes the processor to carry out steps comprising:
aggregating and sending outgoing Internet email messages created by intranet members, and sending the aggregated outgoing email messages when an Internet connection is established; and
downloading in aggregate on behalf of intranet members email messages from associated POP/IMAP server email mailboxes when an Internet connection is established.

53. The portable email messaging system according to claim 51, wherein said portable intranet software, when executed by the processor of the computer device, further causes the processor to carry out steps comprising:
creating a portable intranet;
selecting whether to create an intranet on a single or on multiple machines;
choosing a location where to save an intranet being created;
entering an Internet domain name for an intranet being created;
entering POP/IMAP and SMTP server information for an intranet account being created;
entering an email address convention to follow for creating email accounts for intranet members for an intranet being created; and
entering a password for an intranet being created.

54. The portable email messaging system according to claim 53, wherein said portable intranet software, when executed by the processor of the computer device, further causes the processor to carry out steps comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

55. The portable email messaging system according to claim 54, wherein said portable intranet software, when executed by the processor of the computer device, further causes the processor to carry out steps comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

56. The portable email messaging system according to claim 53, wherein said portable intranet software, when executed by the processor of the computer device, further causes the processor to carry out steps comprising:
entering an intranet domain name and password for an existing intranet; and
accessing the created intranet by locally finding an existing intranet directory.

57. The portable email messaging system according to claim 56, wherein said portable intranet software, when executed by the processor of the computer device, further causes the processor to carry out steps comprising:
providing a screen of the portable intranet, wherein the screen includes a TRANSFER key, a STOP key, an ADDRESS BOOK key, an ACCOUNTS key, a SCHEDULER key, a CONFIGURATIONS key, an IMPORT/EXPORT key, and a LOGOUT key.

58. The portable email messaging system according to claim 57, wherein said portable intranet software, when executed by the processor of the computer device, further causes the processor to carry out steps comprising:
enabling a user to use the TRANSFER key to initiate sending/receiving of Internet messages for intranet members, and to stop sending/receiving of Internet messages;
enabling a user to use the ACCOUNTS key to manage an intranet address book directory, approve/deny new intranet member account requests, and remove intranet member accounts;
enabling a user to use the SCHEDULER key to create/manage a schedule of intranet message transfer;
enabling a user to use the CONFIGURATION key to modify the intranet password and manage intranet sub-domains;
enabling a user to use the IMPORT/EXPORT key to synchronize the intranet by exporting/importing to and from a location from which sending/receiving of internet message will be conducted; and
enabling a user to use the LOGOUT key to log out of the intranet.

59. The portable email messaging system according to claim 53, wherein said portable intranet software, when executed by the processor of the computer device, further causes the processor to carry out steps comprising:
deploying intranet clients on computer desktops;
providing a screen for users to create portable email accounts following the email convention for the intranet;
enabling users with portable email accounts to request to join an intranet;
approving users with portable email accounts to join an intranet;
providing a screen for users to log into a portable email accounts and to compose/read/send/receive email messages;
enabling users to access an intranet address-book directory, personal directory, group calendar, and shared documents; and
enabling users to manage message folders.

60. The portable email messaging system according to claim 53, wherein said portable intranet software, when executed by the processor of the computer device, further causes the processor to carry out steps comprising:
entering or browsing for a location where portable intranet software will be downloaded;
selecting whether to download desktop icons for portable intranet software;
downloading portable intranet software; and
indicating progress of portable intranet software being downloaded.
